(19) United States
(12) Patent Application Publication
(10) Pub. No.: US 2001/0002851 A1
(43) Pub. Date: Jun. 7, 2001

(54) Multimedia data processing system in network

(76) Inventors: Takao Shimada, Yokohama-shi (JP); Tomohisa Kohiyama, Yokohama-shi (JP); Takahiro Yamada, Yokohama-shi (JP); Shin-ichi Hashimoto, Hadano-shi (JP); Yuji Kimura, Owariasahi-shi (JP); Takeo Tomokane, Yokohama-shi (JP); Itaru Nonomura, Tokyo (JP); Kazuaki Tanaka, Yokohama-shi (JP); Yasunobu Hori, Kawasaki-shi (JP); Yuuichi Ikeya, Tokyo (JP); Yasuhiro Imai, Hadano-shi (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/727,451

(22) Filed: Dec. 4, 2000

Related U.S. Application Data
(63) Continuation of application No. 08/633,311, filed on Apr. 15, 1996.

(30) Foreign Application Priority Data
May 17, 1995 (JP) 7-118673
Apr. 14, 1995 (JP) 7-89613
Jun. 27, 1995 (JP) 7-160972
Jul. 18, 1995 (JP) 7-181550

(51) Int. Cl. H04N 7/06

(52) U.S. Cl. 348/423.1

(57) ABSTRACT

There is provided a device for forming, from original sound-attached moving-picture (video) data, sound-attached moving-picture data of a desired reproduction time which has a data amount smaller than that of the original sound-attached moving-picture data and are suitable to output the corresponding sounds and moving pictures at the same time. The original sound-attached moving-picture data are separated into moving-picture data and sound data. When the separated moving-picture data are moving-picture data which are encoded by orthogonal transform coding, for every frame, any portion representing high frequency components in the moving-picture data in each frame of the moving-picture data is deleted. A portion (reproduction target moving-picture data) of moving-picture data (in the deleted moving-picture data) obtained by encoding the frames whose number corresponds to an indicated reproduction time, and a portion (in the separated sound data) to be reproduced simultaneously with the reproduction target moving-picture data are multiplexed with each other. A multimedia data relay device in a network converts the data amount of data extracted from input information according to a regulation which is predetermined in accordance with the data type, and replaces the converted data by the data before the conversion processing and then output the data. A data converting device in a network performs data conversion processing on conversion target data of input information from a server according to a predetermined regulation, and transmits the converted data to a client. In addition, the data converting device stores the converted input information in the data converting device, and when the client demands the same data, the stored converted data are output to the client with no conversion processing. When data supplied from the server are video data, a correcting-function attached data conversion relay device reduces the size of images represented by the video data, and then supplies the size-converted data to the client. When the data demand from the client is a data demand containing coordinate values in the video data, the correcting-function attached data conversion relay device corrects the coordinate values by multiplying the coordinate values by the inverse number of the reduction ratio of the images, and transmits the data demand containing the corrected coordinate values to the server.

### BACKGROUND OF THE INVENTION

1. Field of the Invention

The present invention relates to an information processing system for processing multimedia data containing video data, audio data, etc., and particularly to a device for forming sound-attached moving-picture data of a desired reproduction time from original sound-attached moving-picture data in which audio data and moving-picture data are multiplexed with each other, the sound-attached moving-picture data having a smaller data amount than that of the original sound-attached moving-picture data and being suitably used to output the corresponding sound and moving picture at the same time.

Further, the present invention relates to a data converting device for converting the size, etc. of input data and outputting the converted data, and particularly to a device which serves as a relay for relaying multimedia data such as video data, audio data, etc. which are transmitted through plural kinds of transmission media.

Still further, the present invention relates to an information processing system for performing data transmission through the data converting relay device, among plural information processing devices.

2. Description of Related Art

(1) Recently, a network infrastructure of LAN (Local Area Network), etc. has been widely utilized in offices and progressively improved in performance, and an accessing environment for the internet has now been prepared. Such development of the network infrastructure and the preparation of the accessing environment are expected to promote spread of a multimedia transmission system for transmitting sound-attached moving-picture data among plural information processing devices through a network, and there are some indications to the spread of the multimedia transmission system. In this specification, the term “sound-attached moving-picture data” means data comprising video data (moving pictures) and corresponding audio data (sounds or voices) which are multiplexed with each other.

In the multimedia transmission system, an information processing device (hereinafter referred to as “video server”) which is a supply source of sound-attached moving-picture data stocks sound-attached moving-picture data which are formed by multiplexing moving-picture data and audio data, and then transmit the stocked sound-attached moving-picture data through a network to another information processing (hereinafter referred to as “client”). The client reproduces the sound-attached moving-picture data which are transmitted from the video server through the network. In this case, it is preferable that moving pictures and sounds which are associated with each other are output at the same time.

Further, the recent improvement of personal computers and work stations is also facilitating users to use these equipments as clients to reproduce sound-attached moving-picture data.

When moving-picture data or audio data are stocked (stored) or transmitted, these data are generally subjected to data compression processing to reduce storage capacity of a storage device for the data stock or shorten a data transmission time because the data amount of these data is extremely large.

Various compression systems to compress moving-picture data or audio (sound) data are known, and MPEG1 (Moving Picture Experts Group Phase 1) video coding standards to compress moving-picture data and MPEG1 audio coding standards which are recommended by ISO (International Standardization Organization) are typically known in these compression systems. Further, MPEG1 system multiplexing standards are also known as standards to specify a multiplexing method of moving-picture data (video data) and sound data (audio data) which are based on the MPEG1 standards.

The summary of the specification of these standards, the compression systems and data formats, etc. is described in “DIAGRAMMATICALLY-EXPLANATORY LATEST MPEG TEXT“, pp 89-128 and pp 231-253 issued by ASCII Corporation on Aug. 1, 1994.

However, when a multimedia system uses an information processing device having low processing performance as a client or a network having a low processing speed, it has a disadvantage that data processing such as transmission, decoding, etc. still needs a long processing time even for compressed sound-attached moving-picture data, so that the sound-attached moving-picture data cannot be reproduced on a real-time basis.

For example, when a video server transmits MPEG1-based sound-attached moving-picture data having a data amount of 1.5 Mbits per second to a client through an N-ISDN (Narrow-Integrated service Digital Network) line having a transmission rate of 64 Kbits per second, a transmission time of about 24 times of a reproduction time is required, and thus it is impossible to reproduce the sound-attached moving-picture data on a real-time basis at the client side.

In order to avoid this problem, the sound-attached moving-picture data which are transmitted from the video server through the network may be temporarily stored in a storage device of the client, and then reproduced. In this case, a storage device having a large capacity must be provided to the client. For example, when MPEG1-based sound-attached moving-picture data having a data amount of 1.5 Mbits per second are stocked (stored) by an amount corresponding to one hour, the storage device must have a storage capacity of 675 Mbytes.

Further, when sound-attached moving-picture data are reproduced, the sound-attached moving-picture data are sometimes required to be reproduced in a fast forward mode to grasp the content of the sound-attached moving-picture data. Here, the fast forward mode is defined as a mode in which picture frames of the data are reproduced at a higher frame feed speed as compared with a normal speed. In order to perform the fast forward reproduction as described above, the processing speed of the decoding operation, etc. is required to be increased. However, it is difficult to increase the processing speed from the viewpoint of a processing load. Therefore, the fast forward reproduction is generally performed by repeating such processing that a part of the moving-picture data of the sound-attached moving-picture data are reproduced while the other is skipped.

However, when the moving-picture data are reproduced from a halfway portion thereof, the normal reproduction of the data cannot be performed due to occurrence of noises unless the data reproduction is started from a specific (significant) pause of the moving-picture data, for example, a pause between frames of the moving-picture data. Accordingly, it is required that the specific (significant) pause of the moving-picture data is detected and then the reproduction is started from the detected specific pause in order to normally reproduce the moving-picture data after the skip is finished. Therefore, the fast forward reproduction has a higher processing load than the normal reproduction.

In order to solve the above problem, there have been proposed a technique of reducing the data amount of the moving-picture data and a technique for forming moving-picture data which are dedicated to the fast forward reproduction. For example, Japanese Laid-open Patent Application No. Hei-6-70174 discloses a technique of reducing the data amount of the moving-picture data by deleting high-frequency components from the moving-picture data. Further, Japanese Laid-open Patent Application No. Hei-6-133263 discloses a technique of analyzing original moving-picture data in advance to form moving-picture data to be dedicated to the fast forward reproduction, and then reproducing the moving-picture data for the fast forward reproduction in the fast forward reproduction mode to thereby reduce the processing load.

The presence of the sound in the reproducing operation has a great effect on user's grasp of the content of the moving-picture data, and thus it is desirable to simultaneously output corresponding moving pictures and sounds even in the fast forward reproduction mode. The technique disclosed in Japanese Laid-open Patent Application No. Hei-6-70174 can reduce the data amount of the moving-picture data by deleting the high-frequency components from the moving-picture data as described above, however, it takes no consideration of audio (sound) data. Further, the technique disclosed in Japanese Laid-open Patent Application No. Hei-6-133262 analyzes the original moving-picture data in advance to form the moving-picture data to be dedicated to the fast forward reproduction, and then reproduces the moving-picture data for the fast forward reproduction in the fast forward reproduction mode to thereby reduce the processing load, however, it also takes no consideration of audio (sound) data.

Like the moving-picture data, when the audio data are reproduced from a halfway portion thereof, the normal reproduction of the audio data cannot be performed due to occurrence of noises unless the data reproduction is started from a specific (significant) portion of the audio data, for example, from a portion between decode processing units of the audio data. Accordingly, it is also required for the audio data that the specific (significant) pause is detected and then the reproduction is started from the detected specific pause in order to perform the normal reproduction after the skip is finished.

Furthermore, in a network system, services are supplied among plural information processing devices which are connected to one another through a network.

As shown in FIG. 17, a server 2101 is connected to a relay device 2301 through a network 2102, and the relay device 2301 is connected to a client 2105 through a network 2104. In response to a service demand (or request) from the client 2105 to the server 2101, the server 2101 supplies a demanded service to the client 2105. At this time, the transmission and reception of various information is performed between the server 2101 and the client 2105 through the network 2102, the relay device 2301 and the network 2104. The relay device 2301 serves to receive information and transmit the information to a desired transmission target or destination. In this case, the relay device 2301 is designed to perform the reception and transmission of the information according to only a predetermined communication procedure, and thus it has no function of processing the received information, particularly has no function of controlling the amount of information.

In general, many information processing devices exist on the network system, however, those information processing devices which are not directly associated with the information transmission between the server 2101 and the client 2105 are omitted from the illustration in FIG. 17. As the information processing devices are used a work station, a personal computer, a domestic game machine, a private information managing terminal, a cable television transmitter, a television receiver, etc.

When the server supplies a service to the client, various data are transmitted and received between the server and the client. A network system considering the transmission and reception of “multimedia data” is called as “multimedia network system”.

In this specification, “multimedia data” are defined as data containing at least one of the following plural kinds of data: text data, audio data, vector picture data, still picture data, moving picture data, music track data, hypertext data, multimedia script data, virtual reality data, etc.

Most of data which have been handled by conventional information processing devices mainly comprise text data and data of program software, and even one-bit data error is not permitted to these data. That is, if any data error occurs, a program would not normally operate irrespective of the degree of the data error (i.e., even when the data error is one bit).

The recent improvement of the processing performance (capabilities) of the information processing devices promotes use of data having relatively large data size such as video data, audio data, etc. These data substantially has characteristic of redundancy, and thus they can serve as data even when they are slightly incomplete. For example, even when the data size of these data is reduced to a desired data size by lowering the resolution of a still picture or reducing a sampling rate of audio data, these data can still serve as still-picture data or audio data.

In view of such a situation, a concept of controlling quality of these data is produced. That is, assuming the transmission of multimedia data which contains a lot of data having redundancy as described above, it is impossible for a server side to output high-quality data to a client when the client side has no performance of receiving high-quality data, and thus it is sometimes preferable for a data transmission efficiency that the server side outputs low-quality and small-size data to the client from the beginning because a transmission time can be shortened and a traffic of the network can be reduced. Here, “low-quality data” means data from which are partially thinned out. For example, for data of a still picture (high-quality data) having a prescribed number of pixels, “low-quality data” means data of the still picture which are obtained by thinning out some pixels from the data of the still picture to degrade its image quality (in this case, the data size is reduced at the same time).

Furthermore, various types of media are used as a transmission medium for connecting the server and the client. Accordingly, even when the client has high performance, the data transmission time would be long if the transmission performance of the transmission medium is low, so that a practical system cannot be achieved. Further, there are some cases where an user needs to observe an outline of multimedia data through a preview or the like.

In view of the foregoing, a technique on a media-converting server is proposed as a technique of supplying from a server data which are suitable for user's demand. In this technique, when high-quality data owned by the server are supplied to a client, those data which are suitably based on the traffic and the performance of the client can be transmitted by adjusting the data size, etc., that is, by varying the data size.

For example, Japanese Patent Application No. Hei-6-14202 discloses a technique of transmitting video data while converting the video data to data having a resolution and a format which are suitable for the performance of the client. Further, Japanese Patent Application Nos. Hei-6-226385 and Hei-7-41592 propose high-speed data conversion methods. By using these techniques, the data transmission based on the transmission performance of the network and the performance of the client can be performed between the server and the client.

In a wide area network system, the server frequently permits a connection with an unspecified client. A technique on a multimedia network system of supplying services to many unspecified clients is described from pages 35 to 61 in the February 1995 issue of INTERNET MAGAZINE (issued by Soft Bank Corporation).

It is difficult to apply the above-mentioned media conversion server to such a wide area network system as described above for the following reasons:

(1) In many cases, no contract on the size of the transmission data, etc. is established between an user of a client and a management organization of the server, and thus it is difficult to operate the server so as to meet needs of the client sides.

(2) It is difficult to judge the connection environment and performance (transmission capability of a connection line, etc.) of a client at the server side, and it is difficult to check whether data suited to the capability of the server side can be supplied.

That is, it is required in the multimedia network system to control the data amount of data to be received by the client, etc., however, it is actually difficult to provide a means of controlling the data amount to the server side in the wide area network environment.

From page 35 to page 61 of the February 1995 issue of “INTERNET MAGAZINE” (issued by Soft Bank Corporation) as mentioned above is described a multimedia network system with which an user can search and browse multimedia data through an user's interactive operation at the client side.

As described above, Japanese Laid-open Patent Application No. Hei-6-14202 proposes the technique of converting video data to data having the resolution and the format which are suited to the performance of the client, and then transmitting the converted data. Also, Japanese Patent Application Nos. Hei-6-226385 and Hei-7-41592 disclose the high-speed data converting methods. By using these techniques, the data transmission which are based on the transmission capability of the network and the performance of the client can be performed between the server and the client.

Further, Japanese Patent Application No. Hei-7-118673 discloses a technique of enabling the user of a client to search multimedia data at high speed by achieving a data conversion function in a relay device of a network and by converting video data to data having a resolution and a format suited to the performance of a client and then transmitting the converted data in a multimedia network system in which data transmission is performed between many unspecified servers and many unspecified clients.

FIG. 50 shows the construction of a multimedia network system in which data are converted and then transmitted to a client when the data are transmitted from a server to the client. In FIG. 50, reference numeral 3101 represents a server, reference numeral 3102, 3104 represents a network, reference numeral 3105 represents a client, and reference numeral 3301 represents a data converting device. The multimedia network system shown in FIG. 50 has the same construction as that of FIG. 17 except that the relay device 2301 of FIG. 17 is replaced by the data converting device 3301. The server 3101 is connected to the data converting device 301 through the network 3102, and the data converting device 3301 is connected to the client 3105 through the network 3104.

In response to a serve demand from the client 3105 to the server 3101, the server 3101 supplies a service to the client 3105. At this time, various information is communicated (transmitted and received) between the server 3101 and the client 3105 through the network 3102, the data converting device 3301 and the network 3104. The data converting device 3301 serves to receive information, and then transmit the information to a desired transmission target. The data converting device 3301 performs data communication according to a predetermined communication procedure, and it has a function of processing the information, particularly of controlling the data amount, etc.

The data conversion processing of the data converting device 3301 is not necessarily performed at high speed. For example, upon comparing the processing of changing the display size of still-picture data and the processing of changing the display size of moving-picture data, the display-size changing processing for the still-picture data must be repetitively carried out for the moving-picture data because the moving-picture data comprise plural still-picture data, and thus its processing cost rises up more. Furthermore, a long processing time is generally needed to translate text data or prepare digest moving-picture data which are obtained by picking up (extracting) only plural main portions of the moving-picture data.

In the data converting device 3301, when data are transmitted from the server 3101 to the client 3105, the total data transmission time from the server 3101 to the client 3105 is longer when the data conversion is performed by a conversion processing having a large time cost than when no data conversion is performed. Therefore, one purpose of the multimedia network system as shown in FIG. 50, that is, “users of clients can search multimedia data at high speed” cannot be achieved.

Furthermore, there are various data to be transmitted in the multimedia network system, and there are also various data conversion systems for respective types of data. For example, a method of “converting moving-picture data to introductory moving-picture data by cutting most of the moving-picture data while only a head portion of the moving pictures is left”, or a method of “converting moving-picture data to digest moving-picture data by picking up a part of the moving pictures” may be considered in order to reduce the data amount through the data conversion processing of the moving-picture data. Here, the processing of “converting moving-picture data to introductory moving-picture data by cutting most of the moving-picture data while only a head portion of the moving pictures” can be very easily performed because it is sufficient to extract only the head portion of the moving picture data, and the time cost is low. On the other hand, the processing of “converting moving-picture data to digest moving-picture data by picking up a part of the moving pictures” needs an editing process of determining and extracting from the whole moving-picture data those portions which are considered to be important, so that the processing itself is very complicated and the time cost is high. Now, the data which are converted by the two methods as described are compared from viewpoint of “quality”. The term “quality” may be regarded as an amount of information to describe the content of the data. In the case of the moving-picture data, the digest moving-picture data can be expected to have higher quality than the introductory moving-picture data because the digest moving-picture data contain information on an outline of the whole content of the moving pictures, which briefly shows the overall flow of the moving pictures.

If it is considered more important to increase the data transmission rate from the server to the client when the data conversion processing is carried out in the data conversion device 301, the moving-picture data are preferably converted to the introductory moving-picture data, however, the “quality” of the converted data is reduced. On the other hand, if the “quality” of the converted data is considered more important, the moving-picture data are preferably converted to the digest moving-picture data, however, the transmission rate from the server to the client is reduced. That is, there is a tradeoff between “quality” and “transmission rate” in both the cases.

Likewise, such a tradeoff between the quality of the converted data and the time cost for the conversion processing frequently occurs in a case where one of a head text and a summary text is prepared on the basis of text data, or in a case where the size of still-picture data is reduced by simply thinning out pixels or by using an error dispersion processing to prepare a size-reduced image of high image quality.

In FIG. 74, reference numeral 4201 represents a server, reference numeral 4102, 4104 represents a network, reference numeral 4203 represents a relay device and reference numeral 4105 represents a client. The network system of FIG. 74 is substantially identical to that of FIG. 74. The server 4201 is connected to the client 4105 through the network 4102, the relay device 4203 and the network 4104. When the client 4105 demands a service through the network to the server 4201, the server 4201 supplies the service through the network to the client 4105. At this time, the relay device 4203 relays data from one network to the other network without changing the data.

As described above, when the server supplies its service to the client, various data communication is performed between the server and the client. For example, “multimedia data” comprising one kind of data such as text data, video data, audio data, etc., or mixed data of at least two kinds of the data as described above can be communicated (transmitted and received).

Recently, a server which is called as “WWW server” has supplied services on the internet. The relation between the WWW server and the client is coincident with the network system of FIG. 74. The WWW server supplies a hypertext using multimedia data as a service. In a hypertext supplied from the WWW server, various data such as text data, moving-picture data, still-picture data, audio data, etc. which are relevant with one another are connected to one another. Accordingly, a client can obtain various information services by tracing the data connection. The WWW server is introduced from page 36 to page 61 of “No. 2 1995 of INTERNET USER (issued by Soft Bank Corporation)”.

In the prior art, some problem has occurred in data transmission time when a server supplies a service to a client. For example, in the case of the transmission of video data having a remarkably larger data amount than text data, the data transmission time becomes longer, and thus it takes a long time from the time when an user demands a service until the time when the service is completed.

Particularly when the data transmission rate of the network 4104 between the relay device 4203 and the client 4105 in FIG. 74 is low, the kind of data can be identified and then the data conversion processing can be performed in the relay device 4203 without changing the system architecture such as the functions, etc. of the server. This technique is disclosed in Japanese patent Application No. Hei-6-226385 as described above. This application discloses a technique of relaying video data while reducing the video data through a size conversion processing to reduce the data amount.

In the case of the text data supplied by the WWW server as described above, there are some cases where video data are attached to a text which is displayed on a client's screen. An image attached in the text is hereinafter referred to as “in-line image”. FIG. 75 shows a display containing an in-line image.

In FIG. 75, reference numeral 4301 represents a display image of a hypertext, reference numerals 4302, 4305, 4310 represent an in-line image, reference numerals 4303, 4311, 4312 represent a text, and reference numerals 4306, 4307, 4308, 4309 represent an image in the in-line image 4305. The in-line image 4305 of FIG. 75 corresponds to video data of one picture. When any one of the images 4306, 4307, 4308 and 4309 is clicked by a pointing device such as a mouse or the like, the selected image is identified on the basis of the coordinate value of a clicked position on the in-line image 4305, and information which is linked to the selected image is given to the client.

FIG. 76 shows a display image of the hypertext of FIG. 75 which is relayed while only vide data are reduce to “½” (half) size in vertical and lateral directions by using the relay device having the function of identifying the kind of the data and then performing the data conversion processing as described above.

In FIG. 76, reference numeral 4401 represents a display image of the hypertext, reference numerals 4402, 4405, 4410 represent an in-line image, reference numerals 4303, 4411, 4412, 4413 represent a text, and reference numerals 4406, 4407, 4408, 4409 represent an image in the in-line image 4405.

By converting the data of the hypertext as shown in FIG. 75 to the data of FIG. 76, the transmission data amount can be reduced, so that the period from the client's service demand time until the service finish time can be shortened. However, the following problems may occur when the relay device performs the conversion processing on only the specific kinds of data a in the case that the hypertext data of FIG. 75 are converted to the hypertext data of FIG. 76:

(1) Sine the size of the in-line image 4405 is varied from that of the in-line image 4305 through the lateral and vertical half-size reduction processing, the coordinates of the images 4406, 4407, 4408 and 4409 of the in-line image 4405 are varied from the coordinates of the respective corresponding images 4306, 4307, 4308 and 4309 on the in-line image 4305 of FIG. 75. In the in-line image 4305 of FIG. 75, a selected image is identified by a coordinate input operation such as a click operation of the mouse or the like, so that the corresponding relation between the images and the coordinates in the reduced in-line image 4405 of FIG. 76 is different from that in the in-line image 4305 of FIG. 75, and thus an user interface is varied.

(2) When the data of FIG. 75 are converted to the data of FIG. 76, the data reducing conversion is performed on only the video data, and no change is made on the size of the texts 4303, 4304, 4311 and 4312. Therefore, a balance between the in-line image and the texts is varied. Further, the lateral width of the image is also varied because the in-line image 4310 is reduced to the in-line image 4410. Therefore, the text 4312 may be displayed while divided into the text 4412 at the right side of the text 4411 and the text 4413 at the lower side of the text 4411 in FIG. 76. As described above, in some cases a display design is varied between the hypertext display 4301 of FIG. 75 before the image is reduced and the hypertext display 4401 of FIG. 76 after the image is reduced.

### SUMMARY OF THE INVENTION

Therefore, a first object of the present invention is to provide a sound-attached moving-picture data forming device for forming sound-attached moving-picture data of a desired reproduction time from original sound-attached moving-picture data in which audio data and moving-picture data are multiplexed with each other, the sound-attached moving-picture data having a smaller data amount than that of the original sound-attached moving-picture data and being suitably used to output the corresponding sound and moving picture at the same time.

A second object of the present invention is to provide a device for converting data transmitted from a server to data which are based on the performance of a client, a transmission medium connected to the client, etc. without changing the specification of the server, and transmitting the converted data to the client.

A third object of the present invention is to provide a device which can perform a data conversion processing according to an user's instruction at a client side when the user instructs to control the data conversion processing of multimedia data.

A fourth object of the present invention is to provide a data converting device with which the user of a client can perform a search operation at high speed even when a data conversion processing having a large time cost is used.

A fifth object of the present invention is to provide a data converting device in which one of various kinds of data conversion processing having different time costs is suitably applied to multimedia data if occasion demands, whereby conversion data having as high quality as possible are supplied to a client with keeping the high search speed for the user of the client.

A sixth object of the present invention is to provide a device or system in which multimedia data can be serviced with a relay device having a function of identifying the kind of data and then performing a data conversion processing, without changing an user interface at a client side in both cases where the data conversion processing is performed and where no data conversion processing is performed.

A seventh object of the present invention is to provide a device or system in which the change of a display image at a client side in both cases where the data conversion processing is carried out and where no data conversion processing is carried out can be reduced when the multimedia data are serviced with a relay device having a function of identifying the kind of data and then performing a data conversion processing.

In order to attain the above objects, according to an aspect of the present invention, a sound-attached moving-picture data forming device is characterized by comprising:

(1) separation means for separating, into moving-picture data and sound data, sound-attached moving-picture data which are obtained by multiplexing sound data and moving-picture data with each other, the moving-picture data being obtained by coding moving-picture data of plural frames on a frame basis with an orthogonal transform coding;

(2) reducing means for deleting data representing high-frequency components of each frame from the moving-picture data separated by the separation means to thereby reduce a data amount of the moving-picture data; and

(3) multiplexing means for multiplexing reproduction target moving-picture data which correspond to a part of the moving-picture data reduced by the reducing means and which are obtained by coding data of frames whose number corresponds to a specified reproduction time, with reproduction target sound data which correspond to a part of the sound data separated by the separation means and which are to be reproduced simultaneously with the reproduction target moving-picture data.

In the sound-attached moving-picture data forming device as described above, the multiplexing means comprises:

(1) first forming means for forming first auxiliary data containing reproduction start time information of the head moving-picture data of each frame in the moving-picture data reduced by the reducing means every frame;

(2) second forming means for forming second auxiliary data containing reproduction start time information of the head sound data of each frame in the sound data separated by the separation means every frame to be simultaneously reproduced;

(3) first extraction means for extracting frames, the number of which corresponds to the specified reproduction time, from the moving data reduced by the reducing means on the basis of the first auxiliary data formed by the first forming means, thereby determining the reproduction target moving-picture data; and

(4) second extraction means for extracting, from the sound data separated by the separation means, those frames which have the reproduction start time corresponding to that of the reproduction target moving-picture data determined by the first extraction means on the basis of the first auxiliary data formed by the first forming means and the second auxiliary data formed by the second forming means, thereby determining the reproduction target sound data, wherein the reproduction target moving-picture data extracted by the first extraction means and the reproduction target sound data extracted by the second extraction means are multiplexed with each other.

According to another aspect of the present invention, a sound-attached moving-picture data forming device is characterized by comprising:

(1) separation means for separating, into moving-picture data and sound data, sound-attached moving-picture data which are obtained by multiplexing sound data and moving-picture data with each other, the moving-picture data containing plural GOPs (Group of Picture), each of which serves as a reproduction processing unit, contains moving-picture data of one or more frames which are encoded every frame in an inter-frame predictive coding system, and comprises an I-picture corresponding to a frame which is obtained by coding moving-picture data of a frame independently of moving-picture data of another frame, at least one P-picture corresponding to a frame obtained by forwardly predictively coding one I-picture at a forward side, and at least one B-picture corresponding to a frame obtained by bidirectionally predictively coding one I-picture or P-picture at a forward side and one I-picture or P-picture at a backward side;

(2) reducing means for replacing data of the B-picture with data having a predetermined value to reduce the data amount of the B-picture; and

(3) multiplexing means for extracting GOPs, the number of which corresponds to a specified reproduction time, from the moving-picture data reduced by the reducing means to thereby determine reproduction target moving-picture data which are moving-picture data to be reproduced, and multiplexing the reproduction target moving-picture data with reproduction target sound data which correspond to a part of the sound data separated by the separation means and which are to be reproduced simultaneously with the reproduction target moving-picture data.

In the sound-attached moving-picture data forming device as described above, the multiplexing means comprises:

(1) first forming means for forming first auxiliary data containing reproduction start time information of the head moving-picture data of each GOP in the moving-picture data reduced by the reducing means every GOP;

(2) second forming means for forming second auxiliary data containing reproduction start time information of the head moving-picture data of each picture in the moving-picture data reduced by the reducing means every picture;

(3) third forming means for forming third auxiliary data containing reproduction start time information of the head sound data of each frame in the sound data separated by the separation means every frame to be simultaneously reproduced;

(4) first extraction means for extracting GOPs, the number of which corresponds to the specified reproduction time, from the moving data reduced by the reducing means on the basis of the first auxiliary data formed by the first forming means, thereby determining the reproduction target moving-picture data; and

(5) second extraction means for extracting, from the sound data separated by the separation means, those frames which have the reproduction start time corresponding to that of the reproduction target moving-picture data determined by the first extraction means on the basis of the second auxiliary data formed by the second forming means and the third auxiliary data formed by the third forming means, thereby determining the reproduction target sound data, wherein the reproduction target moving-picture data extracted by the first extraction means and the reproduction target sound data extracted by the second extraction means are multiplexed with each other.

The multiplexing means as described above preferably serve to multiplex the data so that pauses of the GOPs are coincident with pauses of transmission processing units when the sound-attached moving-picture data are transmitted.

The first forming means may calculate the reproduction start time information of each GOP on the basis of a frame rate of the moving-picture data reduced by the reducing means and the number of pictures contained in all GOPs located at a front side of the GOP concerned, the second forming means can calculate the reproduction start time information of each picture on the basis of the frame rate of the moving-picture data reduced by the reducing means, the reproduction start time information for each GOP and a reproduction order of the picture concerned in the GOP containing the picture concerned, and the third forming means can calculate the reproduction start time information of each frame on the basis of a sampling frequency of the sound data separated by the separation means and the number of frames located at a front side of the frame concerned.

In the sound-attached moving-picture data forming device according to the present invention, the reducing means deletes the data representing the high-frequency components of the data of each frame for the moving-picture data separated by the separation means, thereby reducing the data amount of each frame.

The multiplexing means multiplexes the reproduction target moving-picture data which correspond to a part of the moving-picture data reduced by the reducing means and which are obtained by coding data of frames whose number corresponds to a specified reproduction time, with the reproduction target sound data which correspond to a part of the sound data separated by the separation means and which are to be reproduced simultaneously with the reproduction target moving-picture data.

Further, the reducing means replaces the data of the B-picture with data of a predetermined value for the moving-picture data separated by the separation means, thereby reducing the data amount of the B-picture.

By extracting the GOPs the number of which corresponds to the specified reproduction time from the moving-picture data reduced by the reducing means, the reproduction target moving-picture data which correspond to the moving-picture data to be reproduced are determined, and the determined reproduction target moving-picture data are multiplexed with the reproduction target sound data which correspond to a part of the sound data separated by the separation means and which are to be reproduced simultaneously with the reproduction target moving-picture data.

Accordingly, according to the sound-attached moving-picture data forming device of the present invention, sound-attached moving-picture data of a desired reproduction time, which has a data amount smaller than original sound-attached moving-picture data and are suitable to output corresponding moving pictures and sounds at the same time, can be formed from the original sound-attached moving-picture data.

According to another aspect of the present invention, a data converting device is characterized by comprising information input means for receiving input information containing one or more kinds of data, data analyzing means for checking the kind of each data constituting the input information and extracting data from the input information when the data are judged to be data which are predetermined as conversion target data to be subjected to a data amount conversion processing, control means for performing the conversion processing on the data amount of the extracted data in accordance with a regulation which is predetermined for the kind of the data, information constructing means for replacing the converted data of the input information with the data before the conversion processing, thereby reconstructing the input information, and information output means for outputting the reconstructed information.

The information input means as described above may be designed to receive a command (expansion command) instructing to convert the size of specific data in a specific conversion rate, and may be provided with processing means of analyzing the content of the received expansion command and giving the data obtained by converting the size of the specific data in the specific conversion rate as the converted data which are treated by the information constructing means.

The information input means receives one or more kinds of data, and the data analyzing means checks the kind of each data constituting the input information and extracts the data from the input information when the data are judged to be the data which are predetermined as the conversion target data to be subjected to the data amount conversion processing. The control means performs the conversion processing on the data amount of the extracted data according to a regulation which is predetermined in accordance with the kind of the data, and the information constructing means replaces the converted data of the input information by the data before the conversion processing, thereby reconstructing the input information. The information output means outputs the reconstructed information. With this construction, the data amount of the input data can be automatically adjusted.

Furthermore, the input means receives the command of instructing to convert the size of the specific data in the specific conversion rate. The processing means analyzes the content of the received command, and gives the data obtained by converting the size of the specific data in the specific conversion rate as the converted data which are treated by the information constructing means. With this construction, an user can instruct control of the conversion processing of multimedia data to perform a data conversion processing according to the instruction.

Furthermore, according to another aspect of the present invention, a data converting device is characterized by comprising information input means for receiving input information containing one or more kinds of data, data converting means for performing a data conversion processing on conversion target data to be subjected to a data amount conversion processing according to a predetermined regulation, storing means for storing the converted input information, and information output means for outputting the converted information or the information stored in the storing means, wherein the information output means comprises a data converting device having a function of outputting information existing in the storing means without performing the conversion processing when the same information as the converted input information exist in the storing means.

The data converting means may have plural kinds of predetermined regulations for the data conversion, and have a function of selecting one regulation from the regulation group, outputting only data which are converted according to the selected regulation, and storing in the storing means those data which are converted according to all the regulations of the regulation group.

The input means receives one or more kinds of data, and the data converting means performs the conversion processing on conversion target data (which are needed to be subjected to the data amount conversion processing) according to a predetermined regulation, and stores the converted data in the storing means. The output means outputs the converted information of the information stored in the storing means, and if the same information as the converted input information exists in the storing means, the output means outputs the information existing in the storing means without performing the conversion processing. Accordingly, by holding data which have been once subjected to the conversion processing, the converted data can be output at high speed without repeating the conversion processing on the same data.

Also, the data converting means has plural kinds of predetermined regulations for the data conversion, and has a function of selecting one regulation from the regulation group, outputting only data which are converted according to the selected regulation, and storing in the storing means those data which are converted according to all the regulations of the regulation group. Accordingly, even when no data exist in the storing means, the data can be output without reducing the transmission rate by using a high-speed conversion regulation, and data which are stored in the storing means and generated according to a conversion regulation to convert the data to high-quality data can be output without performing the conversion processing in a second or subsequent operation. Therefore, converted data whose quality is as high as possible can be output with keeping the high speed of the data output.

According to another aspect of the present invention, in an information processing system which comprises a first information processing device for supplying data, a data conversion relay device which is connected to the first information processing device through a network, and a second information processing device which is connected to the data conversion relay device through the network, wherein a data demand from the second information processing device is transmitted through the data conversion relay device to the first information processing device, the first information processing device supplies the data corresponding to the data demand through the data conversion relay device to the second information processing device, and the second information processing device displays images or characters which are represented by the supplied data, when the data supplied from the first information processing device are video data, the data conversion relay device converts the video data so that an image represented by the video data is reduced, and supplies the converted video data to the second information processing device. When the data demand from the second information processing device is a data demand containing coordinate values of the video data, the data conversion relay device corrects the coordinate values by multiplying the coordinate values by the inverse number of the reduction ratio of the image, and transmits the data demand having the corrected coordinate values to the first information processing device.

According to another aspect of the present invention, when the data supplied from the first information processing device are video data, the data conversion relay device of another information processing system converts the video data so that an image represented by the video data is reduced, and then supplies the converted video data to the second information processing device. When the data supplied from the first information processing device are text data, the data conversion relay device converts the text data so that the size of characters contained in the text data are reduced in the same reduction ratio as the image as described above, and then supplies the converted data to the second information processing device.

Furthermore, in the information processing system of the present invention, when the data supplied from the first information processing device are video data, the data conversion relay device may convert the video data so that an image represented by the video data is reduced, and then supply the converted data to the second information processing device. The second information processing device may enlarge the image represented by the supplied video data on the basis of the inverse number of the reduction ratio of the video data, and then display the converted data.

Still furthermore, when the data supplied from the first information processing device are video data, the data conversion relay device may convert the video data so that an image represented by the video data is reduced, and then supply the converted data to the second information processing device. When the data supplied from the first information processing device through the data conversion relay device are text data, the second information processing may convert the text data in the same reduction ratio as the image so that the size of characters contained in the text data is reduced, and then display the converted data.

### BRIEF DESCRIPTION OF THE DRAWINGS

FIG. 1 is a block diagram showing the construction of a video server to which a first embodiment of the present invention is applied;

FIG. 2 is a diagram showing a data flow in a sound-attached moving-picture data of the first embodiment;

FIG. 3 is a flowchart showing a process flow of a sound-attached moving-picture data forming device of the first embodiment;

FIG. 4 shows the data structure of sound-attached moving-picture data of MPEG1 format;

FIG. 5 is a flowchart showing a process flow of a separation processing in the first embodiment;

FIG. 6 shows the data structure of moving-picture data of MPEG1 format;

FIG. 7 is a flowchart showing a process flow of a reduction processing in the first embodiment;

FIG. 8 shows the data structure of GOP auxiliary data used for the reduction processing in the first embodiment;

FIG. 9 shows the data structure of picture auxiliary data used for the reduction processing in the first embodiment;

FIG. 10 shows the data structure of sound (audio) data of MPEG1 format;

FIG. 11 shows the data structure of AAU auxiliary data used for the reduction processing in the first embodiment;

FIG. 12 is a flowchart showing a process flow of a multiplex processing in the first embodiment;

FIG. 13 shows the data structure of dummy data used for a reduction processing in a second embodiment;

FIG. 14 is a flowchart showing a process flow of the reduction processing in the second embodiment;

FIG. 15 is a diagram showing the construction of a third embodiment;

FIG. 16 is a diagram showing the construction of a multimedia data amount control relay device of the third embodiment;

FIG. 17 is a diagram showing the construction of a conventional multimedia network system;

FIG. 18 is a functional block diagram of the third embodiment;

FIG. 19 is a diagram showing the construction of multimedia data;

FIG. 20 is a diagram showing an example of multimedia data;

FIG. 21 is a diagram showing an example of multimedia data;

FIG. 22 is a diagram showing a display on a screen at a client side;

FIG. 23 is a diagram showing a display on the screen at the client side;

FIG. 24 is a diagram showing a control table;

FIG. 25 is a flowchart showing a processing content in the embodiment of the present invention;

FIG. 26 is a diagram showing an example of conversion target multimedia data;

FIG. 27 is a flowchart showing a processing content in the embodiment of the present invention;

FIG. 28 is a diagram showing an example of converted multimedia data;

FIG. 29 is a flowchart showing a processing content in the embodiment of the present invention;

FIG. 30 is a diagram showing an example of the multimedia data;

FIG. 31 is a diagram showing a display on the client's screen of the third embodiment;

FIG. 32 is a diagram showing an example of the multimedia data;

FIG. 33 is a diagram showing a display on the client's screen of the third embodiment;

FIG. 34 is a diagram showing an expansion table;

FIG. 35 is a flowchart showing a processing content of the embodiment of the present invention;

FIG. 36 is a flowchart showing a processing content of the embodiment of the present invention;

FIG. 37 is a diagram showing an example of expansion target multimedia data;

FIG. 38 is a flowchart showing a processing content of the embodiment according to the present invention;

FIG. 39 is a diagram showing an example of the expanded multimedia data;

FIG. 40 is a flowchart showing a processing content of the embodiment according to the present invention;

FIG. 41 is a diagram showing an example of the multimedia data;

FIG. 42 is a diagram showing an example of the multimedia data;

FIG. 43 is a diagram showing a display on the client's screen in a fourth embodiment;

FIG. 44 is a diagram showing another example of the expansion table;

FIG. 45 is a diagram showing a display on the client's screen in the fourth embodiment;

FIG. 46 is a diagram showing another example of the expansion table;

FIG. 47 is a diagram showing a display on the client's screen in a sixth embodiment;

FIG. 48 is a diagram showing the construction of a seventh embodiment;

FIG. 49 is a diagram showing the construction of a cache-attached data converting device of the seventh embodiment;

FIG. 50 is a diagram showing the construction of a conventional multimedia network system;

FIG. 51 is a functional block diagram of the seventh embodiment;

FIG. 52 shows the data structure of multimedia data;

FIG. 53 is a diagram showing an example of the multimedia data;

FIG. 54 is a diagram showing an example of the multimedia data;

FIG. 55 is a diagram showing a display on the client's screen;

FIG. 56 is a diagram showing a display on the client's screen;

FIG. 57 is a diagram showing an example of the multimedia data;

FIG. 58 is a diagram showing an example of the multimedia data;

FIG. 59 is a diagram showing a display on the client's screen;

FIG. 60 is a diagram showing an example of the multimedia data;

FIG. 61 is a flowchart showing a processing content of the embodiment according to the present invention;

FIG. 62 is a flowchart showing a processing content of the embodiment according to the present invention;

FIG. 63 is a flowchart showing a processing content of the embodiment according to the present invention;

FIG. 64 is a diagram showing an example of the multimedia data;

FIG. 65 is a diagram showing a display on the client's screen;

FIG. 66 is a flowchart showing a processing content of the embodiment of the present invention;

FIG. 67 is a flowchart showing a processing content of the embodiment of the present invention;

FIG. 68 is a diagram showing an example of multimedia data;

FIG. 69 is a diagram showing a display on the screen of the embodiment according to the present invention;

FIG. 70 is a functional block diagram of a tenth embodiment;

FIG. 71 is a flowchart showing a processing content of the embodiment of the present invention;

FIG. 72 is a diagram showing a display on the screen of the embodiment of the present invention;

FIG. 73 is a diagram showing the construction of a system which shows characteristics of twelfth and thirteenth embodiments of the present invention;

FIG. 74 is a diagram showing the construction of an example of a network system;

FIG. 75 is a diagram showing a display of a hypertext;

FIG. 76 is a diagram showing a display of a data-converted hypertext;

FIG. 77 is a functional block diagram which diagrammatically shows the functions achieved by a server;

FIG. 78 is a functional block diagram which diagrammatically shows the functions achieved by a client;

FIG. 79 is a diagram showing the construction of a data conversion relay device having a correcting function;

FIG. 80 is a functional block diagram which diagrammatically shows the functions achieved by a first correcting-function attached data conversion relay device;

FIG. 81 is a functional block diagram which diagrammatically shows the functions achieved by a second correcting-function attached data conversion relay device;

FIG. 82 is a diagram showing a first display correction;

FIG. 83 is a diagram showing a second display correction;

FIG. 84 is a diagram showing the construction of a system which shows characteristics of fourteenth embodiment of the present invention;

FIG. 85 is a functional block diagram which diagrammatically shows the functions of the data conversion relay device;

FIG. 86 is a functional block diagram which shows a correcting-function attached client;

FIG. 87 is a diagram showing the construction of a WWW server;

FIG. 88 is a diagram showing the construction of a client;

FIG. 89 is a diagram showing data of HTML format;

FIG. 90 is a diagram showing a map set file;

FIG. 91 is a flowchart showing the processing of the correcting-function attached data conversion relay device of the twelfth embodiment;

FIG. 92 is a diagram showing a data correction 1 of HTML format;

FIG. 93 is a diagram showing a data correction 2 of HTML format;

FIG. 94 is a flowchart showing the processing of the correcting-function attached data conversion relay device of the thirteenth embodiment; and

FIG. 95 is a flowchart showing the processing of the correcting-function attached client of the fourteenth embodiment.

### DETAILED DESCRIPTION OF PREFERRED EMBODIMENTS

Preferred embodiments according to the present invention will be described hereunder with reference to the accompanying drawings.

(First Embodiment)

First, a first embodiment according to the present invention will be described. In the following description, sound-attached moving-picture data are assumed to sound-attached moving-picture data of MPEG1 format.

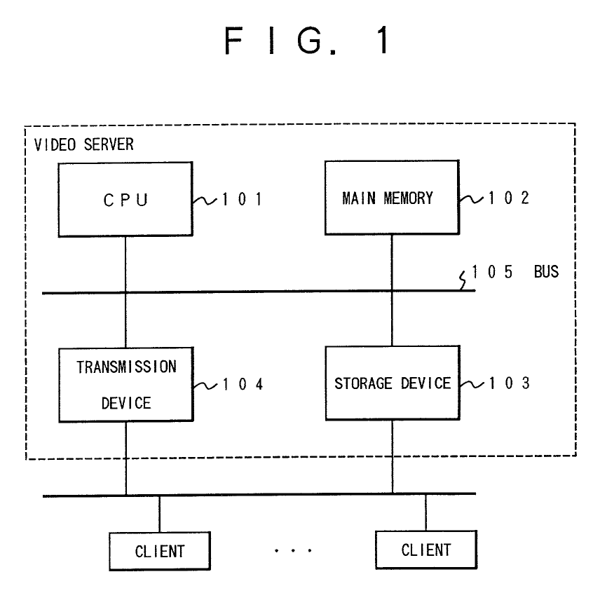

FIG. 1 is a block diagram showing the construction of a video server to which a first embodiment is applied. As shown in FIG. 1, a video server comprises a CPU 101, a main memory 102, a storage device 103, a transmission device 104 and a bus 105.

In this embodiment, the following sound-attached moving-picture (video) data forming processing is performed. That is, on the basis of original sound-attached moving-picture data of MPEG1 format which are stored in the storage device 103, MPEG1-format sound-attached moving-picture data of a desired reproduction time which has a data amount smaller than the original sound-attached moving-picture data and are suitable to output corresponding moving pictures and sounds (which are associated with each other) at the same time, and the formed MPEG1-format sound-attached moving-picture data thus formed are stored in the storage device 103.

According to this embodiment, the sound-attached moving-picture data forming processing which is performed by the video server is realized by using a software. That is, the CPU 101 loads the software stored in the storage device 103 to the main memory 102, and executes the loaded software on the main memory 102 to perform the sound-attached moving-picture data forming processing.

The main memory 102 comprises a volatile storage device which is formed of a storing medium such as a semiconductor memory or the like, and the storage device 103 comprises a nonvolatile storage device which is formed of a storing medium such as a magnetic storage device or the like.

The transmission device 104 transmits through the network to a client the MPEG1-format sound-attached moving-picture data which are formed in the sound-attached moving-picture data processing and stored in the storage device 103. The data transmission which is performed through the bus 105 between respective blocks is entirely controlled by the CPU 101. Furthermore, an input device such as a keyboard, a mouse or the like and a display device such as a CRT or the like may be equipped.

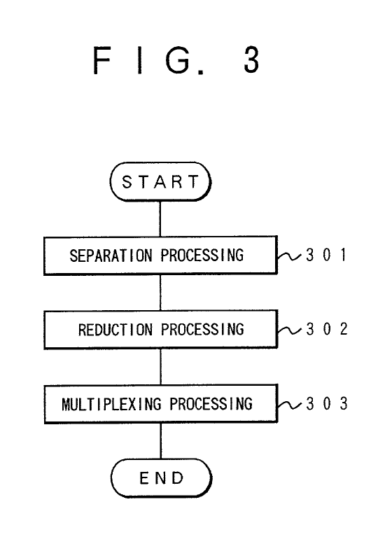

FIG. 3 is a flowchart showing a process flow of the sound-attached moving-picture forming processing which is performed by the video server. In the sound-attached moving-picture data forming processing, a separation processing 301, a reduction processing 302, and a multiplex processing 303 are performed in this order as shown in FIG. 3. The details of each processing will be described hereunder in detail.

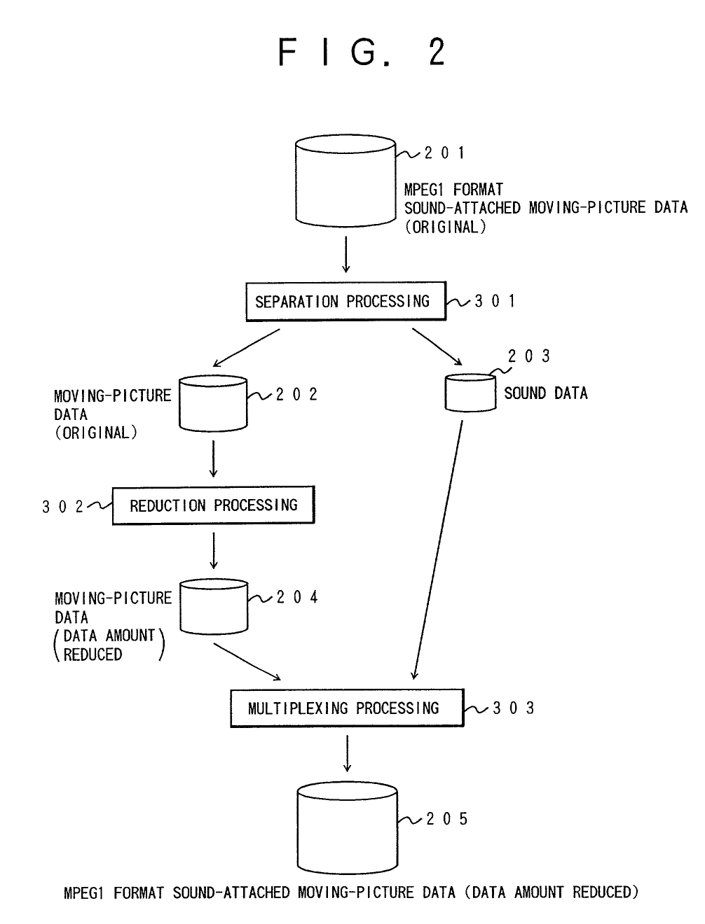

FIG. 2 is a diagram showing a data flow of the sound-attached moving-picture data forming processing.

In FIG. 2, a file 201 serves to store the original MPEG1-format sound-attached moving-picture data. A file 202 serves to store moving-picture data which are separated from the original sound-attached moving-picture data stored in the file 201 by the separation processing 301. Likewise, a file 203 serves to store sound (audio) data which are separated from the original sound-attached moving-picture data stored in the file 201 by the separation processing 301. A file 204 serves to store moving-picture data which are obtained by reducing the data amount of the moving-picture data stored in the file 202 by the reduction processing 302. A file 205 serves to store MPEG1-format sound-attached moving-picture data which are obtained by multiplexing the moving-picture data stored in the file 204 and the sound data stored in the file 203. The MPEG1-format sound-attached moving-picture data stored in the file 205 are transmitted through the network to a client. These files 201 to 205 are installed in the storage device 103.

Next, the sound-attached moving-picture data forming processing will be described in detail.

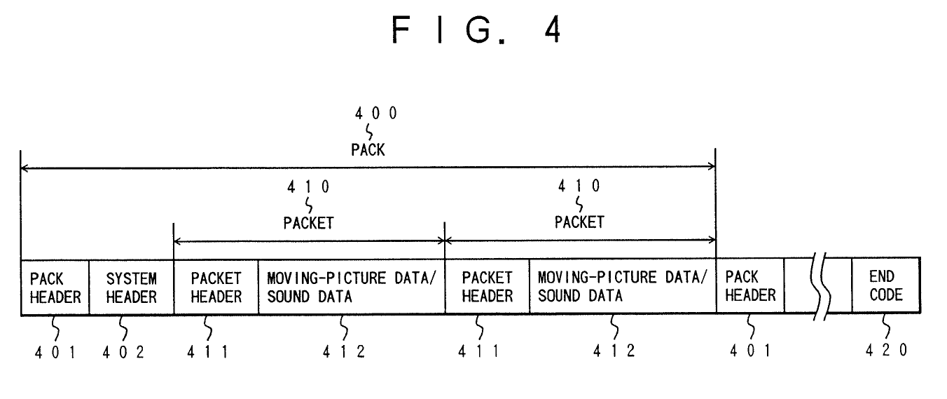

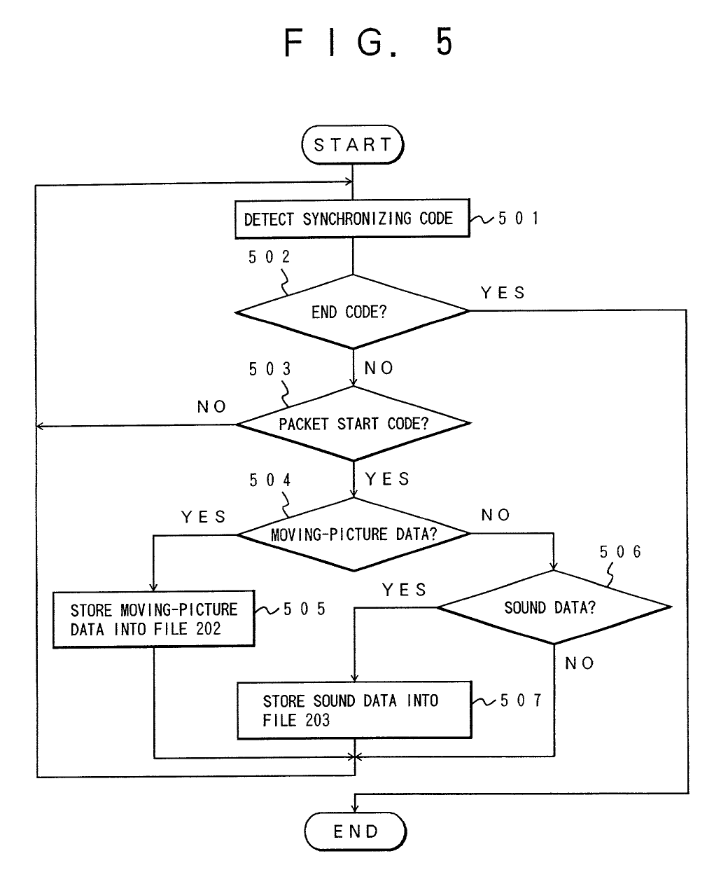

First, the separation processing 301 will be described with reference to FIGS. 4 and 5.

FIG. 4 shows the data structure of the MPEG1-format sound-attached moving-picture data. As shown in FIG. 4, the MPEG1-format sound-attached moving-picture data are designed in a hierarchical structure having two layers of a pack 400 and a packet 410. The pack 400 comprises a pack header 401, a system header 402 and one or more packets 410.

The pack header 401 comprises a pack start code (a kind of synchronizing code) indicating the head of the pack 400, a system time reference value to give a time reference to a time stamp as described later, a multiplexing rate, etc. The system header 402 comprises a system header start code (a kind of synchronizing code) indicating the head of the system header 402, a bit rate, the number of channels of moving-picture data, the number of channels of sound data, etc.

The packet 410 comprises a packet header 411 and data (moving-picture data or sound data) 412. The packet header 411 comprises a packet start code (a kind of synchronizing code) indicating the head of the packet 410, a time stamp which is time information required to output the corresponding moving pictures and sounds (which are associated with each other) at the same time, etc. The time stamp is classified into two types, one type being reproducing-time managing information for indicating a reproduction time and the other type being decoding-time managing information for indicating a decoding time. The packet start code contains a data-type identifying code for the data 412.

The last of the pack 400 is added with an end code 420 (a kind of synchronizing code) indicating the end of sound-attached moving-picture data.

FIG. 5 is a flowchart showing the detailed process flow of the separation processing 301 (FIG. 3).

In the separation processing 301, as shown in FIG. 5, a synchronizing code, which is determined according to MPEG1 system multiplexing standards, is detected from the original MPEG1-format stored in the file 201 (step 501). Subsequently, it is judged whether the synchronizing code detected in step 501 is the end code 420 (step 502). If it is the end code 420, the processing is finished. On the other hand, if it is not the end code 420, it is judged whether the synchronizing code detected in step 501 is the packet start code (contained in the packet header 411) (step 503).

If the synchronizing code is not the packet start code, the process returns to step 501. On the other hand, if the synchronizing code is the packet start code, the data type of the data 412 in the packet 410 is identified on the basis of the data type contained in the packet start code (step 504). If the data type of the data 412 represents moving-picture data, the moving-picture data 412 are stored in the file 202 (step 505). On the other hand, if the data type of the data 412 is judged not to be the moving-picture data in step 504, the data type of the data 412 in the packet 410 is identified on the basis of the data type contained in the packet start code (step 506). If the data type of the data 412 does represent sound data, the process returns to step 501. If the data type of the data 412 represents the sound data, the sound data 412 are stored in the file 203 (step 507).

As described above, the MPEG1-format sound-attached moving-picture data stored in the file 201 are separated into the moving-picture data and the sound data by the separation processing, and the moving-picture data and the sound data thus separated are stored in the files 202 and 203, respectively.

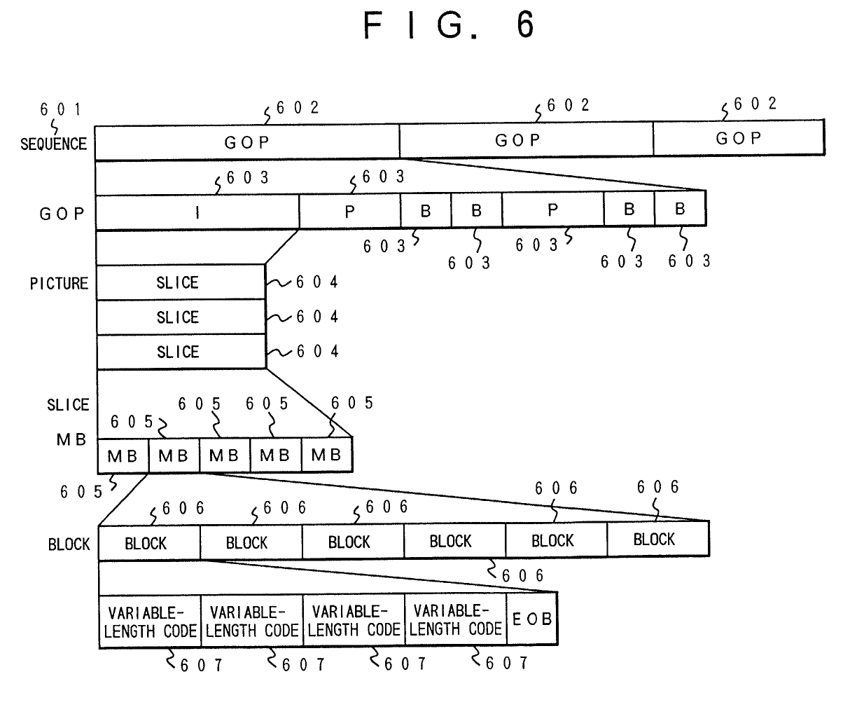

Next, the reduction processing 302 (FIG. 3) will be described with reference to FIGS. 6 and 7.

FIG. 6 shows the data structure of the moving-picture data of MPEG1 format. As shown in FIG. 6, the MPEG1-format moving-picture data are designed in a hierarchical structure comprising six layers of a sequence 601, GOP (Group of Picture) 602, a picture 603, a slice 604, MB (Macro Block) 605, a block 606.

The sequence 601 represents a frame group of frames which are identical in a series of attributes such as a pixel number, a frame rate, etc., and comprises one or more GOPs 602. The GOP 602 is the minimum unit of the frame group which corresponds to a decode processing unit, and comprises one or more pictures (frames) 603. The picture 603 is a common attribute for a frame, and classified into the following three picture types: I-picture (Intra-Picture: in-frame coded image), P-picture (Predictive-Picture: inter-frame forwardly predictive coded image) and B-picture (Bidirectionally predictive-Picture: bidirectionally predictive coded image). The picture 603 comprises one or more slices 604.

Next, the data of each picture type will be briefly described.

The data of an I-picture are obtained by coding the moving-picture data on the basis on only the information thereof with no inter-frame prediction. The data of a P-picture are obtained by coding the moving-picture data on the basis of a prediction using the data of an I-picture or P-picture which is the nearest to the P-picture at a forward side. The data of a B-picture are obtained by coding the moving-picture data on the basis of a prediction using the data of I-pictures or P-pictures which are the nearest to the B-picture at both forward and backward sides. Accordingly, the data of the B-picture are encoded after the data of the I-picture and the P-picture are encoded, and are not used for a prediction when another picture is encoded. The data of the I-picture or P-picture are set to appear periodically.

As described above, in the MPEG1-format moving-picture data, the coding order of the data constituting the B-picture is varied, and thus the decoding order and the reproduction order are different. Therefore, the time stamp as described above is provided to perform the decoding and reproducing operation of the moving-picture data in the correct order so that the moving-picture data and the corresponding sound data are output at the same time.

Referring to FIG. 6, the slice 604 is common information for small frames into which one frame are segmented at any length, and it comprises at least one MB 605 which is sequential in a frame scanning order. One MB 605 comprises six blocks 606 at maximum. The block 606 comprises two or more variable-length codes 607. The variable-length code 607 is an efficiency representing a spatial frequency, and the final variable-length code 607 is an EOB (End of Block) code.

FIG. 7 is a flowchart showing the process flow of the reduction processing 302.

In the reduction processing 302, the maximum number of the variable-length codes 607 per block 606 (hereinafter referred to as “maximum code number”) of the moving-picture data to be stored in the file 204 is determined on the basis of a predetermined demand coding amount as shown in FIG. 7 (step 701). Here, the demand coding amount is determined on the basis of the transmission rate of the network and the processing capability of a client to which the CPU 101 is going to transmit the MPEG1-format sound-attached moving-picture data when the CPU 101 performs the sound-attached moving-picture data forming processing. That is, on the basis of the processing capability of the client and the transmission rate of the network, the CPU 101 calculates the maximum coding amount of the moving-picture data at which the corresponding moving pictures and sounds can be output at the same time at the client side, and determines the calculated maximum coding amount as a demand coding amount. When the video server is equipped with an input device such as a keyboard, a mouse or the like, it may be input through the input device.

Subsequently, the moving-picture data stored in the file 202 are scanned until a block 606 is detected, and portions other than the block 606 are extracted and stored in the file 204 (step 702). Thereafter, the number of variable-length codes 607 contained in the block 606 which is detected in step 702 is counted to obtain a coding number (step 703).

Subsequently, the maximum coding number determined in step 701 is compared with the coding number obtained in step 703 (step 704). If the coding number is larger than the maximum coding number, the maximum coding number of the variable-length codes 607 beginning with the head code of the block 606 detected in step 702, and the EOB code are stored in the file 204 (step 705). On the other hand, if the coding number is equal to or less than the maximum coding number, all the variable-length codes 607 (containing the EOB code) contained in the block 606 detected in step 702 are stored in the file 204 (step 706).

Finally, it is judged whether the end code indicating the end of the moving-picture data which is set according to the MPEG1 video coding standards exists subsequently to the block 606 detected in step 702 (step 707). If the end code exists, the processing is finished. If no end code exists, the process returns to step 702.

As described above, a part (variable-length codes 607 in the block 606) of the moving-picture data which have been stored in the file 202 is deleted to reduce the data amount of the moving-picture data, and the moving-picture data whose data amount is reduced are stored in the file 204.

In the reduction processing 302, the variable-length codes 607 which are near to the EOB code are deleted, so that the high-frequency components of the moving-picture data which are coded by the orthogonal transform coding are deleted.

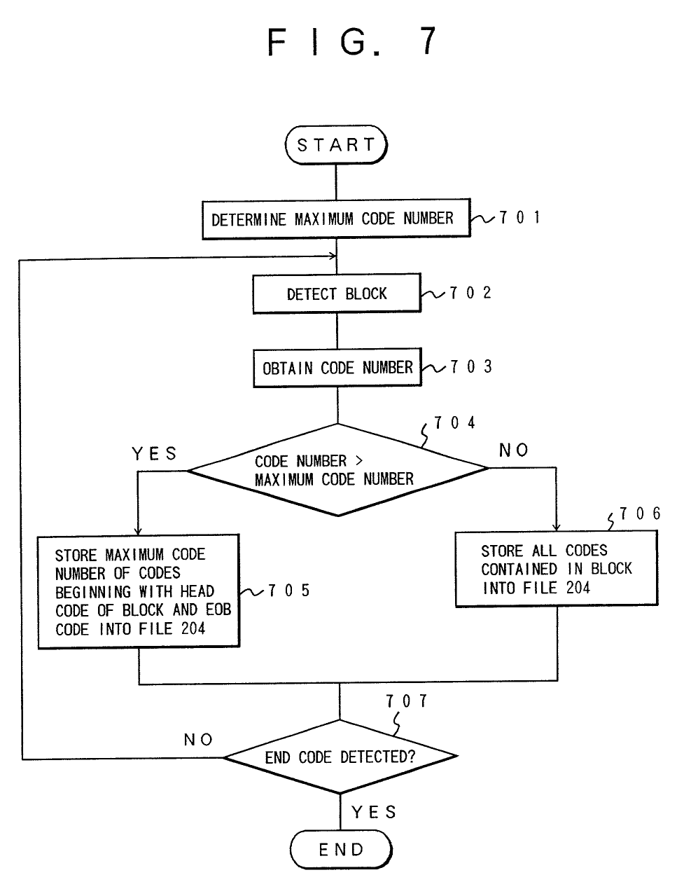

Next, the multiplex processing 303 (FIG. 3) will be described with reference to FIGS. 8 to 12.

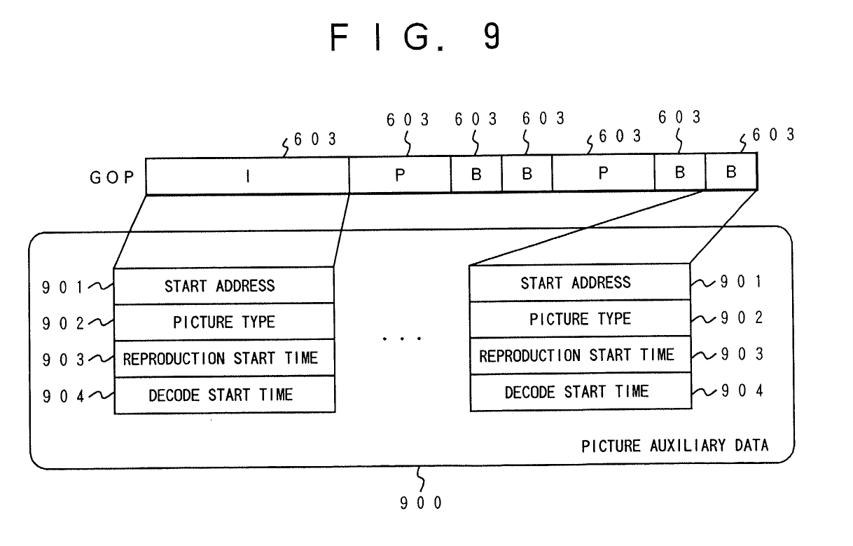

FIG. 10 shows the data structure of the sound data of MPEG1 format. As shown in FIG. 10, the MPEG1-format sound data comprises plural AAU (Audio Access Unit) 1001. The AAU 1001 contains a predetermined sample number of sound data which is the minimum decode processing unit, and it comprises an AAU header 1002 and audio data 1003. Here, the AAU header 1002 comprises a coding mode, a bit rate, a sampling frequency, etc., and the audio data 1003 comprise coded sound data.

FIG. 12 is a flowchart showing the process flow of the multiplex processing 303.

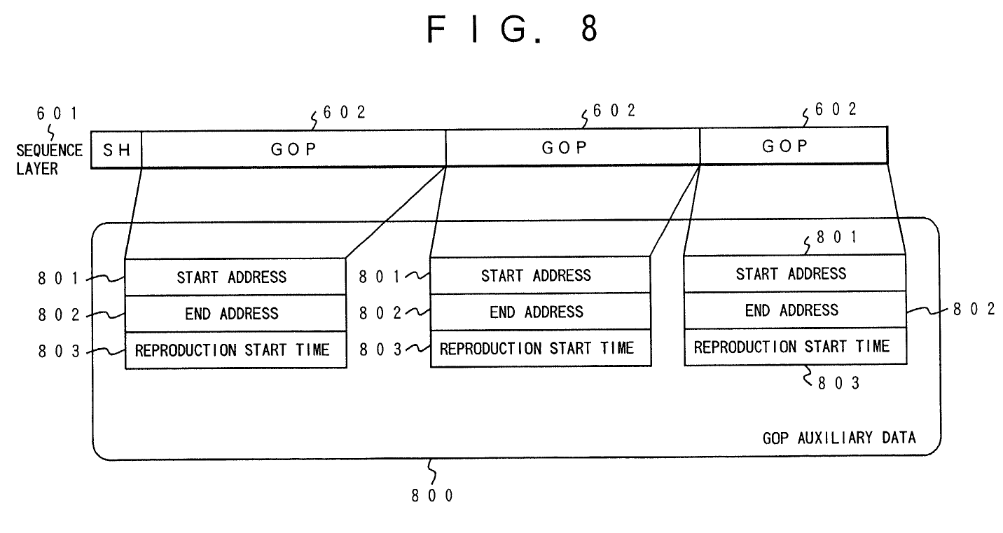

In the multiplex processing 303, as shown in FIG. 12, the moving-picture data stored in the file 204 are first analyzed to form GOP auxiliary data 800 shown in FIG. 8 for every GOP 602 and form picture auxiliary data 900 shown in FIG. 9 for every picture 603 (step 1201).

As shown in FIG. 8, the GOP auxiliary data 800 comprise a reproduction start time 803 of the GOP 602, a start address 801 of the GOP 602, and an end address 802 of the GOP 602.

In the GOP auxiliary data 800, the reproduction start time 803 of the GOP 602 concerned can be calculated on the basis of the frame rate of the moving-picture data and the number of pictures 603 contained in all GOPs 602 before the GOP 602 concerned. The start address 801 of the GOP 602 concerned can be calculated on the basis of the position of the head of the GOP 602 concerned from the head of the moving-picture data. The end address 802 of the GOP 602 concerned can be calculated on the basis of the position of the head of the subsequent (next) GOP 602 from the head of the moving-picture data. If no GOP 602 exists subsequently to the GOP 602 concerned, the end address 802 of the GOP 602 concerned can be calculated on the basis of the position of the end of the moving-picture data from the head of the moving-picture data.

As shown in FIG. 9, the picture auxiliary data 900 comprise a reproduction start time 903 of the picture 603, a decode start time 904 of the picture 603, a picture type 902 of the picture 603, and a start address 901 of the picture 603. In the picture auxiliary data 900, the start address 901 of the picture 603 concerned can be calculated on the basis of the position of the picture 603 concerned from the head of the moving-picture data. The picture type 902 is set by directly setting the picture type of the picture 603 concerned. The reproduction start time 903 of the picture 603 concerned can be calculated on the basis of the frame rate of the moving-picture data, the reproduction start time 803 of the GOP auxiliary data 800, and a display order of the picture 603 concerned in the GOP 602. The decode start time 904 of the picture 603 concerned can be calculated on the basis of the frame rate of the moving-picture data, the reproduction start time 803 of the GOP auxiliary data 800, the display order of the picture 603 concerned in the GOP 602, and the picture type 902.

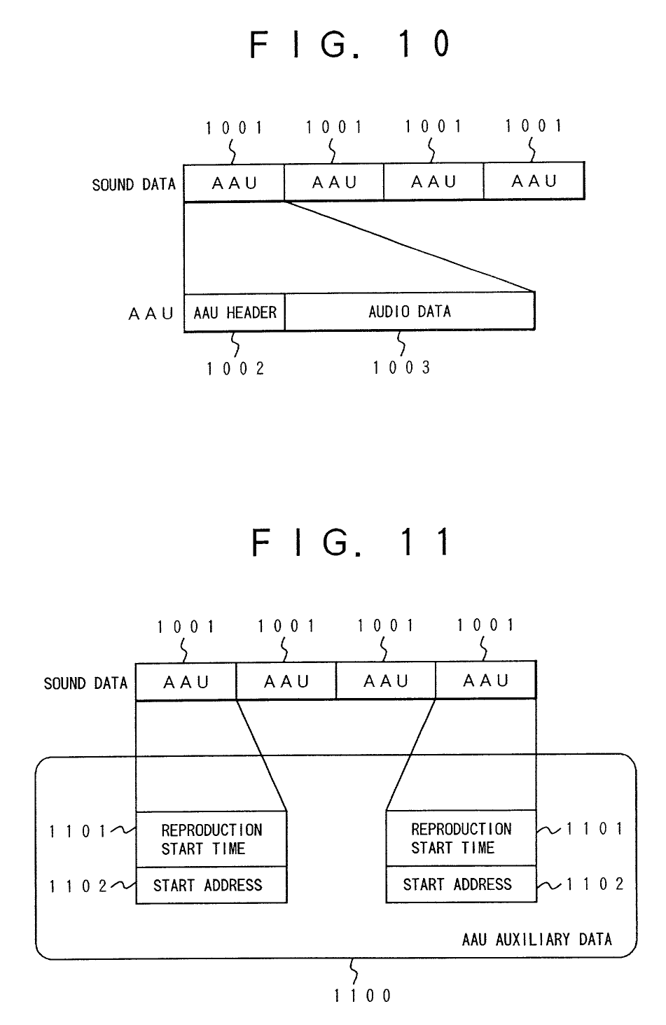

Subsequently to step 1201, the sound data stored in the file 203 are analyzed to form AAU auxiliary data 1100 shown in FIG. 11 (step 1202). As shown in FIG. 11, the AAU auxiliary data 1100 comprise a reproduction start time 1101 of each AAU 1001 and a start address 1102 of each AAU 1001. In the AAU auxiliary data 1100, the reproduction start time 1101 of the AAU 1001 concerned can be calculated on the basis of the sampling frequency of the sound data, and the number of samples per AAU 1001. The start address 1102 of the AAU 1001 concerned can be calculated on the basis of the position of the head of the AAU 1001 concerned from the head of the sound data.

Subsequently, a corresponding (connecting) operation of establishing a corresponding relationship between the AAU 1001 and the GOP 602 is performed for every GOP 602 so that the corresponding (associated) moving pictures and sounds can be output at the same time (step 1203). This operation is performed by searching AAU auxiliary data 1100 in which a reproduction start time 1101 which is equal or the nearest to the reproduction start time 803 of each GOP 602 of the GOP auxiliary data 800 is set, and making a correspondence between each GOP 602 and AAUs 1101 from the AAU 1001 of the searched AAU auxiliary data 1100 till the AAU 1001 of the next searched AAU auxiliary data 1100. Ordinarily, AAUs 1001 of several tens are connected to one GOP 602.

Subsequently, the GOP 602 to be extracted as a multiplexing target and the AAU 1001 which is connected to the GOP 602 in step 1203 are determined (step 1204). Here, the GOP 602 to be extracted as a multiplexing target is determined on the basis of a reproduction speed specified by a client to which the MPEG1-format sound-attached moving-picture data are to be transmitted. That is, when the reproduction speed specified by the client is once speed (normal reproduction speed), all the GOPs 602 are extracted as multiplexing targets. When the reproduction speed specified by the client is double speed (reproduction speed for fast forward reproduction), in order to perform the reproduction in a half reproduction time, every other GOPs 602 are skipped and a half of all the GOPs 602 are extracted as a multiplexing targets. In general, by extracting GOPs 602 of T as multiplexing targets from GOPs 602 of S, and then determining the corresponding AAU 1001 for each of the extracted GOPs 602, can be obtained sound-attached moving-picture data having a reproduction time of T/S-times of the reproduction time of the original moving-picture data. S and T represent natural numbers and satisfy the following relation: S≦T.

Finally, the GOP 602 and the AAU 1001 which are determined in step 1204 are respectively divided into packets and then multiplexed with each other to form the MPEG1-format sound-attached moving-picture data, and then the MPEG1-format sound-attached moving-picture data thus formed are stored in the file 205 (step 1205). At this time, the system time reference value contained in the pack header 401 and the time stamp contained in the packet header 411 are calculated and set on the basis of the reproduction start time 903 of the picture auxiliary data 900 and the reproduction start time 1101 of the AAU auxiliary data 1100. When the GOP 602 and the AAU 1001 are divided into the packets, the data type of the data 412 to be stored in a packet 410 is determined on the basis of the reproduction start time 903 and the start address 901 of the picture auxiliary data 900, and the reproduction start time 1101 and the start address 1102 of the AAU auxiliary data 1100.

Thus, the MPEG1-format sound-attached moving data of a desired reproduction time which are formed by multiplexing the moving-picture data stored in the file 204 and the sound data stored in the file 203 with each other through the multiplex processing, are stored in the file 205.

As described above, according to this embodiment, the MPEG1-format sound-attached moving-picture data of the desired reproduction time, whose data amount is smaller than that of the original MPEG1-format sound-attached moving-picture data and which are suitable to output the corresponding moving pictures and sounds at the same time, can be formed from the original MPEG1-format sound-attached moving-picture data.

In this embodiment, the MPEG1-format sound-attached moving-picture data thus formed are temporarily stored in the storage device 103, and then transmitted to the client. However, the MPEG1-format sound-attached moving-picture data thus formed may be directly transmitted to the client.

(Second Embodiment)

Next, a second embodiment of the present invention will be described.

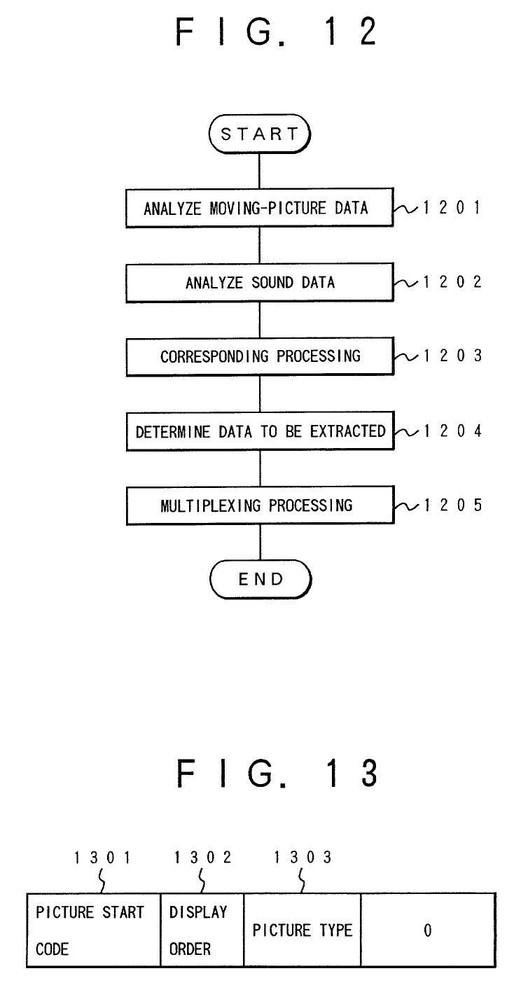

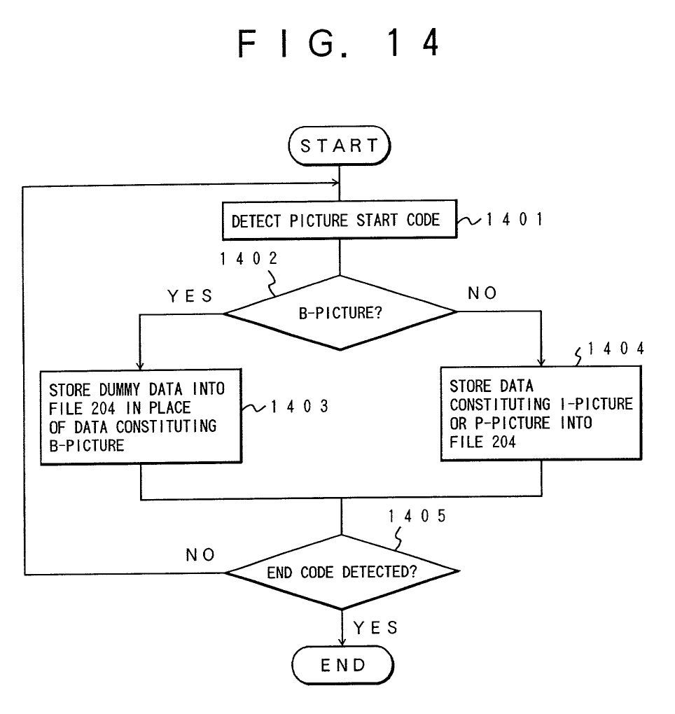

In the second embodiment, the following reduction processing 304 is used in place of the reduction processing 302. The reduction processing 304 will be described hereunder in detail with reference to FIGS. 13 and 14.

FIG. 14 is a flowchart showing the process flow of the reduction processing 304. In the reduction processing 304, the moving-picture data stored in the file 202 are first scanned until the start code of the picture 603 is detected, and portions other than the picture 603 are extracted and stored in the file 204 as shown in FIG. 14 (step 1401).

Subsequently, on the basis of the picture type of the picture 603 detected in step 1401, it is judged whether the picture 603 is a B-picture (step 1402). If the picture is the B-picture, dummy data shown in FIG. 13 are stored in place of the data constituting the B-picture (step 1403).

FIG. 13 shows the data structure of the dummy data. In FIG. 13, a picture start code 1301 indicates start of the picture 603 (a kind of synchronizing code). Further, a display order in the GOP 602 of the picture 603 is set in a display order 1302. A picture type 1303 is a datum indicating the picture type of the picture 603, and in this case the picture type 1303 indicates “B-picture”.

When the data type represents “I-picture” or “P-picture”, the data of the I-picture or P-picture are directly stored in the file 204 (step 1404).

Finally, it is judged whether the end code indicating the end of the moving-picture data exists subsequently to the picture 603 detected in step 1401 (step 1405). If the end code exists, the processing is finished. If no end code exists, the process returns to step 1401.

Thus, with the reduction processing, a part (the data constituting the B-picture) of the moving-picture data stored in the file 202 are replaced by predetermined data whose data amount is smaller (dummy data), whereby the data-amount reduced moving-picture data are stored in the file 204.

In the reduction processing 304, only the data constituting the B-picture are replaced by the dummy data because the data of the B-picture are not used for the prediction to encode other pictures and thus the deletion of the data of the B-picture has no effect on the image quality of the other pictures.

As described above, according to this embodiment, MPEG1-format sound-attached moving-picture data of a desired reproduction time, whose data amount is smaller than that of original MPEG1-format sound-attached moving-picture data and which are suitable to output the corresponding moving pictures and sounds at the same time, can be formed from the original MPEG1-format sound-attached moving-picture data.

(Third Embodiment)

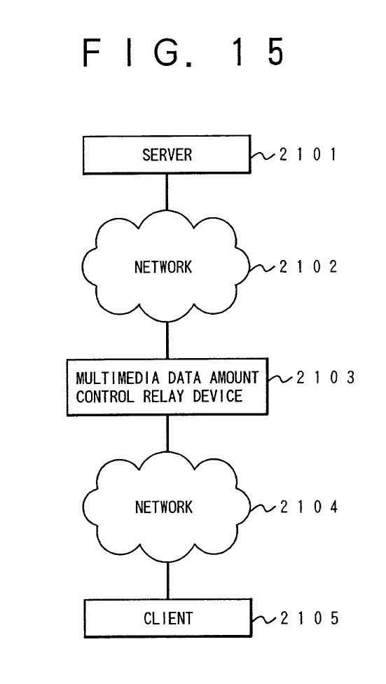

FIG. 15 is a schematic diagram showing the construction of a third embodiment according to the present invention. As shown in FIG. 15, a system of the third embodiment includes a server 2101, networks 2102 and 2104, a multimedia data amount control relay device 2103 and a client 2105. That is, the server 2101 is connected through the network 2102 to the multimedia data amount control relay device 2103, and the client 2105 is connected through the network 2104 to the multimedia data amount control relay device 2103. Multimedia data are communicated between the server 2101 and the client 2105, and at this time the multimedia data amount control relay device 2103 controls the data amount.

The server 2101 may supply services to clients other than the client 2105, however, only the client 2105 is illustrated in FIG. 15 in order to simplify the description of this embodiment. When the system is designed so that the transmission capability is different between the network 2102 and the network 2104, the effect of the multimedia data amount control relay device 2103 of this embodiment is higher.

It is preferable that different networks 2102 and 2104 are connected to each other to construct the multimedia data amount control relay device 2103 as a gateway. Further, each of the networks 2102 and 2104 may be constructed by plural networks.

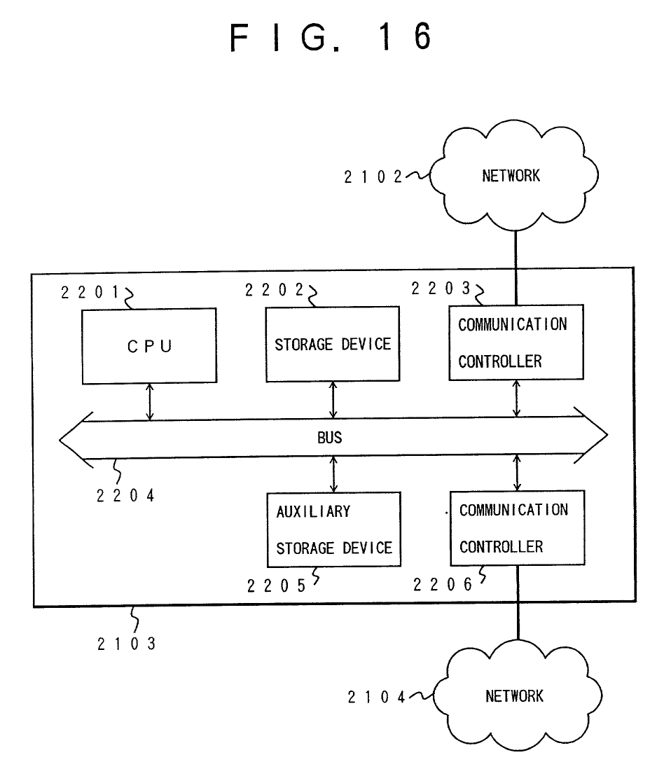

FIG. 16 is a schematic diagram showing the construction of the multimedia data amount control relay device 2103 shown in FIG. 15. The device 2103 shown in FIG. 16 comprises a CPU 2201 for performing prescribed processing, a storage device 2202 which contains a program for operating the CPU 2201, and stores necessary information, communication controllers 2203 and 2206 for controlling data communication between the networks 2102, 2104 and the device, respectively, and an auxiliary storage device 2205. The respective elements are connected to one another through a bus 2204 to communication information therebetween.

An operation of the multimedia data amount control rely device 2103 will be described. The storage device 2202, the communication controller 2203, the auxiliary storage device 2205, the communication controller 2206 and the CPU 2201 are controlled by commands and data which are supplied thereto through the bus 2204. The CPU 2201 is operated according to a preset software to perform the main function of the multimedia data amount control relay device 2103.

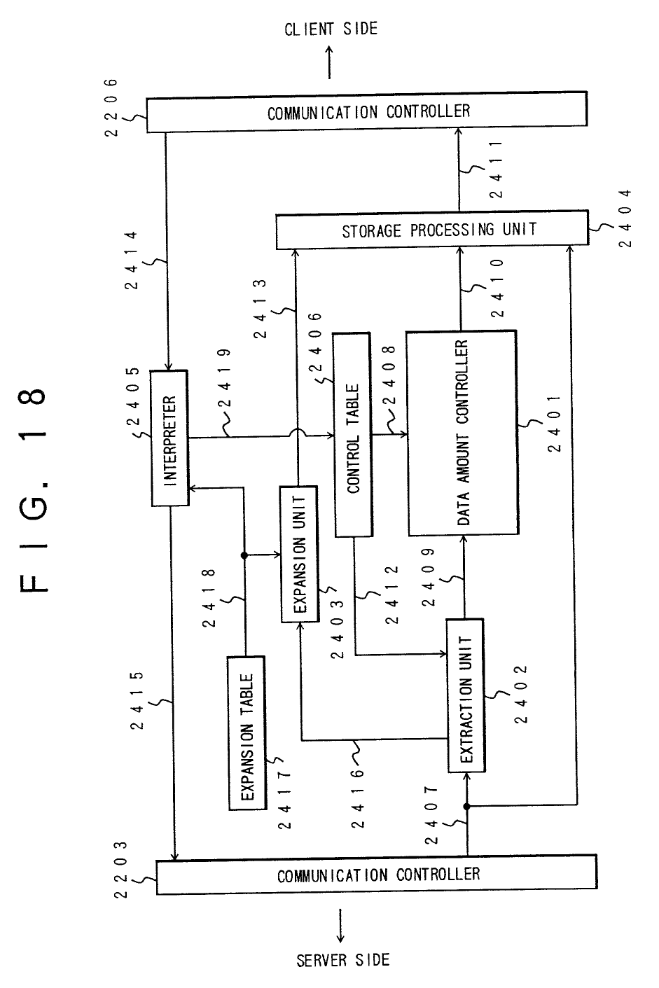

FIG. 19 shows the data structure of multimedia data serving as a control target in this embodiment. In FIG. 19, reference numeral 2501 represents multimedia data having n kinds of data, reference numeral 2502 represents first data, reference numeral 2503 represents second data, . . . , and reference numeral 2504 represents n-th data. Each of the data has a data number, a data type and a data content. Specifically, reference numeral 2505 represents the data number of the data 2502, reference numeral 2506 represents the data type of the data 2502, and reference numeral 2507 represents the data content of the data 2502. Likewise, reference numeral 2508 represents the data number of the data 2503, reference numeral 2509 represents the data type of the data 2503 and the reference numeral 2510 represents the data content of the data 2503. Further, reference numeral 2511 represents the data number of the data 2504, reference numeral 2512 represents the data type of the data 2504, and the reference numeral 2513 represents the data content of the data 2504. The control target of this embodiment are the multimedia data having the data structure as shown in FIG. 19.

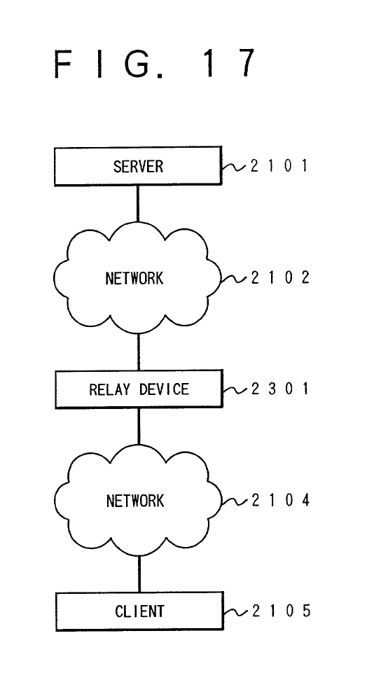

FIG. 18 is a functional block diagram schematically showing the functions which are achieved when the CPU 2201 shown in FIG. 16 operates according to a predetermined software. Elements shown in the functional block diagram and an operation thereof will be described hereunder.

Communication controllers 2203 and 2206 are identical to those shown in FIG. 16, and the communication controllers 2203 and 2206 are connected to the network 2102 at the server side and the network 2104 at the client side, respectively.

A data amount controller 2401 is input with conversion target (control target) multimedia data 2409 and control information 2408, and serves to perform a conversion processing suitable for each data on the conversion target multimedia data 2409 on the basis of the control information 2408 to control the data amount, and then output the converted multimedia data 2410.

An extraction unit 2402 is input with multimedia data 2407 and extraction information 2412, and serves to extract a data group serving as a data amount control target from the multimedia data and output the extracted data group as conversion target multimedia data 2409. Further, it also serves to extract a data group serving as an expansion target from the multimedia data and output the extracted data group as expansion target multimedia data 2416.

An expansion unit 2403 is input with the expansion target multimedia data 2416 and expansion policy information 2418, and it serves to perform an expansion processing on the expansion target multimedia data 2416 on the basis of the expansion policy information 2418 and output the processed data as expanded multimedia data 2413. The concept of “expansion” will be described later.

A storage processing unit 2404 is input with the multimedia data 2407, the converted multimedia data 2410 and the expanded multimedia data 2413, and serves to partially change the multimedia data 2407, replace the converted multimedia data 2410 with the corresponding data before the conversion, newly insert the expanded multimedia data 2413, and then output the final data as converted and expanded multimedia data 2411. When no expansion processing is performed, the expanded multimedia data 2413 are not inserted into the multimedia data 2407.

An interpreter 2405 is input with a command 2414 supplied from the client side and the expansion policy information 2418. When the command 2414 is an expansion command instructing the control processing of the data amount, the interpreter 2405 converts the command to a command before expansion on the basis of the expansion policy information 2418, and output it as an interpreted command 2415. The interpreter 2405 further outputs a control parameter 2419 corresponding to the expansion command. On the other hand, if the command 2414 is not an expansion command, the command 2414 is not subjected to the conversion processing, and it is directly output as an interpreted command 2415. The expansion command as described above will be also described later.

A control table 2406 serves to store at least the types of data which can be converted by the data amount controller 2401, and parameters of the respective data at the conversion time. An expansion table 2417 stores expansion policy information 2418 indicating an expansion method of the expansion processing of the multimedia data which is performed by the expansion unit 2403.

In this invention, the communication controllers 2203 and 2206 may be combined into a single communication controller to achieve the function of the multimedia data amount control relay device 2103.

In this case, the same function of the system shown in FIG. 15 can be achieved by any one of the following constructions.

(1) The server 2101, the multimedia data amount control relay device 2103 and the client 2105 are connected to the network 2102.

(2) The multimedia data amount control relay device 2103 is connected to the network 2102 in the system shown in FIG. 17.

(3) The multimedia data amount control relay device 2103 is connected to the network 2104 in the system shown in FIG. 17.

Next, a specific operation will be described.

First, an operation when the present invention is not applied to the conventional multimedia network system shown in FIG. 17, will be described. The conventional multimedia network system was briefly described above, however, it will be concretely described to clarify the features of the present invention.

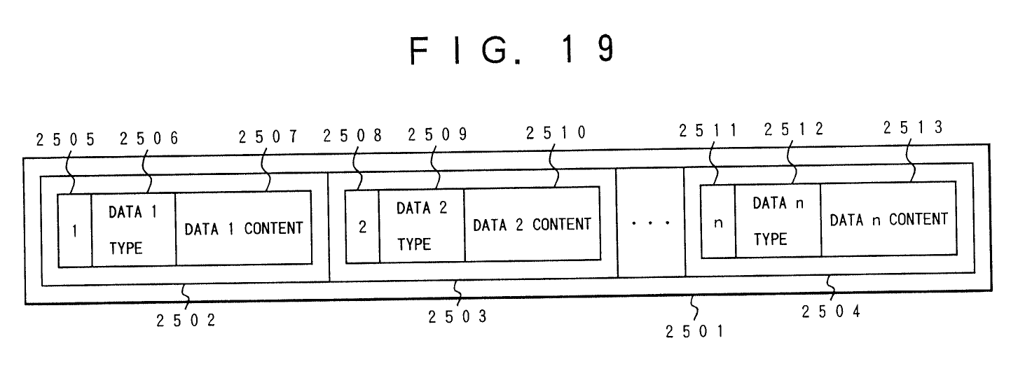

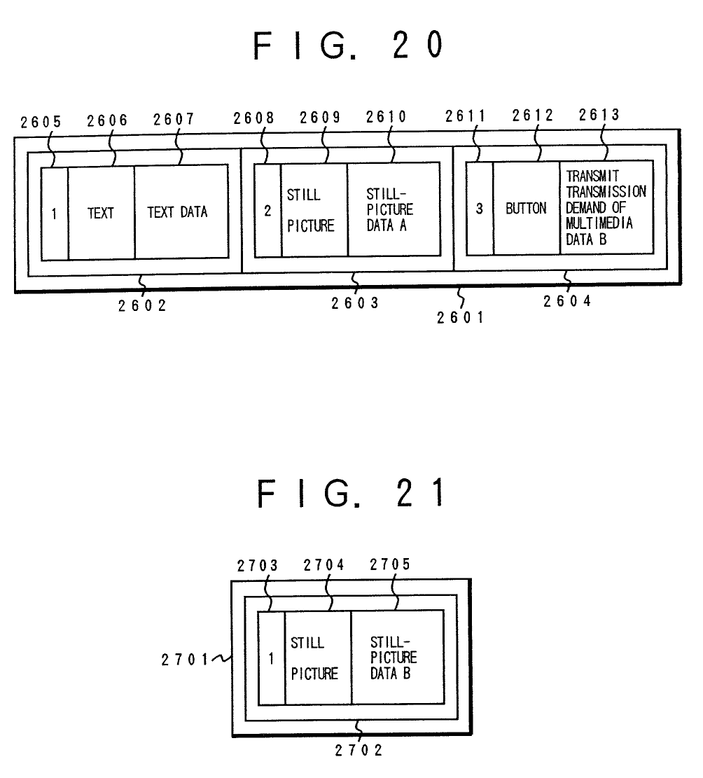

In FIG. 17, reference numeral 2301 represents a relay device for performing data communication (transmission and reception) between the network 2102 and the network 2104. The server 2101 has multimedia data A 2601 shown in FIG. 20 and multimedia data B 2701 shown in FIG. 21. After the system is activated, it receives a transmission demand command of these data supplied from the client, and transmits the data in accordance with the demand.

In FIG. 20, reference numeral 2601 represents multimedia data A which are constructed by three data items, and reference numerals 2602, 2603 and 2604 represent data items constituting the multimedia data A 2601. Reference numeral 2605 represents the data number of the data 2602, reference numeral 2606 represents a data type indicating that the data 2602 are text data, and reference numeral 2607 represents the data content of the data 2602 in which the text data are stored. Likewise, reference numeral 2608 represents the data number of the data 2603, reference numeral 2609 represents a data type indicating that the data 2603 are data for a still picture, and reference numeral 2610 represents the data content of the data 2603 in which the still-picture data A are stored.

Further, reference numeral 2611 represents the data number of the data 2604, reference numeral 2612 represents a data type indicating that the data 2604 are button data, and reference numeral 2613 represents the data content of the data 2604 in which the button data are stored. Here, an user displays selectable buttons on a display unit at a client side, and selects one of the displayed buttons to transmit the command corresponding to the selected button to the server. In this case, “button data” means data to enable such processing of performing the transmission of a command corresponding to the selected button to the server.

The data 2604 contains button data with which a command demanding multimedia data B 2701 to be transmitted to the server can be transmitted. As not shown, the button data contain data of so-called “button name”, and in this case the button name of the button data 2604 is set as “travel scene”.

Next, in FIG. 21, reference numeral 2701 represents the multimedia data B which comprise an item of single data, and reference numeral 2702 represents data constituting the multimedia data B. Reference numeral 2703 represents the data number, reference numeral 2704 represents a data type indicating that the data 2702 are still-picture data, and reference numeral 2704 represents the data content of the data 2702 in which the still-picture data B are stored.

A client 2105 which is connected to the network 2104 comprises at least means for interpreting the multimedia data, a display, a pointing device, and a communication device for transmitting information such as commands, etc. to the network 2104 and receiving information from the network 2104.

It is assumed that the client 2105 is activated to transmit a transmission demand command of the multimedia data A to the server 2101. The relay device 2301 receives the transmission demand command through the network 2104, and transmits it to the server 2101. The server 2101 receives the command through the network 2102, and transmits the multimedia data A 2601 to the client 2105. The relay device 2301 receives the multimedia data A 2601 through the network 2102, and transmits the received multimedia data A 2601 to the client 2105.

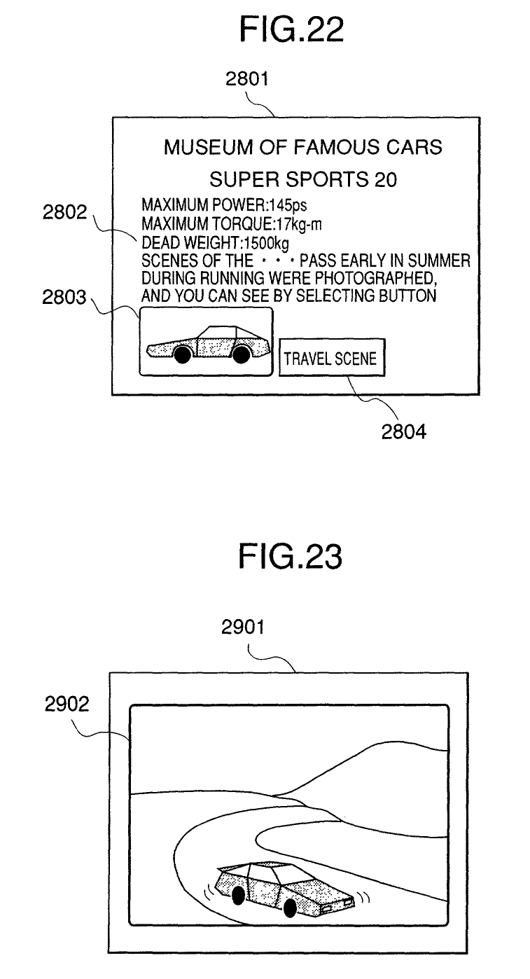

The client 2105 receives the multimedia data A 2601 through the network 2104 to interpret the received content, displays image information shown in FIG. 22 on the display, and then waits for an user's instruction using the pointing device.

In FIG. 22, reference numeral 2801 represents a screen display of the multimedia data A 2601, reference numeral 2802 represents a screen display of the text data 2607, reference numeral 2803 represents a screen display of the still-picture data A 2610, and reference numeral 2804 represents a screen display of the button data 2613. As described above, these data are displayed in a data storing order of the multimedia data (“storing” means “constructing”).

When the user of the client 2105 selects a button 2804 through the pointing device, the client 2105 transmits the transmission demand command of the multimedia data B 2701 to the server 2101. The relay device 2301 receives the transmission demand command through the network 2104, and transmits it to the server 2101. The server 2101 receives the command through the network 2102, and transmits the multimedia data B 2701 to the client 2105.

The relay device 2301 receives the multimedia data B 2701 through the network 2102, and transmits it to the client 2105. The client 2105 receives the multimedia data B 2701 through the network 2104 to interpret the received content, and displays the image data on the display as shown in FIG. 23. In FIG. 23, reference numeral 2901 represents a screen display of the multimedia data B 2701, and reference numeral 2902 represents a screen display of the still-picture data B 2705.

The foregoing is the operation of the conventional device. Next, the operation of the system according to the present invention as shown in FIG. 15 will be described. In this embodiment, the following assumptions are set to simplify the description.

(Assumption 1)

The data which can be converted by the data amount controller 2401 are limited to data of still pictures. The conversion, that is, the reduction of the data amount is performed by reducing the display size of an image to “½” size in both lateral and vertical directions.

(Assumption 2)

The expansion of the multimedia data by the expansion unit 2403 is not carried out.

(Assumption 3)

No expansion command is transmitted from the client 2105 to the server 2101. This assumption is associated with the assumption 2.

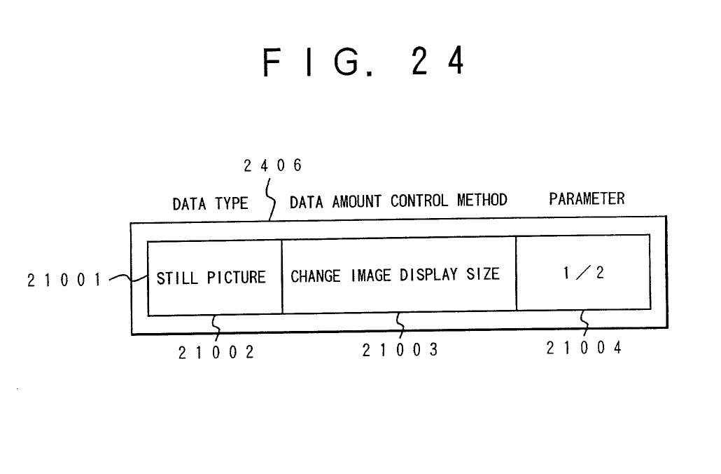

FIG. 24 shows an example of the control table 2406 based on the assumption 1. In FIG. 24, reference numeral 21001 represents a group of items in the control table 2406 (ordinarily, plural items are registered), and reference numeral 21002 represents a data type indicating that the first one of the items 21001 is an item on still-picture data. Reference numeral 21003 represents a data amount control method of the still-picture data, and in this case, change of an image display size is indicated. Reference numeral 21004 represents a parameter used for the data amount control method. In this case, the item 21004 indicates that the change of the image display size is performed on the still-picture data with a parameter of “½” to reduce the display size to “½” size. Further, from the assumptions 2 and 3, no expansion table 2417 is used. The detailed operation of the device according to the present invention will be described on the assumptions as described above.

First, upon activation of the client 2105, it is assumed to transmit the transmission demand command of the multimedia data A 2601 to the server 2101. The communication controller 2206 receives the transmission demand command which is transmitted through the network 2104 to the server 2101, and transmits it as a command 2414 to the interpreter 2405.

The interpreter 2405 checks that the command 2414 is not the expansion command, and transmits it as an interpreted command 2415 to the communication controller 2203. That is, the command from the client 2105 is transmitted to the server 2201 while no change is made on the command.

The server 2101 receives the command through the network 2102, and transmits the multimedia data A 2601 to the client 2105. The communication controller 2203 receives the multimedia data A 2601, and transmits the data as multimedia data 2407 to the extraction unit 2402 and the storage processing unit 2404. When receiving the multimedia data 2407, the extraction unit 2402 performs “conversion target data extracting processing” in which data serving as a conversion target is extracted from the multimedia data, and “expansion target data extraction processing” in which data serving as an expansion target are extracted from the multimedia data.

From the assumption 2, the expansion processing of the multimedia data by the expansion unit 2403 is not performed, and thus the description on the expansion target data extraction processing of the extraction unit 2402 is omitted from the following description.

In the conversion target data extraction processing, the extraction information 2412 is obtained and used for the processing by the control table 2406. The extraction information 2412 comprises a sequence of information comprising only the data types of items in which parameters are set (i.e., the parameters are not “OFF”), out of the items registered in the control table 2406. When there is no extraction information 2412 corresponding to the received multimedia data, the extraction unit 2402 outputs directly the received multimedia data as conversion target data to the data amount controller 2401 without performing the conversion target data extraction processing.

In this embodiment, only the item 21001 on the still picture is registered in the control table 2406 and the parameter of the item 21001 is “½”, the extraction information 2412 is only “still picture”. Therefore, there exists the extraction information 2412 corresponding to the received multimedia data, and thus the extraction unit 2402 executes the conversion target data extraction processing.

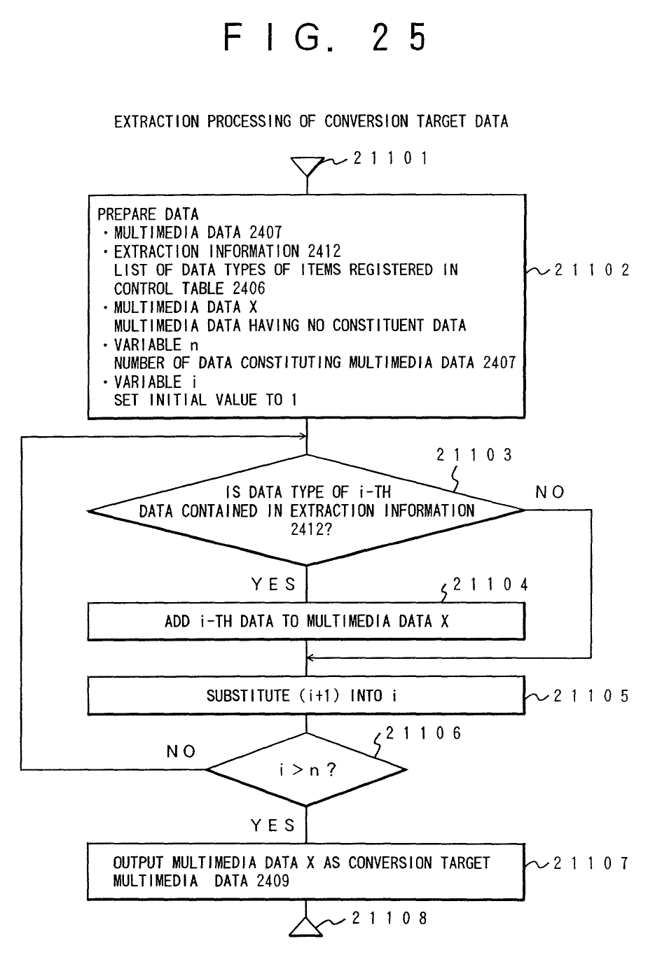

Next, the extraction unit 2402 performs the conversion target data extraction processing according to the process flow shown in FIG. 25. The conversion target data extraction processing will be described hereunder with reference to FIG. 25.

Step 21101 represents the start of the conversion target data extraction processing by the extraction unit 2402. In step 21102, the extraction unit 2402 prepares five kinds of data.

A first kind of data corresponds to received multimedia data 2407, and a second kind of data corresponds to extraction information 2412. A third kind of data corresponds to multimedia data X in which the number of constituent data is “0”, and a fourth kind of data corresponds to a variable n which represents the number of the data constituting the multimedia data 2407 (specifically, n=3 because the multimedia data 2407 are the multimedia data A 2601). A fifth kind of data corresponds to a processing control variable i which is used to repeat the processing, and “1” is substituted into the variable i as an initial value.

In step 21103, the extraction unit 2402 checks whether the data type of i-th data of the multimedia data 2407 is contained in the extraction information 2412. If the data type is contained in the extraction information 2412, “YES” is judged and the process goes to step 21104. On the other hand, if the data type is not contained, “NO” is judged and the process goes to step 21105. At this time, the value of i is equal to “1”, and the data type of the first data of the multimedia data 2407 is “text”. Accordingly, the judgement result is “NO”, and step 21104 is skipped.

Next, in step 21105, the extraction unit 2402 substitutes the result of “i+1” into i, and thus the value of i is equal to “2”.

In step 21106, the extraction unit 2402 compares the value of i with the value of n. If i>n, it judges “YES” and the process goes to step 21107. If not so, it judges “NO” and the process goes to step 21103. At this time, the value of i is equal 2 and the value of n is equal to 3, so that “NO” is judged and the process goes to step 21103.

In step 21103, i is equal to “2”, and the data type of the second data of the multimedia data 2407 is “still picture”, so that the processing result of the extraction unit 2402 is “YES”, and the process goes to step 21104.

In step 21104, the extraction unit 2402 adds the i-th data to the multimedia data X. The data number of the added data is not changed. In this case, the second data are added to the multimedia data X.

In step 21105, the extraction unit 2402 sets the value of i to 3. In step 21106, the processing result of the extraction unit 2402 is “NO”, and the process goes to step 21103. In step 21103, the value of i is equal to 3, and the data type of the third data of the multimedia data 2407 is “button”, so that the processing result of the extraction unit 2402 is “NO”. Therefore, the process goes to step 21105. In step 21105, the extraction unit 2402 sets the value of i to 4. In step 21106, the processing result of the extraction unit 2402 is “YES”, and thus the process goes to step 21107.

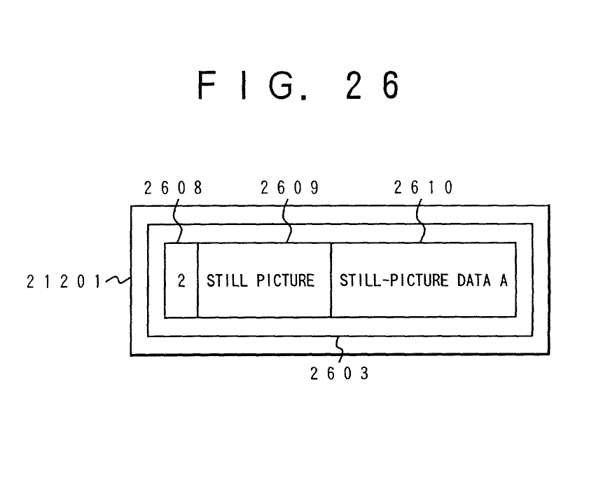

In step 21107, the extraction unit 2402 outputs the multimedia data X as the conversion target multimedia data 2409, and delivers the data to the data amount controller 2401. FIG. 26 shows the conversion target multimedia data 2409 at this time. In FIG. 26, reference numeral 21201 represents conversion target data. In step 21108, the extraction unit 2402 finished the processing.

With the above processing, the extraction unit 2402 obtains the multimedia data 2407, and generates the conversion target multimedia data 2409 on the basis of the multimedia data 2407. The conversion target multimedia data 2409 are transmitted to the data amount controller 2401.

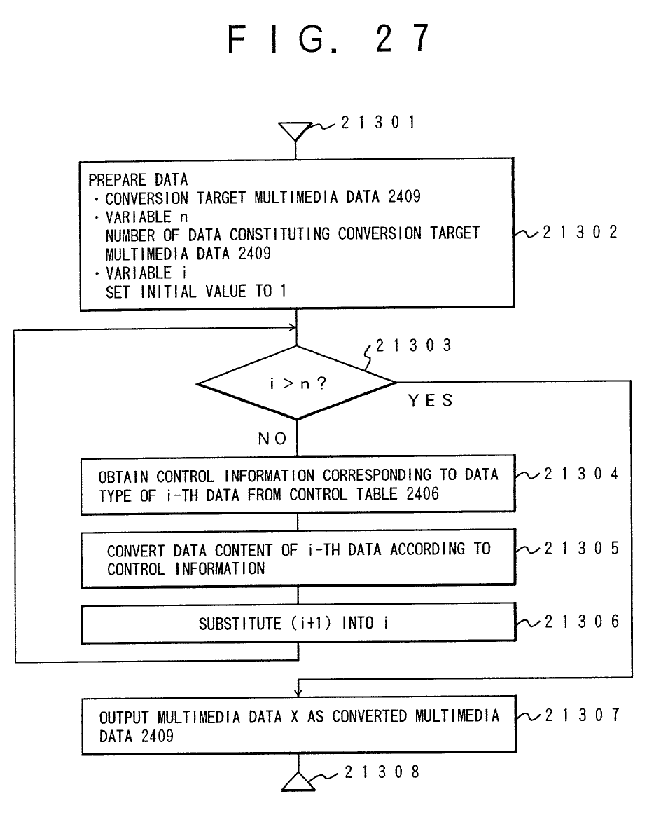

Upon receiving the conversion target multimedia data 2409, the data amount controller 2401 performs the data conversion processing according to the flowchart of FIG. 27. Next, the data conversion processing performed by the data amount controller 2401 will be described with reference to FIG. 27.

First, in step 21301, the data amount controller 2401 starts the data conversion processing. In step 21302, the data amount controller 2401 prepares three kinds of data. A first kind of data corresponds to the conversion target multimedia data 2409 which are received from the extraction unit 2402. A second kind of data corresponds to a variable n representing the number of data constituting the conversion target multimedia data 2409, and in this case, n is equal to 1 because the number of the data constituting the conversion target multimedia data 2409 is equal to 1. A third kind of data corresponds to a processing control variable i which is used to repeat the processing, and “1” is substituted into the variable i as an initial value.

In step 21303, the data amount controller 2401 compares i and n. If i>n, “YES” is judged and the process goes to step 21307. If not so, “NO” is judged and the process goes to step 21304. At this time, the value of i is equal to 1 and the value of n is equal to 1, so that the judgment is “NO” and the process goes to step 21304.

In step 21304, the data amount controller 2401 obtains from the control table 2406 the control information 2408 corresponding to the data type of the i-th data of the conversion target multimedia data 2409. The control information 2408 corresponds to information on a data amount control method and its parameter (see FIG. 24) which are predetermined in accordance with the data type in the control table 2406.

Now, the value of i is equal to 1, and the data type of the first data of the conversion target multimedia data 2409 is “still picture”. Accordingly, the content of the control information 2408 is set as “data amount control method: change of image display size, parameter: ½”.

In step 21305, the data amount controller 2401 reduces the display size of the data content (“still picture data A”) of the i-th data of the conversion target multimedia data 2409 to “½” in vertical and lateral directions, thereby reducing (converting) the data amount in accordance with the control information 2408. Further, the data amount controller 2401 overwrites these data on the data content of the i-th data of the conversion target multimedia data 2409. With this operation, the data content before the overwrite is deleted, and the converted data are stored.

In step 21306, the data amount controller 2401 performs a calculation of “i+1”, and substitutes the calculation result into “i”, so that the value of i is equal to 2. Further, the data amount controller 2401 performs the processing of step 21303. In this case, since the value of i is equal to 2, the judgment of step 21303 of the data amount controller 2401 is “YES”, and thus the process of the data amount controller 2401 goes to step 21307.

In step 21307, the data amount controller 2401 outputs the conversion target multimedia data 2409 having the converted data as the converted multimedia data 2410 to the storage processing unit 2404. FIG. 28 shows the data structure of the converted multimedia data 2410. In FIG. 28, reference numeral 21401 represents the converted multimedia data, reference numeral 21402 represents first data of the converted multimedia data, and reference numeral 21403 represents video data obtained by reducing the display size of the still picture A to “½” size in both the vertical and lateral directions. In step 21308, the data amount controller finishes the processing.

Through the above processing, the data amount controller 2401 obtains the conversion target multimedia data 2409, generates the converted multimedia data 2410 and then transmits the data to the storage processing unit 2404. The description of is the expansion unit 2403 is omitted from the following description because of the assumption 2.

When receiving the multimedia data 2407, the converted multimedia data 2410 and the expanded multimedia data 2413, the storage processing unit 2404 performs “converted data storing processing” and “expanded data storing processing”. Here, the “expanded data storing processing” is such processing as using the expanded multimedia data 2413, however, the description thereof is omitted from the following description because no expanded multimedia data 2413 are generated on the basis of the assumption 2.

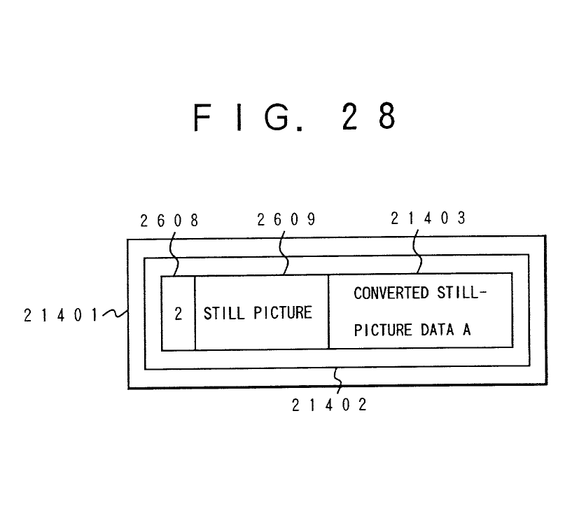

The storing processing unit 2404 performs the converted data storing processing according to the flowchart of FIG. 29. The converted data storing processing will be described with reference to FIG. 29.

First, in step 21501, the storing processing unit 2404 starts the converted data storing processing.

In step 21502, the storing processing unit 2404 prepares five kinds of data. A first kind of data correspond to the multimedia data 2407 which are received from the communication controller 2203, and a second kind of data correspond to the converted multimedia data 2410 which are received from the data amount controller 2401. A third kind of data correspond to a variable n representing the number of data which constitute the converted multimedia data 2410, and in this case, n=1 is satisfied because the number of the data constituting the converted multimedia data 2410 is equal to 1. A fourth kind of data correspond to a processing control variable i to repeat the processing, and 1 is substituted into the variable i as an initial value. A fifth kind of data correspond to a variable k, and no special value is set as an initial value.

In step 21503, the storing processing unit 2404 compares i and n. If i>n, it judges “YES”, and the program goes to step 21507. On the other hand, if not so, the storing processing unit 2404 judges “NO” and the process goes to step 21504. Here, the value of i is equal to 1, and thus the judgment result is “NO”, so that the process goes to step 21504.

In step 21504, the storing processing unit 2404 substitutes into “k” the data number of the i-th data of the converted multimedia data 2407. In this case, the value of i is equal to 1, and the data number of the first data of the converted multimedia data is equal to 2 shown in FIG. 28, so that k=2.

In step 21505, the storing processing unit 2404 overwrites the i-th data of the converted multimedia data 2410 on the k-th data of the multimedia data 2407. In this case, i=1 and k=2, so that the first data of the converted multimedia data 2410 are overwritten on the second data of the multimedia data 2407. With this operation, the data content before the overwriting operation is deleted, and the converted data are stored. In step 21506, the storing processing unit 2404 calculates “i+1”, and substitutes the calculation result into i. In this case, the value of i is equal to 2.

Subsequently, the storing processing unit 2404 advances its process to step 21503. In this case, the value of i is equal to 2, so that the processing result of step 21303 of the storing processing unit 2404 is “YES”, and the storing processing unit 2404 advances its process to step 21507.

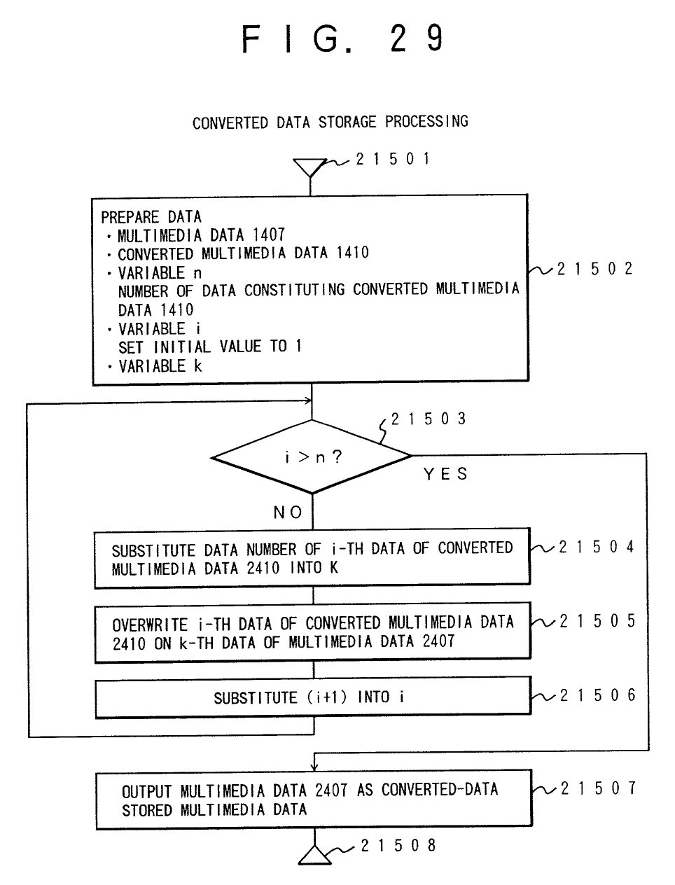

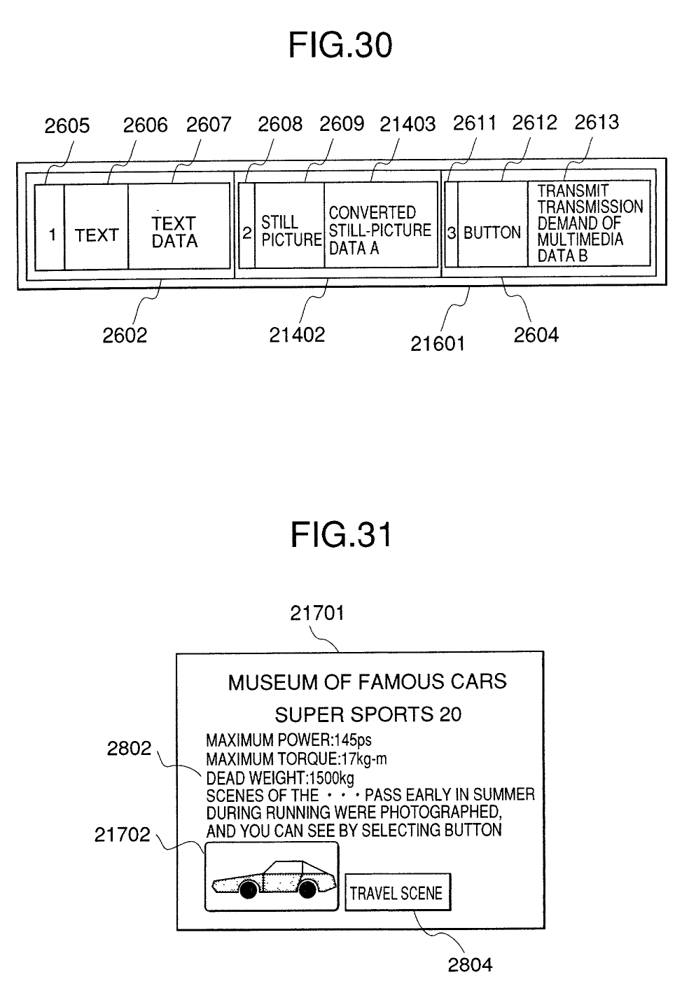

In step 21507, the storing processing unit 2404 temporarily stores the multimedia data 2407 as the conversion-data stored multimedia data. FIG. 30 shows the multimedia data which are stored as the conversion-data stored multimedia data at this time. In FIG. 30, reference numeral 21601 represents the multimedia data which are held in the converted data storing processing of the storing processing unit 2404.

In step 21508, the storing processing unit 2404 finishes the converted data storing processing. In this case, since the description of the expanded data storing processing is omitted, the storing processing unit 2404 outputs the multimedia data 21601 as the control and expanded multimedia data 2411 to the communication controller 2206. The communication controller 2206 transmits the multimedia data 21601 to the client 2105.

The client 2105 receives the multimedia data 21601 through the network 2104 to interpret the received data content and display the multimedia data on the display as shown in FIG. 31, and then waits for an instruction from an user through the pointing device. In FIG. 31, reference numeral 21701 represents a screen display of the client which receives the multimedia data 21601. Reference numeral 21702 represents a screen display of the still-picture data A whose display size is reduced to “½” size in the vertical and lateral directions.

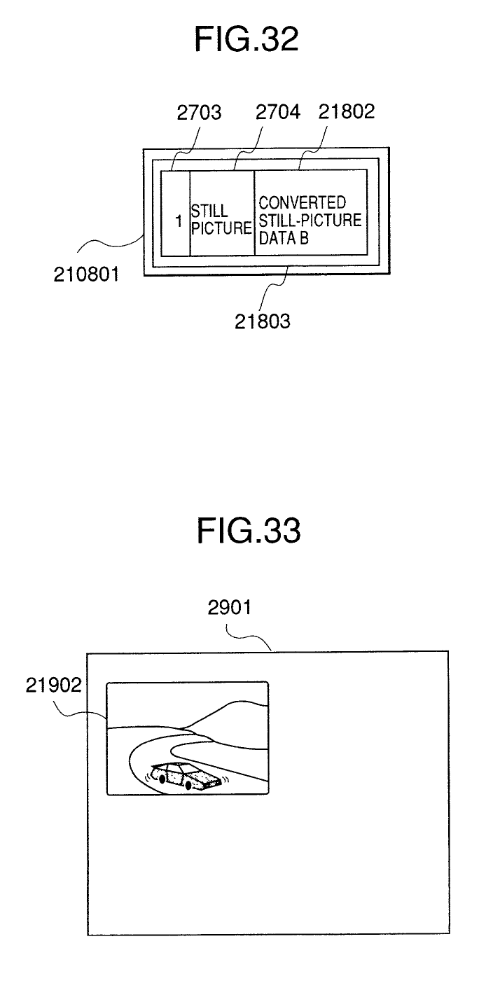

When the user of the client 2105 selects a button 2804 through the pointing device, the client transmits a transmission demand command of the multimedia data B 2701 to the server 2101. The multimedia data amount control relay device 2103 receives the transmission demand command through the network 2104, and transmits it to the server 2101. The server 2101 receives this command through the network 2102, and transmits the multimedia data B 2701 to the client 2105. The multimedia data amount control relay device 2103 receives the multimedia data B 2701 through the network 2102 to perform the same data amount control processing as described above. As a result, the multimedia data B 2701 are converted to multimedia data as shown in FIG. 32.

In FIG. 32, reference numeral 21801 represents the multimedia data B 2701 which are subjected to the conversion processing by the multimedia data amount control relay device 2103, and reference numeral 21803 represents first data of the multimedia data 21801. Reference numeral 21802 represents still-picture data obtained by reducing the display size of the still picture B to “½” size in the vertical and lateral directions.

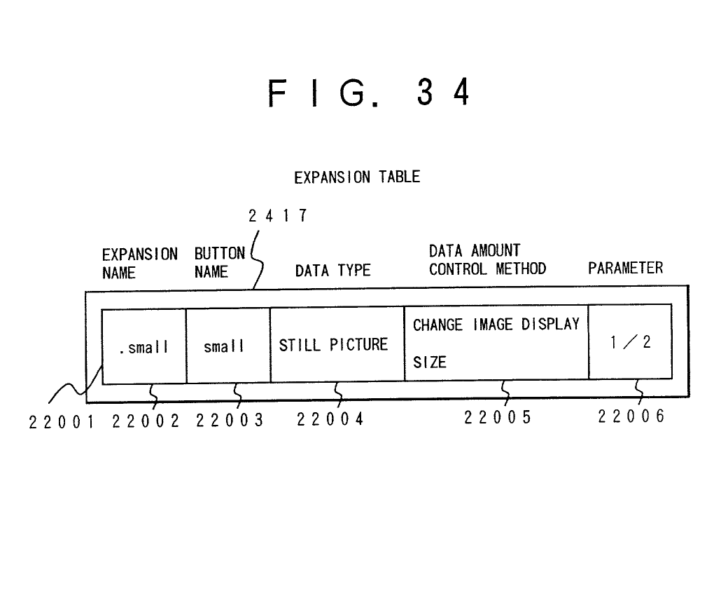

The multimedia data amount control relay device 2103 transmits the multimedia data 21801 to the client 2105. The client 2105 receives the multimedia data 21801 through the network 2104 to interpret the received data content, and displays a frame shown in FIG. 33 on the display. In FIG. 33, reference numeral 21901 represents a screen display of the multimedia data 21801, and reference numeral 21902 represents a screen display of the still-picture data 21802.

Here, the effect of this embodiment will be described hereunder on the assumption that the resolution of the screen display of the display which is equipped to the client is set to “640×480 dots”. The data amount of the multimedia data is assumed as follows. That is, the total data amount of the data number and the data type of each constituent data is assumed to be 4 bytes. For text data, 2 bytes are allocated to one character, and for a still picture, 256 colors are allocated to one dot, that is, one dot can be represented by data of one byte. Two hundred bytes are allocated to the button data.

The data amount of the multimedia data 2601 is calculated on the assumption as described above. Assuming the number of characters of the text data 2607 to be 100 characters, the data amount of the characters is equal to 200 (100×2) bytes. The text data 2607 contain 100-byte information on the size, arrangement, etc. of the characters, and thus the data amount of the text data 2607 comprise 300 bytes. Further, assuming the display size of the data of the still-picture data A 2610 to be “200×150 dots”, the data amount is equal to “1×200×150”=30000 bytes.

From the above assumption, the data amount of the multimedia data 2601 is equal to “(4+300)+(4+30000)+(4+200)=30512 bytes”.

Further, the display size of the still-picture data 21403 is reduced to ”½” size in the vertical and lateral directions, and the data comprise 100×75 dots. Accordingly, the data amount of the still-picture data 21403 is equal to “1×100×75”=7500 bytes. Therefore, the data amount of the multimedia data 21601 after the conversion processing is equal to “(4+300)+(4+7500)+(4+200)=8012 bytes”.

From the above calculation, the data amount of the multimedia data 2601 is reduced from 30512 bytes to 8012 bytes.

In terms of percentage, it means that the data amount is reduced by (8012/30512)×100≈26.3 (%), and the data transmission rate is increased about 3.8 times.

Here, the transmission rate of the network 2102 is set to 1500000 (bits/second), and the transmission rate of the network 2104 is set to 14400 (bits/second).

In the prior art, that is, in the system shown in FIG. 17, a time required for the transmission of the multimedia data 2601 from the server 2101 to the client 2105 is obtained from the following calculation.

In the following description, t1 represents a transmission time from the server 2101 to the relay device 2301, t2 represents a transmission time from the relay device 2301 to the client 2105, and T represents a transmission time form the server 2101 to the client 2105. An overhead due to the processing of the relay device 2301 is assumed to be sufficiently small and thus negligible.

t1=(30512×8)/1500000≈0.163 (second)

t2=(30512×8)/14400≈17.0 (seconds)

T+t1+t2≈17.163 seconds

Likewise, in this embodiment, that is, in the system shown in FIG. 15, a time required for the transmission of the multimedia data 2601 from the server 2101 to the client 2105 is obtained from the following calculation.

In the following description, tc represents a processing time of the multimedia data amount control relay device 2103, t1′ represents a transmission time from the server 2101 to the multimedia data amount control relay device 2103, t2′ represents a transmission time from the multimedia data amount control relay device 2103 to the client 2105, and T′ represents a transmission time of the multimedia data 2601 from the server 2101 to the client 2105.

t1′=t1≈0.163 second

t2′=(8012×8)/14400≈4.45 seconds

T′=t1′+t2′+tc≈(4.613+tc) (second)

Here, assuming that tc=1 second, T′≈5.613 (second), and thus the transmission time is shortened at about (17.163/5.613 ≈) 3.06 times. Even assuming that tc=4 seconds, T′≈8.613 (second). The transmission time is shortened at about (17.163/8.613 ≈) 2.0 times.

That is, when two networks having different transmission capabilities are connected to the server 2101 and the client 2105, the transmission time of the multimedia data can be more greatly shortened in this invention than in the prior art if the transmission capability of the network at the client side is relatively low.

Even when the multimedia data amount control relay device 2103 has one communication controller, the same effect could be obtained if the multimedia data amount control relay device 2103 is connected to the network 2102 in the system shown in FIG. 17.

In this embodiment, the image quality of the still-picture data is sacrificed in order to shorten the transmission time of the multimedia data from the server 2101 to the client 2105, however, this embodiment is very effective for such a browsing case where the picture content may be roughly grasped.

According to this embodiment, the user of the client 2105 can access a larger amount of still-picture data in a shorter time as compared with the conventional system. This provides effects of enabling reduction in a data searching time, etc., but also an effect of enabling reduction in a response time which is an important factor to determine “easy to use” in an interactive system and also an effect of achieving an interactive system which is excellent in operation performance. The response time is defined as a time from the time when an user transmits his demand until the time when a response to the demand is given to the user.

Furthermore, according to this embodiment, even when the transmission capability of each of the networks 2102 and 2104 is high and there is no large difference between the respective transmission capabilities, that is, there is little effect in reduction of the transmission time, the amount of the data which are received by the client 2105 can be controlled. Therefore, the user can determine a communication arrangement in consideration of supplied information quality and required time in accordance with a given purpose, and in this point an interactive system which is excellent in operation performance can be achieved.

The display size conversion processing of the still-picture data can be performed on a part of the still-picture data. When the processing of reducing the data amount can be performed on a part of the data as described above, the same function can be achieved by carrying out the same processing as this embodiment on a part of the multimedia data relayed from the server 2101 to the client 2105 in the multimedia data amount control relay processing device 2103, and repeating this operation.

Likewise, the same function as this embodiment can be achieved by dividing the multimedia data relayed from the server 2101 to the client 2105 on a constituent data basis, performing the same processing as this embodiment for every divided data, and repeating this operation.

In the above two cases, the processing of the data amount controller 2401 can be performed during a time when the communication controller 2203 waits for data from the server 2101, and the processing efficiency of the whole system can be improved.

(Fourth Embodiment)

A fourth embodiment according to the present invention will be described with reference to the accompanying drawings. First, the concept of the expansion (processing) of the multimedia data will be described prior to the detailed description of this embodiment.

In the third embodiment of the present invention, the multimedia data amount control relay device 2103 reduces the display size for all the still-picture data which are relayed from the server 2101 to the client 2105. However, there is a case where the reduction of the display size is not needed by the user at the side of the client 2105. Accordingly, the system is required to be designed so that it can be selected (determined) by some user whether the multimedia data amount control relay device 2103 performs the reduction of the display size of the still pictures, that is, whether the data amount is controlled. The user's selection as described above can be allowed by using a suitable registering manner of control information to be registered in the control table, however, it is preferably performed by a simple operation of a device at the client side.

Therefore, in order to satisfy the above requirement, it is considered to perform the expansion processing on the multimedia data. Here, the term “expansion” would be more clearly understandable if it is considered as being such a concept that existing data are replaced by remade data or commands.

Next, the expansion of the multimedia data will be described in detail.

The data type of the data 2604 constituting the multimedia data 2601 corresponds to button data, and its content 2613 is “transmission of a transmission demand of multimedia data B”. It is displayed as “button” on the display frame of the display of the client 2105, and the user selects a button through the pointing device to transmit “the transmission demand command of the multimedia data B” from the client 2105 to the server 2101.

In addition to the above button, a button for transmitting “a transmission demand command of the multimedia data B whose data amount is controlled” may be newly added so that the multimedia data amount control relay device 2103 controls the data amount only when the button is selected. In this case, by selecting one of the two buttons, the user can determine whether the data amount control operation of the multimedia data amount control relay device 2103 is performed.

The “expansion of multimedia data” corresponds to the addition of the button for demanding the transmission of the data whose data amount is controlled by the multimedia data amount control relay device 2103 as described above. Further, “expansion command” is a command which is transmitted from a client when the user at the client side selects the button added to expand the multimedia data.

The multimedia data amount control relay device 2103 of the fourth embodiment when only the assumption 1 of the three assumptions which are set in the third embodiment is set and thus the assumptions 2 and 3 are not set, will be described.

The processing when the expansion of the multimedia data is performed will be described in detail like the third embodiment.

FIG. 34 shows an example of the expansion table 2417 in this embodiment. In FIG. 34, reference numeral 22001 represents one of the items of the expansion table (plural items may exist), and reference numeral 22002 represents the expansion name of an item 22001 (in this case, it is represented as “.small”. Reference numeral 22003 represents the button name of the item 22001, and in this case it is represented as “small”. Reference numeral 22004 represents the data type of the item 22001, and it indicates that the item 22001 is an item on a still picture. Reference numeral 22005 represents a data amount control method of the item 22001, and in this case it indicates “change of image display size”. Reference numeral 22006 represents a parameter of the item 22001, and it indicates a parameter for the data amount control method. In this case, the parameter indicates “½”. As is apparent from comparison with the control table shown in FIG. 24, this embodiment is characterized in that “expansion name” and “button name” are provided.

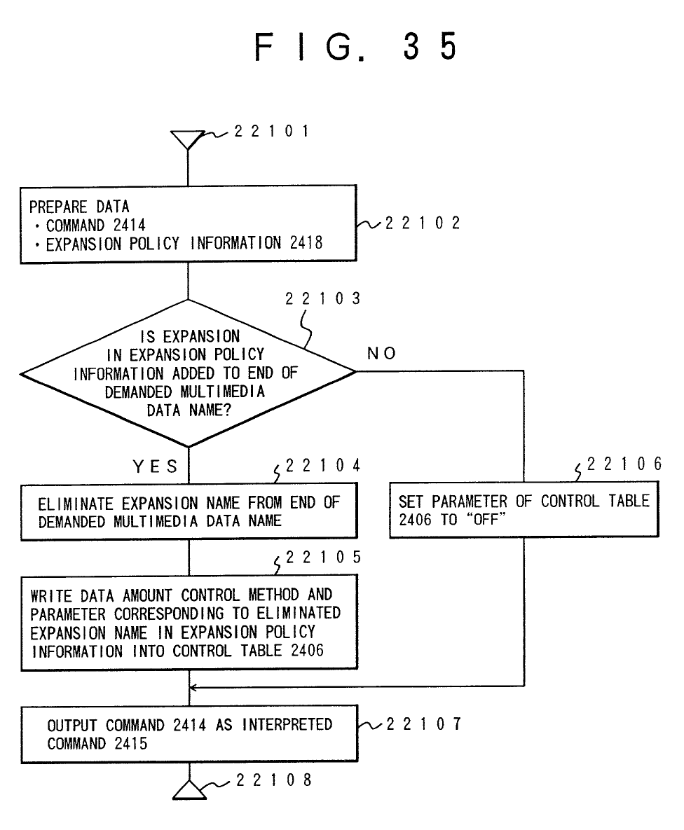

Upon activation of the client 2105, it transmits the transmission demand command of the multimedia data A 2601 to the server 2101. The transmission demand command is assumed to be represented as “REQUEST: multimedia data A” in a text format. The communication controller 2206 receives the transmission demand command which is transmitted through the network 2104 to the server 2101, and transmits the received command 2414 to the interpreter 2405. When receiving the command 2414, the interpreter 2405 performs a command interpretation processing. The command interpretation processing is performed according to a flowchart of FIG. 35.

Next, the command interpretation processing will be described with reference to FIG. 35.

First, in step 22101, the interpreter 2405 starts the command interpretation processing. In step 22102, the interpreter 2405 prepares two kinds of data. A first kind of data are data which are the command 2414 received from the communication controller 2206. A second kind of data are expansion policy information 2418. The expansion policy information 2418 is information obtained by collecting all items stored in the expansion table, and in this case it corresponds to the item 22001.

In step 22103, the interpreter 2405 compares the end of the name of the multimedia data which are demanded to be transmitted by the command 2414, with the expansion names of all the items of the expansion policy information 2418, and judges whether they are coincident with each other. If they are coincident with each other, the interpreter 2405 judges “YES”, and it advances the process to step 22104. If they are not coincident with each other, the interpreter 2405 judges “NO”, and it advances the process to step 22106. Here, the item of the expansion policy information 2418 is only the item 22001, and the expansion name of the item 22001 is “.small”. Further, the name of the multimedia data for which transmission is demanded by the command 2414 is “multimedia data A”, and the expansion names of the end of this name and the expansion name of the item 22001 are not coincident with each other. Therefore, the judgment result is “NO”, and the process goes to step 22106.

When the process goes to step 22104, the expansion name is eliminated from the end of the transmission-demanded multimedia data name, and the data amount control method and the parameter which correspond to the eliminated expansion name in the expansion policy information are written in the control table 2406 in step 22105.

In step 22106, the interpreter 2405 outputs “OFF” as a control parameter to change the parameters of all the items of the control table 2406 to “OFF”. “OFF” means that no conversion processing is performed.

In step 22107, the interpreter 2405 outputs the command 2414 as an interpreted command 2415 to the communication controller 2203. The interpreted command 2415 at this time is “REQUEST: multimedia data A” as described above.

In step 22108, the interpreter 2405 finishes the command interpretation processing.

As described above, the interpreter 2405 interprets the command 2414 to change the control parameter 2419, thereby changing the content of the control table 2416, and then outputs the interpreted command 2415. In this case, the command 2414 and the interpreted command 2415 are identical to each other, and the interpreter 2405 changes the parameters of all the items of the control table 2406 to “OFF”.

Subsequently, the communication controller 2203 transmits the interpreted command 2415 to the server 2101. The server 2101 receives this command through the network 2102, and transmits the multimedia data A 2601 to the client 2105.

The communication controller 2203 receives the multimedia data A 2601, and transmits the received data as multimedia data 2407 to the extraction unit 2402 and the storage processing unit 2404.

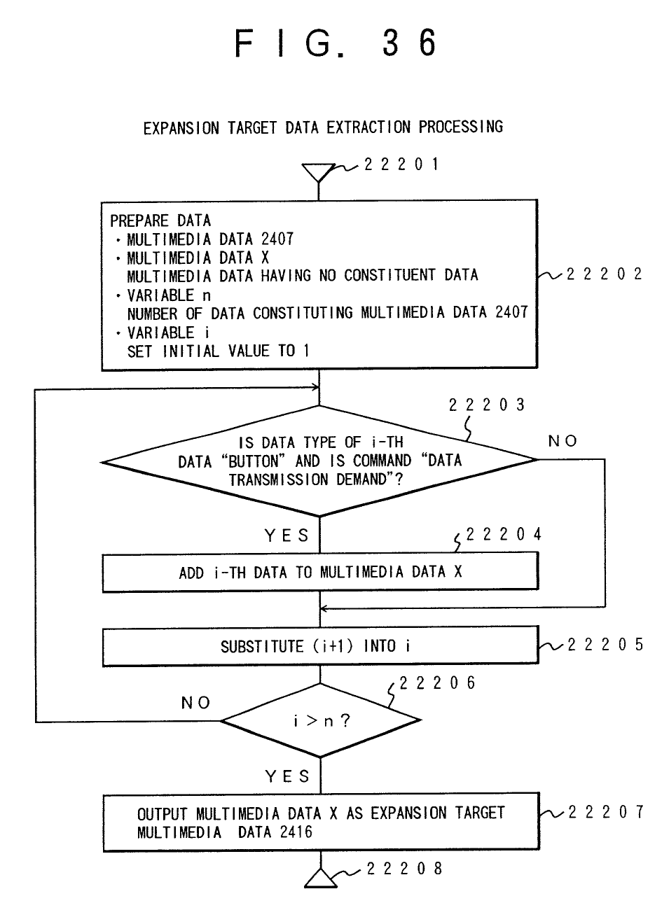

When receiving the multimedia data 2407, the extraction unit 2402 performs the conversion target data extraction processing and the expansion target data extraction processing. In this case, since the parameters of all the items of the control table 2406 are changed to “OFF” by the interpreter 2405, there exists no extraction information 2412 of data to be converted. Accordingly, the extraction unit 2402 performs no conversion target data extraction processing, and outputs empty multimedia data having no data (i.e., the number of data constituting the multimedia data is equal to zero) as the conversion target multimedia data 2409 to deliver the data to the data amount controller 2401. The extraction unit 2402 performs the expansion target data extraction processing according to the flowchart of FIG. 36. Next, the expansion target data extraction processing which is performed by the extraction unit 2402 will be described with reference to FIG. 36.

First, in step 22201, the expansion target data extraction processing is started. Instep 22202, the extraction unit 2402 prepares four kinds of data. A first kind of data are the multimedia data 2407 which are received from the communication controller 2203. A second kind of data are multimedia data X having data whose number is equal to zero. A third kind of data correspond to a variable n representing the number of data which constitute the multimedia data 2407. Specifically, the multimedia data 2407 are the multimedia data A 2601, and thus n=3. A fourth kind of data correspond to a processing control variable i which is used to repeat the processing, and 1 is substituted into the variable i as an initial value.

In step 22203, the extraction unit 2402 judges whether the data type of i-th data of the multimedia data 2407 represents “button” and a command which is transmitted when the user of the client selects the “button” is a data transmission demand command. If the extraction unit 2402 judges that the above condition is satisfied, the process goes to step 22204. If not so, the process goes to step 22205. In this case, the value of i is equal to 1, and the data type of the first data of the multimedia data 2407 represents “text”. Accordingly, the judgment is “NO”, and the extraction unit 2402 advances it process to step 22205.

In step 22205, the extraction unit 2402 substitutes the result of “i+1” into the variable i, so that the value of the variable i is equal to 2. In step 22206, the extraction unit 2402 compares the variables i and n. If i>n, the judgment is “YES”, and the process goes to step 22207. If not so, the judgment is “NO”, and the process goes to step 22203. At this time, the value of i is equal to 2 and the value of n is equal to 3, so that the judgment is “NO”, and the process goes to step 22203.

In step 22203, the value of i is equal to 2, and the data type of the second data of the multimedia data 2407 represents “still picture”, so that the judgment of the extraction unit 2402 is “NO”, and the process goes to step 22205. In step 22205, the extraction unit 2402 sets the value of i to 3.

In step 22206, the judgment of the extraction unit 2402 is “NO”, and the process goes to step 22203. In step 22203, the value of i is equal to 3, and the data type of the third data of the multimedia data 2407 represents “button”, so that the judgment of the extraction unit 2402 is “YES”, and the process goes to step 22204.

In step 22204, the extraction unit 2402 adds the i-th data of the multimedia data 2407 to the multimedia data X. In this case, the extraction unit 2402 adds the data 2604 to the multimedia data X. In step 22205, the extraction unit 2402 sets the value of i to 4.

In step 22206, the judgment of the extraction unit 2402 is “YES”, and the process goes to step 22207.

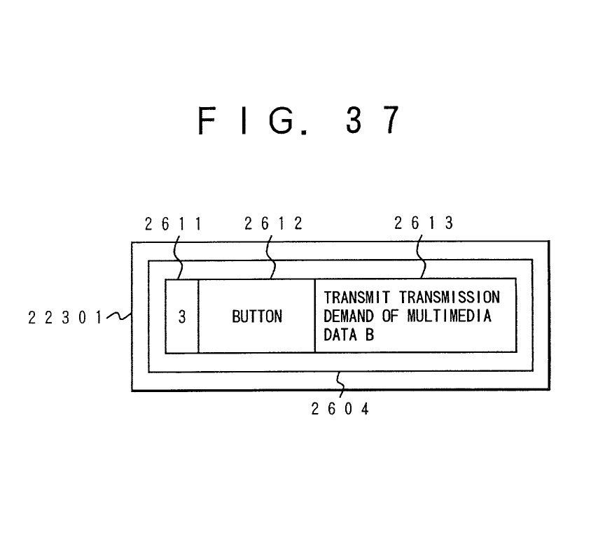

In step 22207, the extraction unit 2402 outputs the multimedia data X as the expansion target multimedia data 2416 to the expansion unit 2403. FIG. 37 shows the expansion target multimedia data at this time. In FIG. 37, reference numeral 22301 represents the multimedia data which are output as the expansion target multimedia data 2416 by the extraction unit 2402. Subsequently, in step 22208, the extraction unit 2402 finishes the expansion target data extraction processing.

Next, the operation of the expansion unit 2403 will be described.

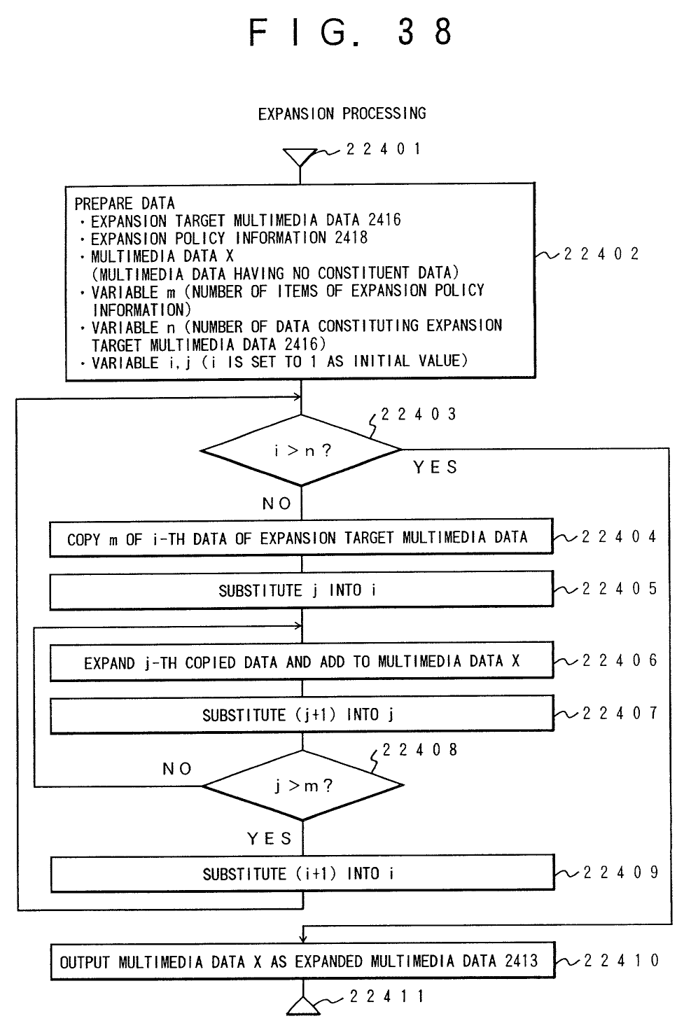

When receiving the expansion target multimedia data 2416 transmitted from the extraction unit 2402, the expansion unit 2403 performs the expansion processing according to a flowchart of FIG. 38.

Next, the expansion processing of the expansion unit 2403 will be described in detail with reference to FIG. 38.

First, in step 22401, the expansion unit 2403 starts the expansion processing.

In step 22402, the expansion unit 2403 prepares seven kinds of data. A first kind of data are the expansion target multimedia data 2416 which are received from the extraction unit 2402. A second kind of data corresponds to expansion policy information 2418. The expansion unit 2403 obtains this information from the expansion table 2417. A third kind of data are the multimedia data X in which the number of the constituent data thereof is equal to zero. A fourth kind of data correspond to a variable m indicating the number of items of the expansion policy information 2418. At this time, the item of the expansion policy information 2418 is limited to the item 22001, and thus m=1. A fifth kind of data correspond to a variable n representing the number of data of the expansion target multimedia data 2416. At this time, the expansion target multimedia data 2416 are the multimedia data 22301, and thus n=1. Sixth and seventh kinds of data correspond to variables i and j which are used to repeat the processing, respectively, and “1” is substituted into the variable i as an initial value.

In step 22403, the expansion unit 2403 compares the values of i and n. If i>n, it judges “YES” and advances the process to step 22410. If not so, it judges “NO” and advances the process to step 22404. In this case, since i=1 and n=1, the expansion unit 2403 judges “NO” and advances the process to step 22404.

In step 22404, the expansion unit 2403 makes m copies of the i-th data of the expansion target multimedia data. The copied information may be temporarily stored in an auxiliary storage device or the like. In this case, since i=1 and m=1, one copy of the data 2604 is made.

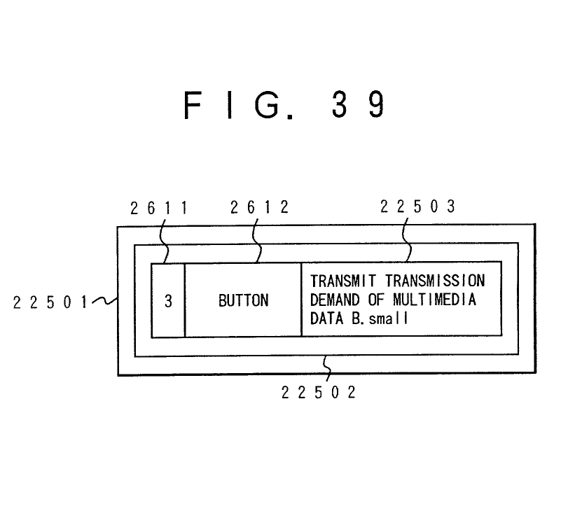

In step 22405, the expansion unit substitutes “1” into the variable j. In step 22406, the expansion unit 2403 expands j-th copy data. First, the expansion unit 2403 adds the expansion name of the j-th item of the expansion policy information 2418 to the end of the data name which is demanded by the button data of the j-th copy data. Further, the expansion unit 2403 overwrites the button name of the j-th item of the expansion policy information 2418 on the button name of the button data of the j-th copy data. In this case, j=1, and the first copy data are the data 2604. The name of the data which are demanded by the button data 2613 is “multimedia data B”. The expansion unit 2403 adds the end of the name with the first item of the expansion policy information, that is, the expansion name of the item 22001 to rewrite the button name of the button data 2613 “travel scene” to the button name “small” of the item 22001. Further, the expansion unit 2403 adds the data to the multimedia data X. FIG. 39 shows the data structure of the multimedia data X at this time. In FIG. 39, reference numeral 22501 represents multimedia data, reference numeral 22502 represents expanded data, and reference numeral 22503 are button data which can transmit a transmission demand command of data of “multimedia data B. small” and are named as “small”.

In step 22407, the expansion unit 2403 calculates “j+1”, and substitutes the calculation result into the variable j, so that the value of j is equal to 2.

In step 22408, the expansion unit 2403 compares the values of j and m. If j>m, it judges “YES” and the process goes to step 22409. If not so, it judges “NO” and the process goes to step 22406. In this case, j=2 and m=1, so that the expansion unit 2403 advances the process to step 22409.

In step 22409, the expansion unit 2403 calculates “i+1”, and substitutes the calculation result into the variable i. As a result, the value of i is equal to 2. Further, the expansion unit 2403 advances the process to step 22403.

In step 22403, i=2 and n=1, so that the judgment of the expansion unit 2403 is “YES”, and the expansion unit 2403 advances the process to step 22410.

In step 22410, the expansion unit 2403 outputs the multimedia data X as the expanded multimedia data 2413 to the storage processing unit 2404. At this time, the multimedia data 2413 are the multimedia data 22501.

In step 22411, the expansion unit 2403 finishes the expansion processing.

Next, the operation of the data amount controller 2401 will be described.

The data amount controller 2401 performs the processing according to the flowchart of FIG. 27 like the third embodiment. The summary of the processing will be described hereunder.

Since the conversion target multimedia data 2409 which are received from the extraction unit 2402 are empty multimedia data, the data amount controller unit 2401 sets the value of n to zero in step 21302.

In step 21303, the judgment of the data amount controller 2401 is “YES”, and the data amount controller 2401 advances its process to step 21307. In step 21307, the data amount controller 2401 outputs the multimedia data X, that is, the empty multimedia data as the converted multimedia data 2410 to the storage processing unit 2404.

Next, the operation of the storage processing unit 2404 will be described.

When receiving the multimedia data 2407, the converted multimedia data 2410 and the expanded multimedia data 2413, the storage processing unit 2404 performs the converted data storing processing and the expanded data storing processing.

The storage processing unit 2404 performs the converted data storage processing according to the flowchart of FIG. 29 like the third embodiment. In this case, the converted multimedia data 2413 are empty multimedia data, so that the storage processing unit 2404 sets the value of n to zero in step 21502.

In step 21503, the judgment of the storage processing unit 2404 is “YES”, and the storage processing unit 2404 advances its process to step 21507.

In step 21507, the storage processing unit 2404 outputs the multimedia data 2407 as converted-data stored multimedia data. At this time, no change is made to the multimedia data 2407, so that the converted-data stored multimedia data correspond to the multimedia data A 2601.

Subsequently, the storage processing unit 2404 performs the expanded data storing processing according to a flowchart of FIG. 40, and the expanded data storing processing will be next described with reference to FIG. 40.

First, in step 22601, the storage processing unit 2404 starts the expanded data storing processing.

In step 22602, the storage processing unit 2404 prepares four kinds of data. A first kind of data are the converted-data stored multimedia data which are obtained in the converted data storing processing of the storage processing unit 2404. In this case, the first kind of data correspond to the multimedia data A 2601. A second kind of data are the expanded multimedia data 2413 which are received from the expansion unit 2403. A third kind of data correspond to a variable n which represents the number of data constituting the converted-data stored multimedia data. Since the number of the data constituting the multimedia data A 2601 is equal to 3, n=3. A fourth kind of data correspond to a processing control variable i, and the storage processing unit 2404 substitutes “1” into the variable i as an initial value.

In step 22603, the storage processing unit 2404 compares the values of i and n. If i>n, it judges “YES”, and advances its process to step 22607. If not so, it judges “NO” and advances its process to step 22604. In this case, since i=1 and n=1, the judgement is “NO” and thus the storage processing unit 2404 advances its process to step 22604.

In step 22604, the storage processing unit 2404 searches data having the data number of i from the data constituting the expanded multimedia data. If there exists at least one item of data having the data number i, the judgment is “YES”, and the storage processing unit 2404 advances its process to step 22605. If no data having the data number of i exists, the judgment is “NO” and the storage processing unit 2404 advances its process to step 22606. At this time, i=1. Specifically, the expanded multimedia data are the multimedia data 22501. The number of the data constituting the multimedia data 22501 is equal to 1 and the data number thereof is equal to 3. Accordingly, the judgment is “NO” and the storage processing unit 2404 advances its process to step 22606.

In step 22606, the storage processing unit 2404 substitutes the calculation result of “i+1” into the variable i. As a result the value of i is equal to 2. Thereafter, the storage processing unit 2404 advances its process to step 22603.

In step 22603, the judgment of the storage processing unit 2404 is “NO” like the previous judgment result as described above, and the storage processing unit 2404 advances its process to step 22604.

In step 22604, the judgement of the storage processing unit 2404 is “NO” like the previous judgement as described above, and the storage processing unit 2404 advances its process to step 22606.

In step 22606, the storage processing unit 2404 substitutes the calculation result of “i+1” into the variable i, so that the value of i is equal to 3. Subsequently, the storage processing unit 2404 advances its process to step 22603.

In step 22603, the judgment of the storage processing unit 2404 is “NO” like the previous judgment as described above, and the storage processing unit 2404 advances its process to step 22604.

In step 22604, the value of i is equal to 3, and the data number of the data constituting the multimedia data 22501 is equal to 3, so that the judgment at this time is “YES”, and thus the storage processing unit 2404 advances its process to step 22605.

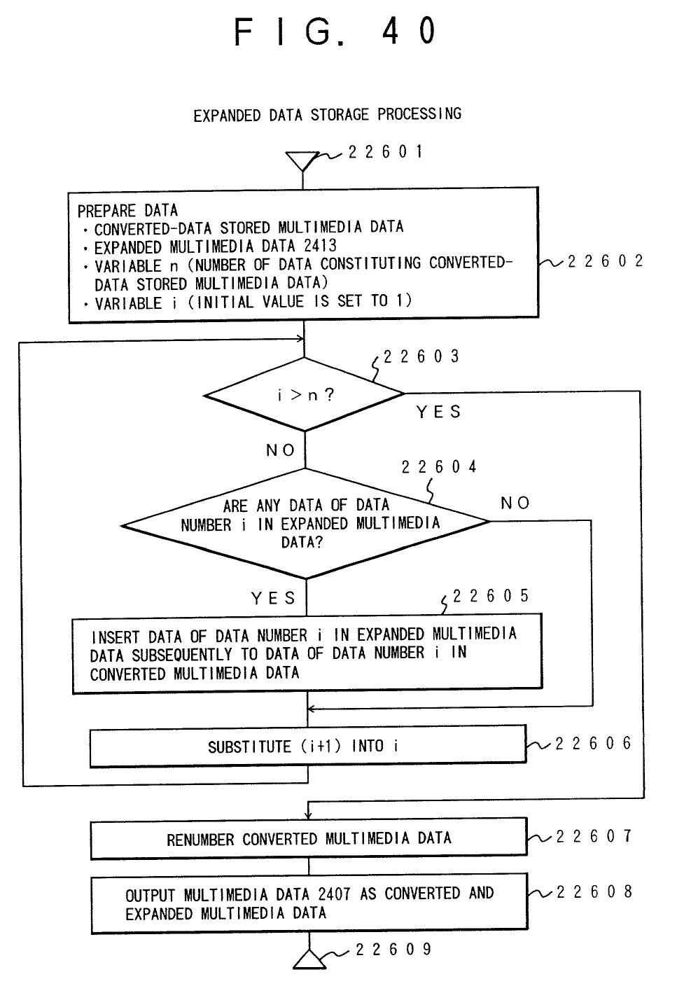

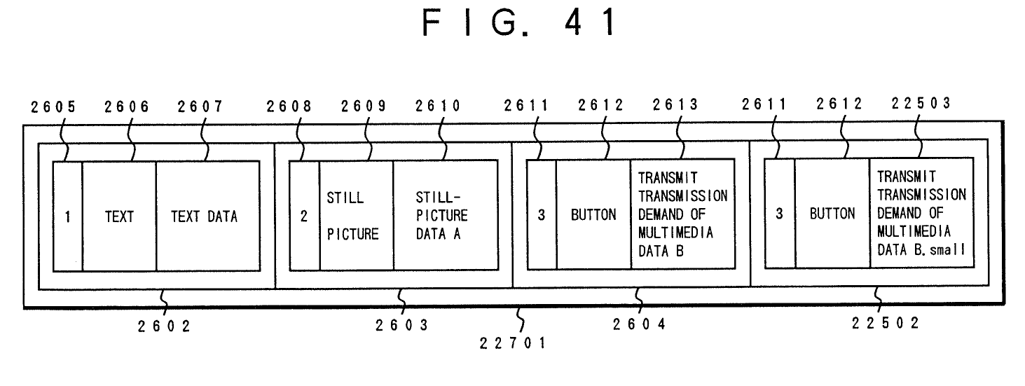

In step 22605, the storage processing unit 2404 inserts all data having the data number “i” of the expanded multimedia data subsequently to the data having the data number “i” of the converted multimedia data. Here, the expanded multimedia data are the multimedia data 22501, that is, i=3. Therefore, the data 22502 is inserted subsequently to the converted-data stored multimedia data, that is, the third data of the multimedia data A 2601. As a result, the converted-data stored multimedia data are constructed as shown in FIG. 41. In FIG. 41, reference numeral 22701 represents the multimedia data in which the data 22502 are inserted subsequently to the third data 2604 of the multimedia data A 2601.

Subsequently, in step 22606, the storage processing unit 2404 substitutes the calculation result of “i+1” into the variable i, so that the value of i is equal to 4. Thereafter, the storage processing unit 2404 advances its process to step 22603.

In step 22603, i=4 and n=3, so that the judgement of the storage processing unit 2404 is “YES” and thus the storage processing unit 2404 advances its process to step 22607.

In step 22607, the storage processing unit 2404 renumbers the data constituting the converted multimedia data from the first data. In this case, the storage processing unit 2404 renumbers the data constituting the multimedia data 22701 to change the data numbers of the data as shown in FIG. 42. In FIG. 42, reference numeral 22801 represents the multimedia data in which the data numbers of the data constituting the multimedia data 22701 are rearranged (renumbered) by the storage processing unit 2404, and reference numeral 22802 represents the data number which is renumbered by the storage processing unit 2404.

In step 22608, the multimedia data 2407 whose data number is renumbered by the storage processing unit 2404 in step 22607 are output as the converted and expanded multimedia data 2411 to the communication controller 2206. At this time, specifically the converted and expanded multimedia data 2411 are multimedia data 22801.

In step 22609, the storage processing unit 2404 finishes the expanded data storing processing.

Thereafter, the communication controller 2206 receives the converted and expanded multimedia data 2411, that is, the multimedia data 22801 from the storage processing unit 2404, and delivers the data to the client 2105.

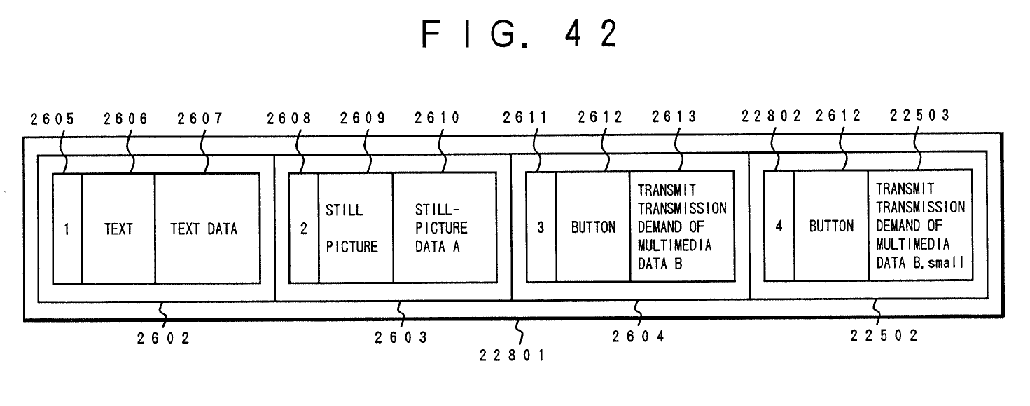

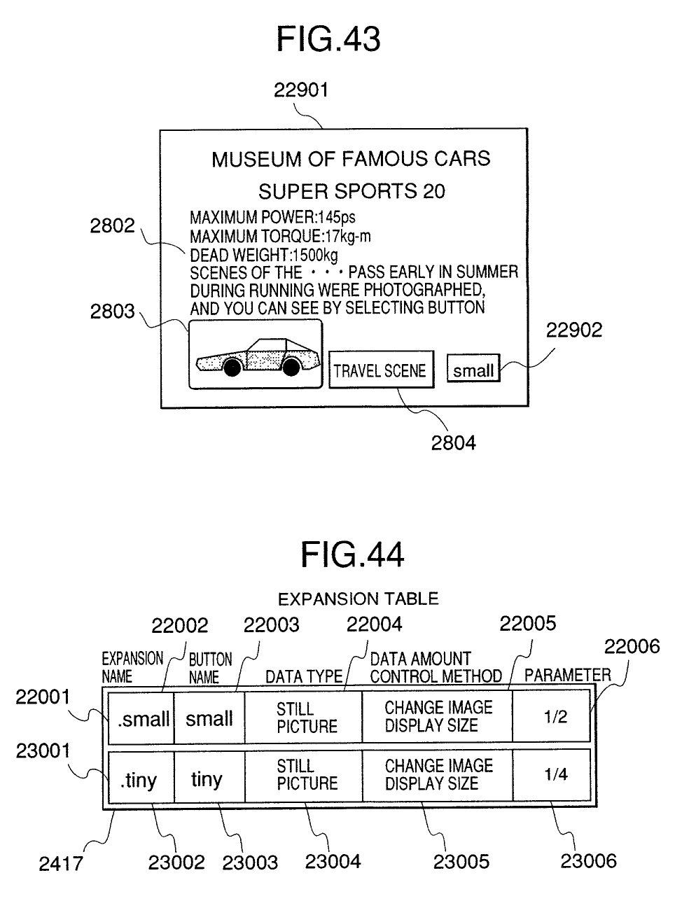

The client 2105 receives the multimedia data 22801 through the network 2104 to interpret the data content, and displays on the data on the display frame of the display as shown in FIG. 43, thereafter waiting for an user's instruction through the pointing device. In FIG. 43, reference numeral 22901 represents a display frame of the multimedia data 22801, and reference numeral 22902 represents a display frame of the button data 22503.

Here, when the user of the client 2105 selects the button 2804 through the pointing device, the client 2105 transmits a command “REQUEST: multimedia data B” to the server 2101. This command is interpreted by the interpreter 2405 when the command is relayed by the multimedia data amount control relay device 2103. However, since this command is not the expansion command, the interpreter 2405 sets all the parameters of the control table 2406 to “OFF”, and transmits the command to the server 2101 directly.

The server which receives the command “REQUEST: multimedia data B” transmits the multimedia data B 2701 to the client 2105.

When the multimedia data B 2701 are relayed by the multimedia data amount control relay device 2103, no data amount control is performed on these data because all the parameters of the control table 2406 are set to “OFF”. Further, since the button data are not contained in the multimedia data B 2701, the data expansion is not performed.

Accordingly, the multimedia data amount control relay device 2103 directly transmits the multimedia data B 2701 to the client 2105, so that the display frame of the display of the client 2105 becomes a display frame 2901 shown in FIG. 23.

On the other hand, when the user of the client 2105 selects the button 22902 through the pointing device, the client 2105 transmits a command “REQUEST: multimedia data B. small” to the server 2101.

The operation of the multimedia data amount control relay device 2103 in the above case will be described.

The communication controller 2206 receives the command “REQUEST: multimedia data B. small” through the network 2104, and transmits it as the command 2414 to the interpreter 2405. When receiving the command 2414, the interpreter 2405 performs the command interpretation processing according to the flowchart of FIG. 35.

In step 22103, the item of the expansion policy information 2418 is only the item 22001, and the expansion name of the item 22001 is “.small”. On the other hand, the name of the multimedia data for which transmission is demanded by the command 2414 is “multimedia data B. small”. Therefore, the end of the above name and the expansion name of the item 22001 are coincident with each other, so that the judgment result is “YES” and thus the interpreter 2405 advances its process to step 22104.

In step 22104, the interpreter 2405 eliminates the expansion name from the end of the name of the multimedia data which are demanded by the command 2414. In this case, the command “REQUEST: multimedia data B.small” is changed to “REQUEST: multimedia data B”.

In step 22105, the interpreter 2405 outputs as a conversion parameter 2419 the data type, data amount control method and the parameter which correspond to the eliminated expansion name, and writes the conversion parameter 2419 into the control table 2406. In this case, the item corresponding to the expansion “.small” in the item of the expansion policy information 2418 is the item 22001, and at this time the conversion parameter 2419 is “still picture, change of image display size, ½”. The interpreter 2405 outputs the conversion parameter 2419 to change the item on “still picture” of the control table 2406. The result of this change is the same as shown in FIG. 24.

In step 22107, the interpreter 2405 outputs the command 2414, that is, “REQUEST: multimedia data B” as the interpreted command 2415 to the communication controller 2203.

The communication controller 2203 transmits the interpreted command 2415 to the server 2101.

The server 2101 receives the command through the network 2102, and transmits the multimedia data B 2701 to the client 2105. Here, in the multimedia data amount control relay device 2103, the control table 2406 is similar to that of the third embodiment, and the multimedia data B 2701 do not contain the button data, so that the operation of the multimedia data amount control relay device 2103 is perfectly identical to that of the third embodiment. Therefore, the multimedia data amount control relay device 2103 controls the data amount of the multimedia data B 2701 to transmit the multimedia data 21601 to the client 2105.

The client receives the multimedia data 21601 through the network 2104 to interpret the received data content, and displays a display frame on the display of the client 2105.

As described above, according to the fourth embodiment, the number of buttons to be displayed on the display of the client 2105 is increased, and it can be determined by selecting a button whether the data conversion is performed in the multimedia data amount control relay device 2103.

The server 2101 is designed to hold a lot of still-picture data, and thus when data to be supplied to the client 2105 is required to be searched from the still-picture data, in some cases a transmission amount of the still-picture data to check the data content is extremely large, so that this searching operation needs a remarkably long time. According to this embodiment, when a searching operation is performed, the user of the client 2105 can perform the searching operation rapidly if he searches images whose display size is reduced to “½” (half) size in the vertical and lateral directions by selecting the added “small”. That is, the above operation is sufficient to check the content for the search although the image quality is somewhat degraded, and the searching operation can be performed at high speed by reducing the data amount. By selecting an original button at the time when a search target still picture is found out, the user of the client 2105 can see the still picture which the user wishes to grasp finally. As described above, this embodiment is particularly effective to the case where the user searches the multimedia data at high speed and he wishes to obtain data without reducing the data amount for those data which are finally needed.

In the third and fourth embodiments, no change is made to the data format of the multimedia data, the communication protocol (regulation), etc. Therefore, the conventional system can be directly used for the client 2105 and the server 2101. That is, the device of this embodiment can be disposed at any position, and the change of the system architecture and the number of processes which are needed due to the provision of the system of this embodiment are extremely small.

Further, the above embodiment has been described on the assumption that the number of the button data contained in the multimedia data is equal to 1 to simplify the description. However, even when plural button data are contained in the multimedia data, the multimedia data amount control relay device 2103 may add all the buttons with a button for transmitting an expansion command and transmit suitable data to the client 2105 when the client 2105 selects the button.

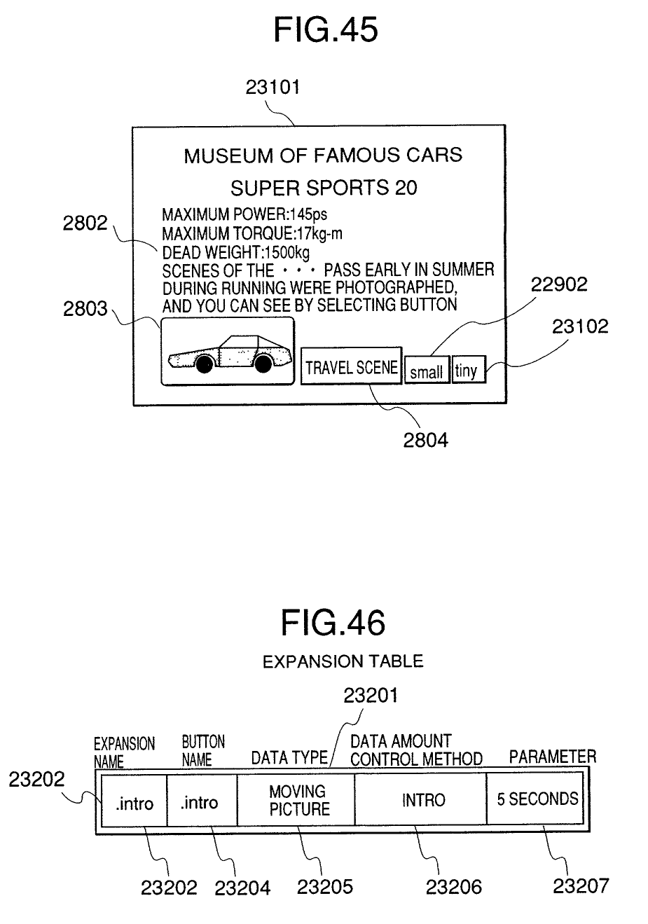

Still further, in this embodiment, the number of buttons which are added on the display frame of the client by the command expansion is equal to 1. However, the item of the expansion table 2417 may be added to add plural buttons on the display frame of the client 2105. For example, when the expansion table has two items as shown in FIG. 44, the client 2105 displays a frame shown in FIG. 45 when the client 2105 receives the multimedia data A 2601 which is expanded by the multimedia data amount control relay device.

In FIG. 44, reference numeral 23001 represents a second item of the expansion table 2417, reference numeral 23002 represents the expansion name of the item 23001, reference numeral 23003 represents the button name of the item 23001, reference numeral 23004 represents the data type of the item 23001, reference numeral 23005 represents a data amount control method of the item 23001, and reference numeral 23006 represents a parameter of the item 23001.

In FIG. 45, reference numeral 23101 represents a display frame on which a transmission demand result of the multimedia data A 2601 when the expansion table 2417 is constructed as shown in FIG. 44 is displayed at the client 2105 side, and reference numeral 23102 represents a button which is added on the basis of the item 23001.

When the user selects the button 23102, the still-picture data B whose display size is finally reduced to “¼” in the vertical and lateral directions are finally transmitted to the client 2105.

Further, in this embodiment, the type of the data to be expanded by the expansion unit 2403 is limited to the button data. However, the same purpose as this embodiment can be also achieved by expanding any other data type insofar as the user of the client 2105 can transmit the data as a command like the button data.

The following is common to the third and fourth embodiments.

One item of data is used as a data amount control target in the multimedia data transmitted from the server 2101 to the client 2105, however, the data amount of plural items of data in one multimedia data may be controlled.

In the third and fourth embodiments, the multimedia data amount control relay device 2103 limits to still pictures the data type for which the data amount is controlled. However, the data mount controller 2401 may be designed to perform the data amount control processing on plural types of data. In this case, if an item is registered in the control table for every data type, the multimedia data amount control relay device 2103 can perform the data amount control on plural types of data. At the same time, it can perform the data amount control on plural types of data contained in one multimedia data.

The following processing modes other than the display size conversion processing of still pictures may be used to reduce the data amount: frame thinning-out processing of moving-picture data, sampling rate conversion of sound data, conversion from sound data to text data, conversion from color moving pictures to monochromatic moving pictures, conversion from Kanji-character mixed sentences to Katakana-character sentences, extraction of a part of sound data and moving-picture data, etc.

Likewise, in the foregoing description, the number of severs is set to one. However, even when plural servers exist on the network 2102 and the user of the client 2105 selectively connects these servers if occasion demands, this invention is applicable to the transmission of the multimedia data from all the servers to the client 2105.

Further, in the foregoing description, there exist two networks between the server 2101 and the client 2105. However, this invention is applicable if at least one network exists between the server 2101 and the client 2105.

(Fifth Embodiment)

Next, a fifth embodiment according to the present invention will be described.

In a fifth embodiment, there is considered a case where a specific classification is made to the multimedia data which are processed in the fourth embodiment, for example, such a case where multimedia data containing only still-picture data or multimedia data containing only moving-picture data are transmitted from a server to a client.

In this case, by providing the expansion table 2417 every classification of the multimedia data, the expansion policy of the multimedia data can be changed. For example, the following case is considered: the end of the name of multimedia data containing only text data is set to “.text” at all times, the end of the name of multimedia data containing only still-picture data is set to “.picture” at all times and the end of the name of multimedia data containing only moving-picture data is set to “.video” at all times. In this case, two expansion tables are prepared. The expansion table corresponding to the end of the data name “.picture” is the same as shown in FIG. 34, and the expansion table corresponding to “.video” is constructed as shown in FIG. 46.

In FIG. 46, reference numeral 23201 represents the expansion table corresponding to “.video”, reference numeral 23202 represents items of the expansion table 23201, reference numeral 23203 represents an item of the expansion name, and reference numeral represents an item of the button name. Reference numeral 23205 represents an item of the data type, reference numeral 23206 represents an item of a data amount control method, and reference numeral 23207 represents an item of a parameter. The expansion table corresponding to “.text” is not specially prepared.

In this embodiment, the data amount controller 2401 is characterized by having a function of cutting the head of moving-picture data for arbitrary time. When “intro” is indicated in the data amount control method of an item on the moving picture in the content of the control table 2406, only “time” which is a “parameter” for the moving-picture data to be transmitted to the client 2105 is extracted.

When the expansion of the multimedia data is performed, the expansion unit 2403 analyzes the end of the transmission demand data name in the button data and selects on the basis of the analysis result an expansion table to be used by the expansion unit 2403 to perform the expansion processing so that no expansion is performed on the button data to transmit the text data (the expansion table corresponding to text data is not prepared), and the same expansion as the fourth embodiment is performed on the button to transmit still-picture data, and the button data to transmit moving-picture data is added with a name of “intro”. As a result, the transmission demand button of the text data is added with no button data, the transmission demand button of the still-picture data is added with a button of “small”, and the transmission demand button of the moving-picture data is added with a button of “intro” on the screen display of the display of the client 2105.

When the user of the client 2105 selects the button of “intro” which is added to the transmission demand button of the moving-picture data, the moving-picture data which are transmitted from the server 2101 to the client 2105 are controlled in data amount by the multimedia data amount control relay device 2103, and moving-picture data of five seconds at the head of the moving-picture data are transmitted to the client 2105. That is, the user of the client 2105 can see the head moving-picture data of five seconds without receiving all the moving-picture data.

As described above, according to the fifth embodiment, the operation performance can be improved by adding the buttons which meet the features of the multimedia data.

(Sixth Embodiment)

Next, a sixth embodiment according to the present invention will be described. In this embodiment, the expansion method of the multimedia data of the fourth embodiment is changed.

When the expansion processing is performed on the multimedia data, the expansion of the multimedia data is performed so that the buttons are added. In this embodiment, the “button data” are changed to “pull-down menu data”. The pull-down menu data are defined as data for such a menu as described below. That is, when an user makes choice, new choices are displayed on the screen of the client 2105 to enable the user to make further choice. This “pull-down menu mode” is applied to the display described in the fourth embodiment.

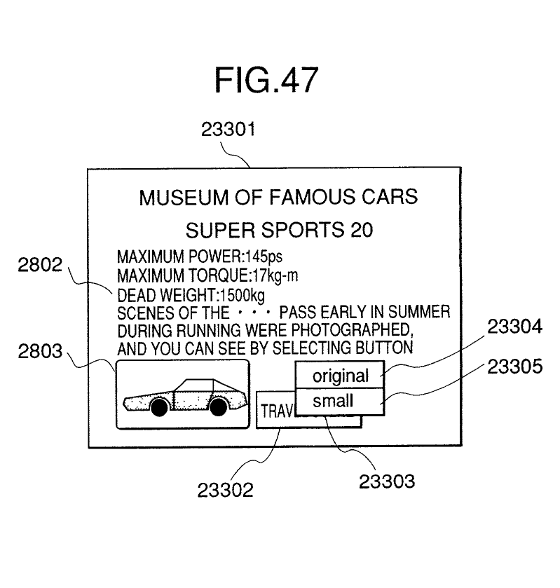

The client which transmits the transmission demand of the multimedia data A to the server 2101 finally displays the apparently same display content as the frame 2801 of FIG. 22. At this time, when the user selects the button 2804, the display frame is changed as shown in FIG. 47.

In FIG. 47, reference numeral 23301 represents a screen display of the client 2105 in this embodiment, reference numeral 23302 represents a pull-down menu display button, reference numeral 23303 represents a pull-down menu, reference numeral 23304 represents a transmission demand choice of still-picture data B, and reference numeral 23305 represents a transmission demand choice of still-picture data B whose display size is reduced to “½” size.

When the user of the client 2105 selects the choice 23304, the client 2105 receives the still-picture data B. When the user selects the choice 23305, the client 2105 can receive the still-picture data B whose display size is reduced to “½” in the vertical and lateral directions.

In order to realize the above operation, such pull-down menu data as described above may be generated in the expansion unit 2403 in place of the button data to be added, and overwritten on the original button data in the storage processing unit 2404.

As described above, this embodiment can achieve such a screen display that the expansion of the multimedia data can be performed without changing the layout of the screen display of the client 2105. Therefore, the operation performance of the user side can be further improved.

(Seventh Embodiment)

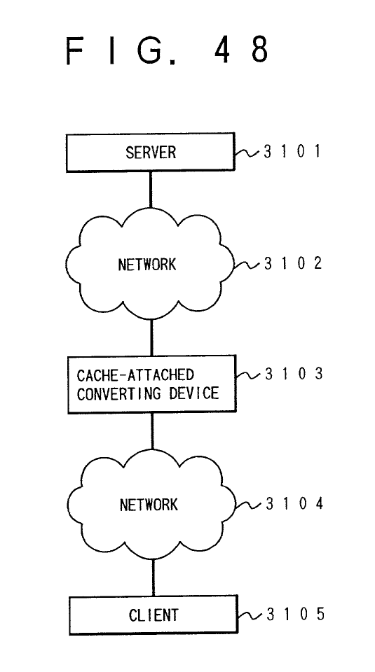

A seventh embodiment will be next described with reference to FIGS. 48 to 62.

FIG. 48 is a diagram showing the construction of the seventh embodiment according to the seventh embodiment. As shown in FIG. 48, the system of the seventh embodiment includes a server 3101, networks 3102 and 3104, a data converting device with a cache (hereinafter referred to as “cache-attached data converting device”) 3103, and a client 3105. That is, the server 3101 is connected to the cache-attached data converting device 3103 through the network 3102, and the client 3105 is connected to the cache-attached data converting device 3103 through the network 3104. Multimedia data are communicated between the server 3101 and the client 3105, and at this time the cache-attached data converting device 3103 controls the data amount. The server 3101 may supply services to clients other than the client 3105, however, only one client 3105 is illustrated in FIG. 48 in order to simplify the description.

When the system is designed so that the networks 3102 and 3104 have different transmission capabilities, the cache-attached data converting device 3103 shows larger effects. It is preferable that the cache-attached data converting device 3103 is connected to the different networks 3102 and 3104 to enable the cache-attached data converting device 3103 to operate as a gateway. Further, each of the networks 3102 and 3104 may comprise plural networks.

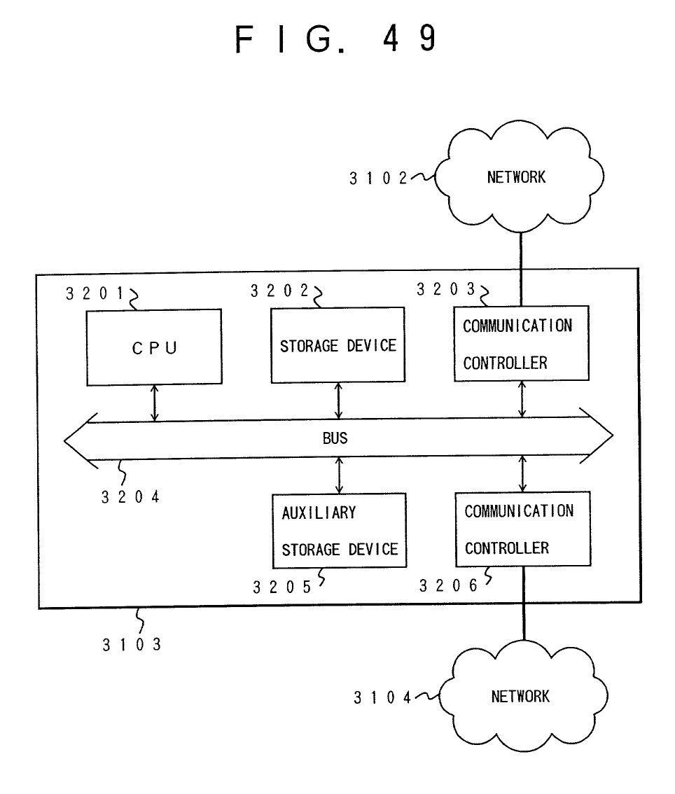

FIG. 49 is a diagram showing the construction of the cache-attached data converting device 3103 shown in FIG. 48. The data converting device 3103 shown in FIG. 49 includes a CPU 3201 which performs prescribed processing, a storage device 3202 for storing necessary information containing a program which is used to operate the CPU 3201, communication controllers 3203 and 3206 for performing data communication between the network 3102 and the cache-attached data converting device 3103 and between the network 3104 and the data converting device 3103 respectively, and an auxiliary storage device 3205. These elements are connected to one another through a bus 3204 to communicate information thereamong. The storage device 3202, the communication controller 3203, the auxiliary storage device 3205 and the communication controller 3206 are controlled on the basis of commands and data which are transmitted from the CPU 3201 through the bus 3204 thereto. The main function of the cache-attached data converting device 3103 is realized by operating the CPU 3201 according to a predetermined software.

Next, the operation of the cache-attached data converting device 3103 will be described.

FIG. 51 is a functional block diagram showing the functions which the CPU 3201 shown in FIG. 49 achieves according to the predetermined software between the communication controllers 3203 and 3206.

The constituent elements of the functional block diagram and the operation thereof will be described.

The communication controllers 3203 and 3206 are identical to those of FIG. 49, and are connected to the network 3102 at the server side and the network 3104 at the client side, respectively.

The controller 3401 receives the multimedia data 3407 from the communication controller 3203 connected to the server 3101, and transmits the data as conversion target multimedia data 3404 to a data converter 3403. Further, the controller 3401 receives converted multimedia data 3411 which are output from the data converter 3403 in response to the supply of the conversion target multimedia data 3404 from the controller 3401, and temporarily stores the converted multimedia data 3411 therein. The controller 3401 has functions of outputting the converted multimedia data 3411 as transmission multimedia data 3412 and recording the converted multimedia data 3411 in a cache 3402. Further, the controller 3401 outputs a conversion system specifying information 3418 to the data converter 3403, and specifies and changes a conversion method in the data conversion unit 3403. That is, the controller 3401 temporarily holds the input multimedia data 3407, and converts one item of multimedia data 3407 according to plural conversion systems to output the data group as the transmission multimedia data 3412 and store the data in the cache 3402 by repeating the following operations:

(1) specifies the conversion method in the data converter 3403 by outputting the conversion system specifying information 3418,

(2) outputting the multimedia data 3407 as the conversion target multimedia data 3404, and

(3) inputting the converted multimedia data 3411 output from the data converter 3403.

Any data can be stored in or read out from the cache 3402.

The data converter 3403 receives the conversion target multimedia data 3404 output from the controller 3401, and outputs the converted multimedia data 3411. A signal 3418 of FIG. 51 will be described later.

The controller 3405 receives the data transmission demand command 3414 of specific multimedia data from the communication controller 3206, and outputs the command 3414 as the transmission multimedia data 3416 to the communication controller 3206 when the multimedia data as described above exist in the cache 3402. On the other hand, when no converted multimedia data exist in the cache 3402, the controller 3405 directly outputs the command 3414 as an interpretation command 3415 to the communication controller 3203.

When no converted multimedia data 3416 exist in the cache 3402 as described above, the controller 3405 also outputs predetermined multimedia data as the transmission multimedia data 3416 to the communication controller 3206. A data name storage unit 3406 serves to temporarily store the data names of data which do not exist in the cache 3402.

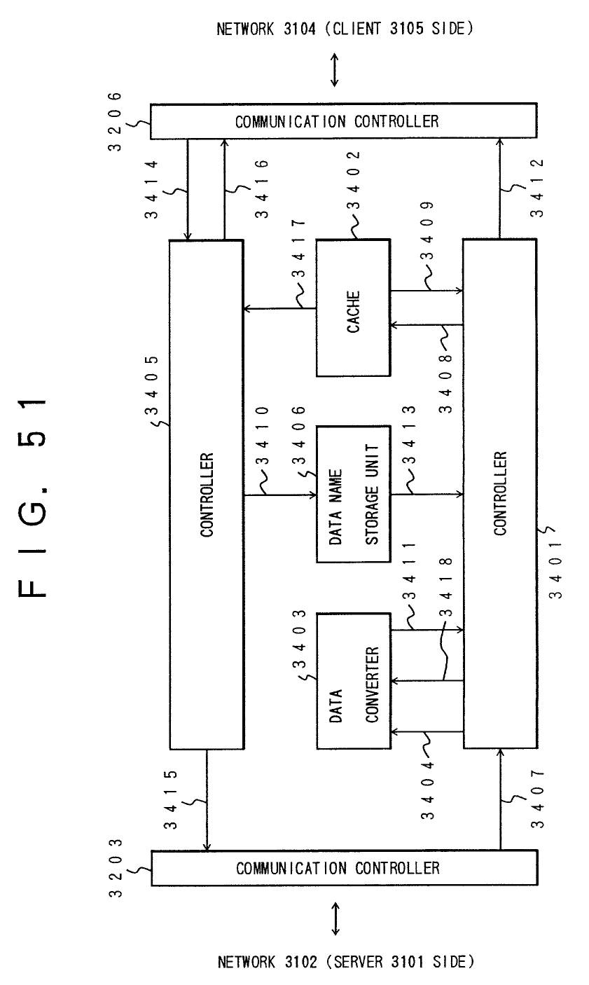

FIG. 52 shows the data structure of multimedia data of this embodiment. In FIG. 52, reference numeral 3501 represents multimedia data comprising data of n, reference numeral 3502 represents first data, reference numeral 3503 represents second data, . . . , and reference numeral 3504 represents n-th data. Each data has a data number, a data type and a data content. Specifically, reference numeral 3505 represents the data number of the data 3502, reference numeral 3506 represents the data type of the data 3502 and reference numeral 3507 represents the data content of the data 3503. Likewise, reference numeral 3508 represents the data number of the data 3503, reference numeral 3509 represents the data type of the data 3503, reference numeral 3510 represents the data content of the data 3503, reference numeral 3511 represents the data number of the data 3504, reference numeral 3512 represents the data type of the data 3504, and reference numeral 3513 represents the data content of the data 3504. The multimedia data having the data structure as shown in FIG. 52 is used as a control target.

Next, a specific operation of this embodiment will be described.

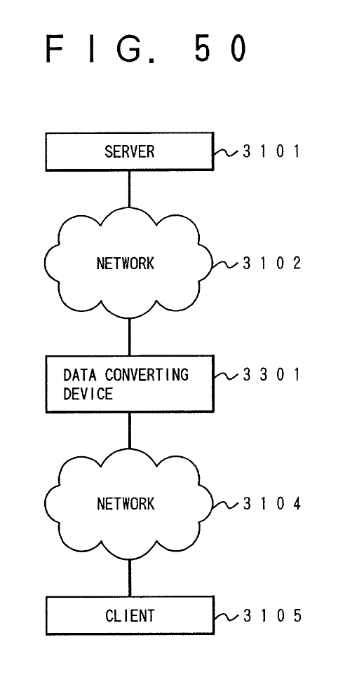

First, an operation when this invention is not applied in the multimedia network system shown in FIG. 50 will be described. This case was somewhat described in the prior art, however, it will be described in detail to clarify the features of this invention.

In FIG. 50, reference numeral 3301 represents a data converting device (data amount control relay device), and it serves to communicate data between the networks 3102 and 3104. Particularly when data are transmitted from the network 3102 to the network 3104, it performs data conversion to control the data amount of the multimedia data.

In this conventional system, the function of the data converting device is set as follows. The data converting device is designed to reduce the display size to “½” (half) size in the vertical and lateral directions for still-picture data, and also to form a digest version of six seconds for moving-picture data, whereby the data amount is reduced for the still-picture data and the moving-picture data.

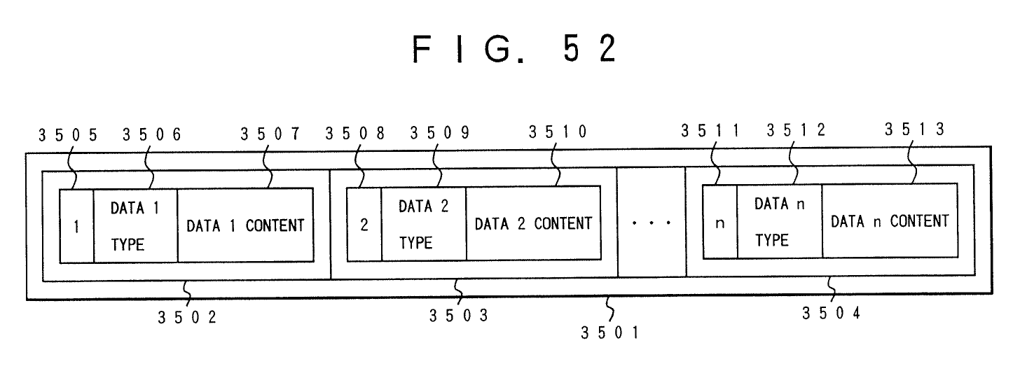

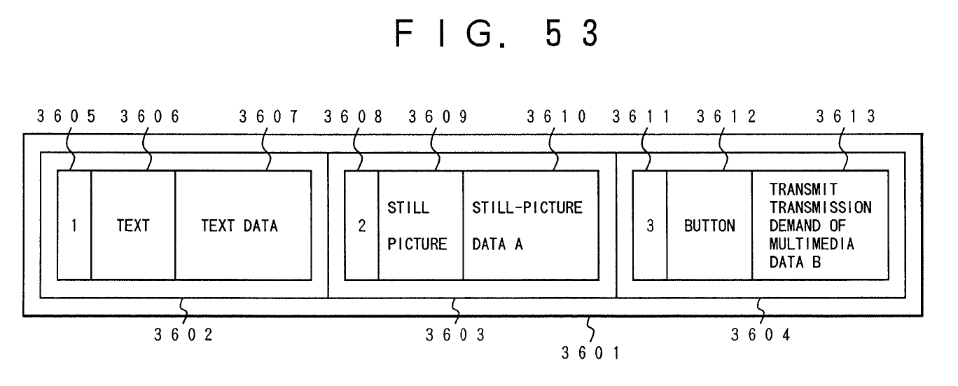

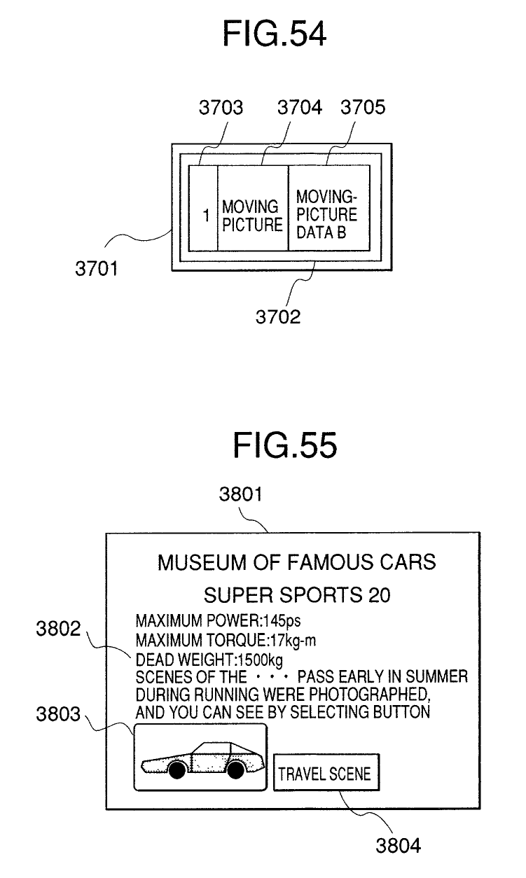

The server 3101 is assumed to have multimedia data A 3601 shown in FIG. 53 and multimedia data B 3701 shown in FIG. 54. After the system is activated, the server 3101 receives transmission demand commands of these data from a client, and transmits these data to the client if occasion demands.

In FIG. 53, reference numeral 3601 represents multimedia data comprising three data, and reference numerals 3602, 3603 and 3604 represent the data constituting the multimedia data. Reference numeral 3605 represents the data number of the data 3602, reference numeral 3606 represents a data type indicating that the data 3602 are text data, and reference numeral 3607 represents the data content of the data 3602, in which text data are stored. Likewise, reference numeral 3608 represents the data number of the data 3603, reference numeral 3609 represents a data type indicating that the data 3603 are still-picture data, and reference numeral 3610 represents the data content of the data 3603, in which still-picture data A are stored. Reference numeral 3611 represents the data number of the data 3604, reference numeral 3612 represents a data type indicating that the data 3604 are button data, and reference numeral 3613 represents the data content of the data 3604, in which button data are stored. Here, “button data” are defined as data for performing the following processing: an user displays a selectable button, and by selecting the displayed button, the command corresponding to the selected button is transmitted to the server.

In the data 3604 is stored button data to enable a transmission demand command of the multimedia data B 3701 to be transmitted to the server. The button data has data which is called as “button name” as not shown, and in this embodiment the button name of the button data 3604 is assumed to be “travel scene”.

In FIG. 54, reference numeral 3701 represents multimedia data B comprises one item of data, and reference numeral 3702 represents the data constituting the multimedia data B. Here, reference numeral 3703 represents a data number, reference numeral 3704 represents a data type indicating that the data 3702 are moving-picture data, and reference numeral 3704 represents the data content of the data 3702, in which moving-picture data B are stored. Here, the moving-picture data B 3702 are assumed to be moving pictures of 30-second reproduction time.

The client 3105 connected to the network 3104 has at least means for interpreting the multimedia data, a display, a pointing device, and a communication device for transmitting information such as commands, etc. to the network 3104 and receiving information from the network 3104.

First, data communication which is performed between the server 3101 and the client 3105 through no data converting device 3301 will be described.

When the client 3105 receives the multimedia data A 3601, the client interprets the received data content to display image information as shown in FIG. 55 on the display, and waits for an user's instruction through the pointing device. In FIG. 55, reference numeral 3801 represents a screen display of the multimedia data A 3601, reference numeral 3802 represents a screen display of the text data 3607, reference numeral 3803 represents a screen display of the still-picture data A 3610, and reference numeral 3804 represents a screen display of the button data 3613. As described above, the data are displayed in a storage order of the data constituting the multimedia data (“storage” means “constituting”).

When the user of the client 3105 selects a button 3804 through the pointing device, the client 3105 transmits the transmission demand command of the multimedia data B 3701 to the server 3101. The data converting device 3301 receives the transmission demand command through the network 3104, and transmits the command to the server 3101. The server 3101 receives the command through the network 3102, and transmits the multimedia data B 3701 to the client 3105.

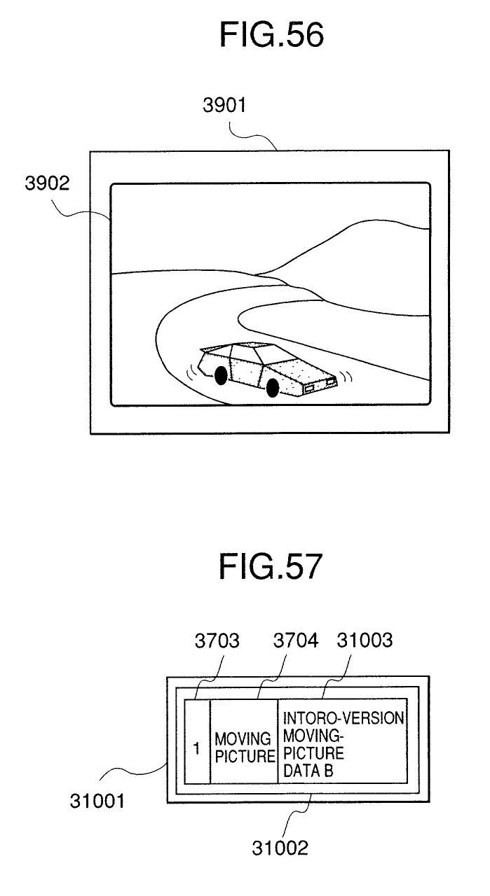

Likewise, when the client 3105 receives the multimedia data B 3701, the client 3105 interprets the received data content to display image information as shown in FIG. 56 on the display. In FIG. 56, reference numeral 3901 represents a screen display of the multimedia data B 3701, and reference numeral 3902 represents a screen display of the moving-picture data B 3704. At this time, moving pictures of 30 seconds are reproduced on the screen display 3902.

It is assumed that the client 3105 transmits the transmission demand command of the multimedia data A when it is activated. This transmission demand command is transmitted through the network 3104 to the data converting device 3301. The data converting device 3301 transmits the transmission demand command to the server 3101.

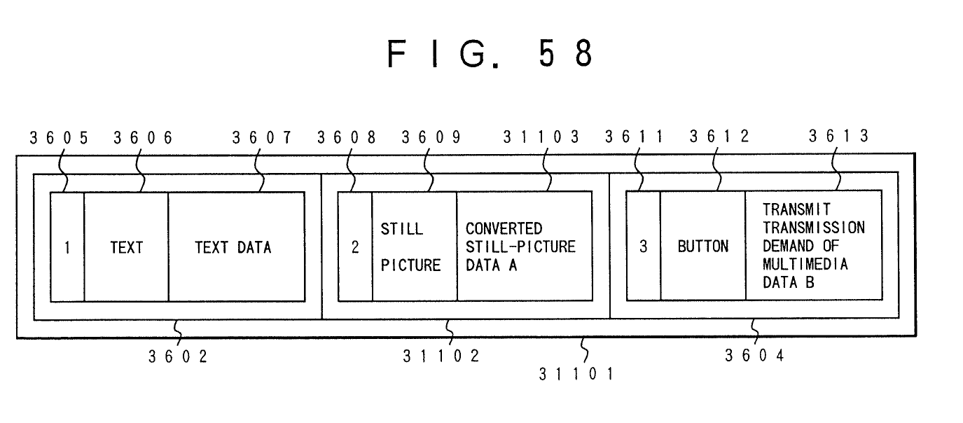

The server 3101 receives the command through the network 3102, and in response to this command it transmits the multimedia data A 3601 to the client 3105. The data converting device 3301 receives the multimedia data A 3601 through the network 3102. The data converting device 3301 converts the multimedia data A 3601 to multimedia data 31101 shown in FIG. 58, and transmits the converted multimedia data 31101 to the client 3105. In FIG. 58, reference numeral 31101 represents the multimedia data which are converted by the data converting device 3301. Reference numeral 31102 represents the constituent data which are converted by the data converting device 3301, and reference numeral 31103 represents still-picture data A whose display size is reduced to “½” in the vertical and lateral directions by the data converting device 3301.

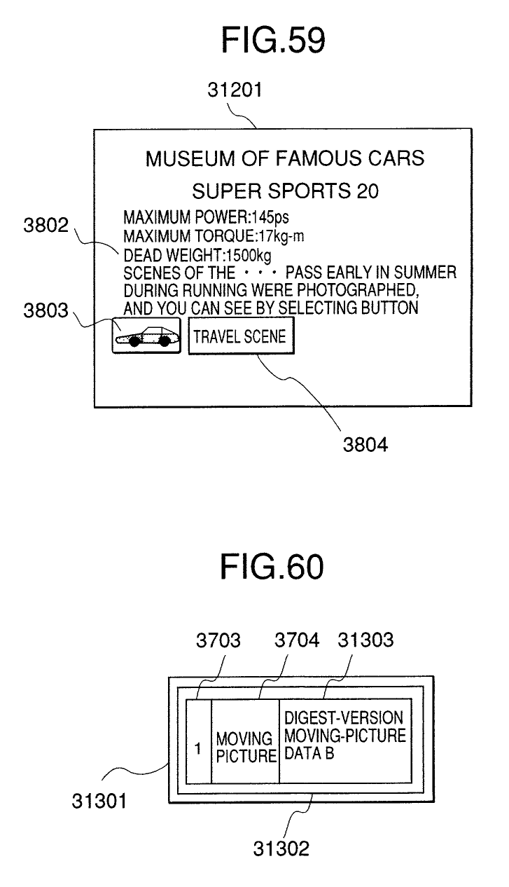

The client 3105 receives the multimedia data 31101 through the network 3104 to interpret the received data content and display image information as shown in FIG. 59 on the display, and waits for an user's instruction through the pointing device. In FIG. 59, reference numeral 31201 represents a screen display of the client for the received multimedia data 31101. Reference numeral 31202 represents a screen display of the still-picture data A whose display size is reduced to “½” in the vertical and lateral directions.

When the user of the client 3105 selects a button 3804 through the pointing device, the client 3105 transmits the transmission demand command of the multimedia data B 3701 to the server 3101. The data converting device 3301 receives the transmission demand command through the network 3104 and transmits the command to the server 3101. The server 3101 receives the command through the network 3102, and in response to the command it transmits the multimedia data B 3701 to the client 3105. The data converting device 3301 receives the multimedia data B 3701 through the network 3102.

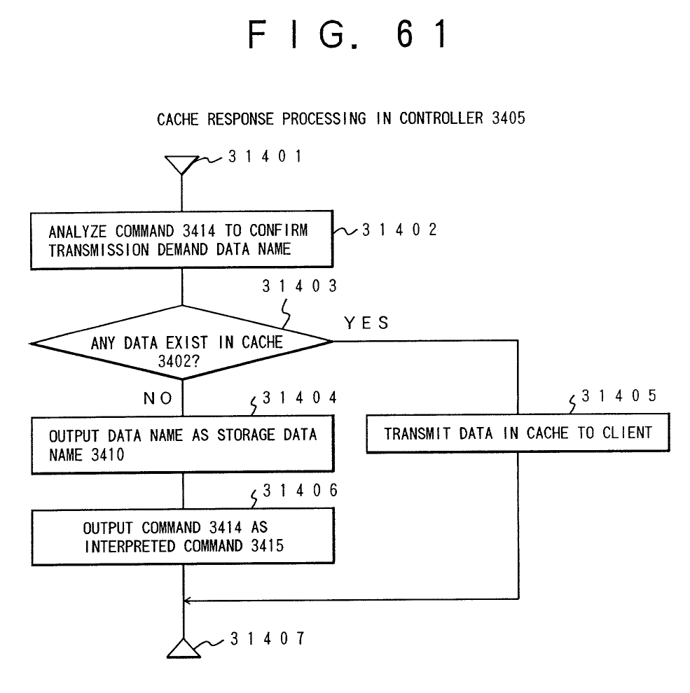

The data converting device 3301 converts the multimedia data B 3701 to multimedia data 31301 shown in FIG. 60, and transmits the multimedia data 31301 to the client 3105.

In FIG. 60, reference numeral 31301 represents multimedia data, reference numeral 31302 represents first data constituting the multimedia data 31301, and reference numeral 31303 represents moving-picture data which are obtained by deleting a part of the moving-picture data 3705 to shorten the moving-picture data 3705 by an amount corresponding to six seconds.

The client 3105 receives the multimedia data 31303 through the network 3104 to interpret the received data content, and displays image information as shown in FIG. 56 on the display.

In FIG. 56, reference numeral 3901 represents a screen display of the multimedia data B 3701, and reference numeral 3902 represents a screen display of the moving-picture data 31301. In this case, on the screen display 3092 are reproduced moving pictures of 6 seconds which are extracted from moving pictures of 30 seconds of the moving-picture data B.

As described above, according to the conventional system, the multimedia data which are transmitted from the server 3101 to the client 3105 are subjected to the size conversion processing to reduce the display size thereof, whereby the transmission rate of the multimedia data in the network 3104 can be increased. As a result, the transmission rate of the multimedia data from the server 3101 to the client 3105 increases. However, in the conventional system, when the time cost of the conversion processing in the data converting device 3301 is large, the transmission rate of the multimedia data from the server 3101 to the client 3105 may be finally lower than that in the case where no data conversion is performed by the data converting device 3301.

The foregoing description relates to the operation of the conventional system. Next, the operation of the system of an embodiment will be described with reference to FIGS. 48 and 51.

In this embodiment, the following assumptions are introduced:

(Assumption 1)

Data which can be converted by the data converter 3403 are limited to still-picture data and moving-picture data. The conversion of the still-picture data is carried out by reducing the display size of pictures to “½” in each of the vertical and lateral directions. The conversion of the moving-picture data is carried out by preparing digest-version moving pictures having a reproduction time which is one-fifth as long as the original reproduction time. That is, the function of the data converter 3403 is identical to that of the data converting device 3301 for the data conversion.

(Assumption 2)

It is set as an initial condition that no data are stored in the cache 3402.

Considering the above assumptions, the operation of the system according to this embodiment will be described.

First, it is assumed that when the client 3105 is activated, the client 3105 transmits the transmission demand command of the multimedia data A 3601 to the server 3101. The communication controller 3206 receives through the network 3104 the transmission demand command which is transmitted to the server 3101, and transmits the command as the command 3414 to the controller 3405.

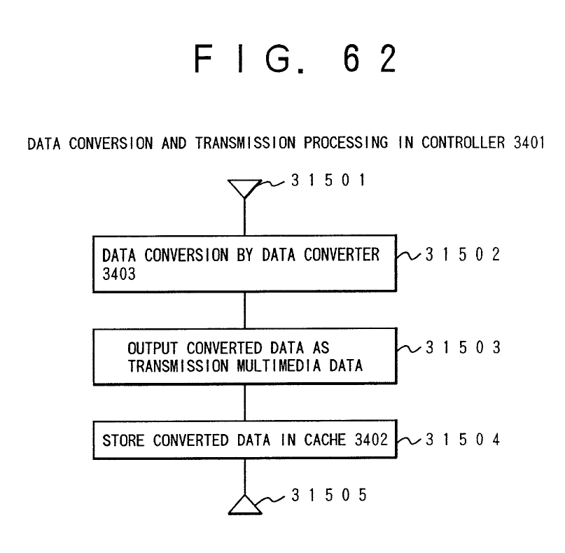

When receiving the command 3414, the controller 3405 carries out “cache response processing” of attempting to satisfy the demand from the client 3105 by transmitting data stored in the cache 3402. The controller 3405 performs this cache response processing according to a flowchart of FIG. 61.

Next, the cache response processing will be described hereunder in detail with reference to FIG. 61.

In step 31401, the cache response processing of the controller 3405 is started. In step 31402, the controller 3405 analyzes the command 3414 to lead out the data name of data demanded by the command 3414. At present, the command 3414 is the transmission demand command of the multimedia data A 3601, and thus the demand data name is “multimedia data A”.

In step 31403, the controller 3405 checks whether the data having the data name obtained in step 31402 are stored in the cache 3402. If the data exist in the cache 3402, the controller 3405 judges “YES”, and the process goes to step 31405. In step 31405, the data in the cache 3402 are transmitted through the communication controller 3206 and the network 3104, and the details thereof will be described later. On the other hand, if the data concerned do not exist in the cache 3402, the controller 3405 judges “NO”, and the process goes to step 31404. In this case, no data are stored in the cache 3402, so that the judgment is “NO” and the process goes to step 31404.

In step 31404, the controller 3405 outputs the data name obtained in step 31402 as a stored data name 3410, and stores the stored data name 3410 into a data name storage unit 3406. In this case, “multimedia data A” is stored. Subsequently, in step 31406, the controller 3405 outputs the command 3414 as an interpretation command 3415. Thereafter, in step 31407, the controller finishes the cache response processing.

The communication controller 3103 transmits the interpretation command 3415 to the server 3101. The server 3101 receives the command through the network 3102, and in response to the command it transmits the multimedia data A 3601 to the client 3105. The communication controller 3203 receives the multimedia data A 3601, and transmits the data as multimedia data 3407 to the controller 3401.

When receiving the multimedia data 3407, the controller 3401 performs “data conversion and transmission processing” of converting the received data according to a predetermined regulation, transmitting the converted data to the client 3105, and then storing the converted data into the cache 3402. The controller 3401 performs the data conversion and transmission processing according to a flowchart of FIG. 62.

The data conversion and transmission processing will be described hereunder with reference to FIG. 62.

In step 31501, the data conversion and transmission processing of the controller 3401 is started. In step 31502, the controller 3401 outputs the multimedia data 3407 as conversion target data 3404. The data converter 3403 converts the multimedia data 3407 according to a predetermined system, and outputs the converted data as the converted multimedia data 3411. In this case, the multimedia data 3407 are the multimedia data A 3601 (FIG. 53). From the assumption 1, the data converter 3403 converts the multimedia data A 3601 (FIG. 53) to the multimedia data 31101 (FIG. 58).

In step 31503, the controller 3401 outputs the converted multimedia data 3411 as the transmission multimedia data 3412. The communication controller 3206 transmits the transmission multimedia data 3412 to the client 3105. In this case, the transmission multimedia data 3412 are the multimedia data 31101.

The client 3105 receives the multimedia data 31101 through the network 3104 to interpret the received data content, displays image information as shown in FIG. 59 on the display and waits for an user's instruction through the pointing device. It is apparent from the screen display of the client that the above operation is the same as the conventional system.

In step 31504, the controller 3401 names the converted multimedia data 3411 as the data name 3413 which is previously stored in the data name storage unit 3406, and stores it into the cache 3402. The data name stored in the data name storage unit 3406 is “multimedia data A”, and specifically the converted multimedia data are the multimedia data 31101. Therefore, the multimedia data 31101 are stored as the name “multimedia data A” in the cache 3402. In step 31505, the controller 3401 finishes the data conversion and transmission processing.

As described above, the controller 3401 converts the multimedia data 3407 by the data conversion and transmission processing, outputs the converted data as the transmission multimedia data 3412, and stores the transmission multimedia data 3412 into the cache 3402 while naming the data as the data name stored in the data name storing unit 3406.

When the user of the client 3105 selects the button 3804 through the pointing device, the client 3105 transmits the transmission demand command of the multimedia data B 3701 to the server 3101.

The communication controller 3206 receives the transmission demand command which is transmitted to the server 3101 through the network 3104, and transmits the command as the command 3414 to the controller 3405. When receiving the command 3414, the controller 3405 performs “cache response processing” of attempting to respond to the command on the basis of the data stored in the cache 3402.

In this case, since only the data having the data name “multimedia data A” are stored in the cache 3402, the controller 3403 outputs the interpretation command 3414 to the server 3101 without responding on the basis of the data stored in the cache 3402 in the same manner as described above.

The communication controller 3203 transmits the interpretation command 3415 to the server 3101. The server 3101 receives this command through the network 3102, and in response to the command, it performs the processing of transmitting the multimedia data B 3701 to the client 3105. The communication controller 3203 receives the multimedia data B 3701, and transmits the data as the multimedia data 3407 to the controller 3401.

In the same manner as described above, the controller 3401 converts the multimedia data B 3701 to the multimedia data 31301 through the data conversion and transmission processing by using the data converter 3403, outputs the multimedia data 31301 as the transmission multimedia data 3412 and stores the data into the cache 3402.

The communication controller 3206 transmits the transmission multimedia data 3412 to the client 3105. In this case, the transmission multimedia data 3412 are the multimedia data 31301 (FIG. 60).

The client 3105 receives the multimedia data 31301 through the network 3104 to interpret the received data content, and displays the image information shown in FIG. 56 on the display. At this time, in the cache 3402 are stored two multimedia data named as “multimedia data A” and “multimedia data B”.

Next, a case where the client 3105 is activated again in the above state will be described.

It is assumed that when the client 3105 is activated, the client transmits the transmission demand command of the multimedia data A 3601 to the server 3101. The communication controller 3206 receives the transmission demand command 3104 which is transmitted to the server 3101 through the network, and transmits the command as the command 3414 to the controller 3405. The controller 3405 receives the command 3414 to perform the cache response processing.

The cache response processing will be described below with reference to FIG. 61.

In step 31402, the controller 3405 analyzes the command 3414 to lead out the data name of data which are demanded by the command 3414. At present, the demand data name of the command 3414 is “multimedia data A”.

In step 31403, the controller 3405 checks whether the data of the data name obtained in step 31402 are stored in the cache. In this case, the judgment is “YES”, and the process goes to step 31405.

Subsequently, in step 31405, the multimedia data having the data name which is lead out in step 31402 are output as the transmission multimedia data 3416. Here, the data which are stored in the cache 3402 with the data name “multimedia data A”, so that the transmission multimedia data 3416 to be output from the controller 3405 are the multimedia data 31101. In step 31407, the controller 3405 finishes the cache response processing. In this case, no interpretation command 3415 is output, and thus the command is not relayed to the server.

Subsequently, the communication controller 3206 transmits the transmission multimedia data 3416, that is, the multimedia data 31101 to the client 3105. The client 3105 receives the multimedia data 31101 through the network 3104 to interpret the received data content and display such image information as shown in FIG. 59 on the display, and is kept on standby for an user's instruction through the pointing device.

Further, when the user of the client 3105 selects the button 3804 through the pointing device, the client 3105 transmits the transmission demand command of the multimedia data B 3701 to the server 3101.

The communication controller 3206 receives the transmission demand command of the multimedia data B 3701. However, as described at the activation time of the client 3105, data having the data name “multimedia data B” exist in the cache 3402, and thus the data are transmitted to the client 3105 by the controller 3405. Therefore, the transmission demand command of he multimedia data B 3701 is not transmitted to the server 3101, and the data conversion processing of the data converter 3403 is not performed.

As described above, according to this embodiment, the conversion data of the multimedia data which has been once accessed from the client 3105 to the server 3101 can be supplied to the client 3105 without performing the transmission and conversion processing at second or subsequent times.

With the above operation, even when the time cost of the data conversion is large, the user of the client 3105 can obtain the converted data at an earlier stage in this embodiment than in the prior art if the converted data are stored in the cache 3402.

Further, if the cache 3402 is achieved in consideration of a file system, not only a file name, but also attributes such as a recording date and a recording capacity may be provided to a file. In this case, as the storage capacity of the cache 3402 approaches to its upper limit, a file management can be performed in such a manner as to delete files from an older file or larger-capacity file, whereby the storage capacity of the cache 3402 can be efficiently used.

(Eighth Embodiment)

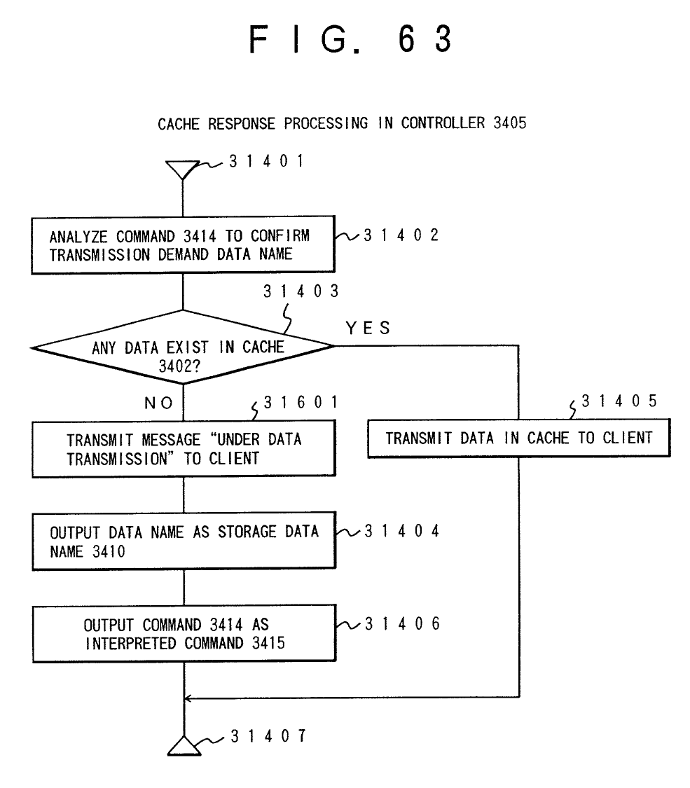

Next, an eighth embodiment according to the present invention will be described. In this embodiment, the cache response processing of the controller 3405 in the seventh embodiment is altered. According to this embodiment, the cache response processing of the controller 3405 is performed according to the flowchart of FIG. 63.

In order to describe the specific operation of this embodiment, the same assumptions as described in the seventh embodiment are introduced, and also the following assumption is introduced.

(Assumption 3)

The client 3105 performs no other operation from the time when the client transmits a command to the server 3101 until the time when the reception of the multimedia data is completed.

It is also assumed that when the client 3105 is activated, it transmits the transmission demand command of the multimedia data A 3601 to the server 3101. The communication controller 3206 receives the transmission demand command which is transmitted to the server 3101 through the network 3104, and transmits the command to the controller 3405.

When receiving the command 3414, the controller 3405 performs the cache response processing according to the flowchart of FIG. 63.

The cache response processing of this embodiment will be described hereunder with reference to FIG. 63.

The difference in the cache response processing between this embodiment and the seventh embodiment resides in that this embodiment has a step 31601 between the step 31403 and the step 31404. Accordingly, the operation at the steps other than the step 31601 is identical to that of the seventh embodiment, and thus only the different point will be mainly described.

In step 31402, the command 3414 is the transmission demand command of the multimedia data A 3601, and thus the demand data name is “multimedia data A”.

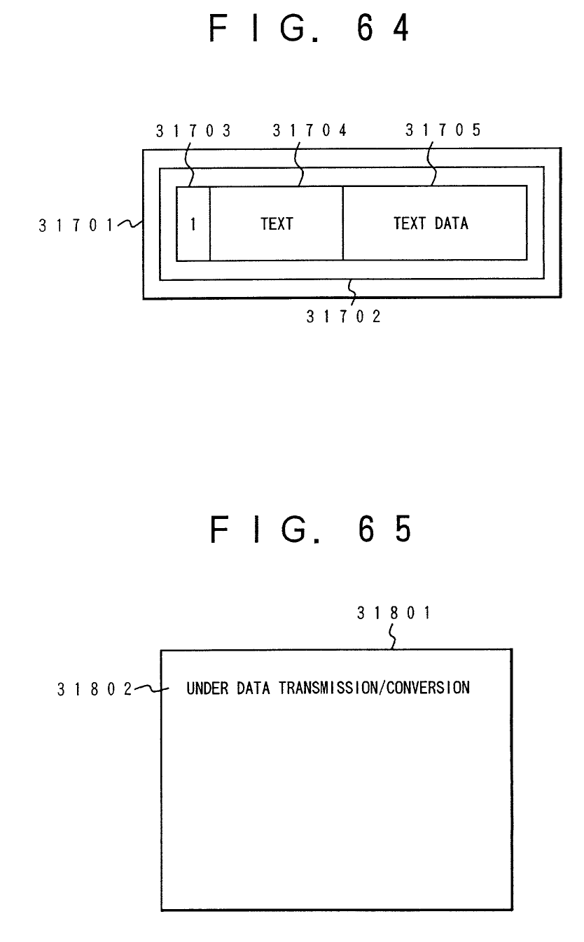

In step 31403, when target data are not stored in the cache 3402, the process goes to step 31601, and in step 31601 the controller 3405 outputs predetermined multimedia data C shown in FIG. 64 as the transmission multimedia data 3416.

In FIG. 64, reference numeral 31701 represents the multimedia data C, and reference numeral 31702 represents the data constituting the multimedia data C 31701. Reference numeral 31703 represents a data number, reference numeral 31704 represents a data type indicating that the data 31702 are text data, and reference numeral 31705 represents the data content of the data 31702, in which text data C are stored. Here, the text data C are text data having a content “under data transmission and conversion”.

The processing at the following steps 31404 and 31406 is the same as described above.

Through the above processing, the controller 3405 transmits a message indicating “under data transmission and conversion” to the client 3105, and also transmits the command 3414 to the server 3101 when data which are demanded to be transmitted by the command 3414 do not exist in the cache 3402.

The communication controller 3206 transmits the transmission multimedia data 3416 to the client 3105. In this case, the multimedia data 3416 are the multimedia data C 31701.

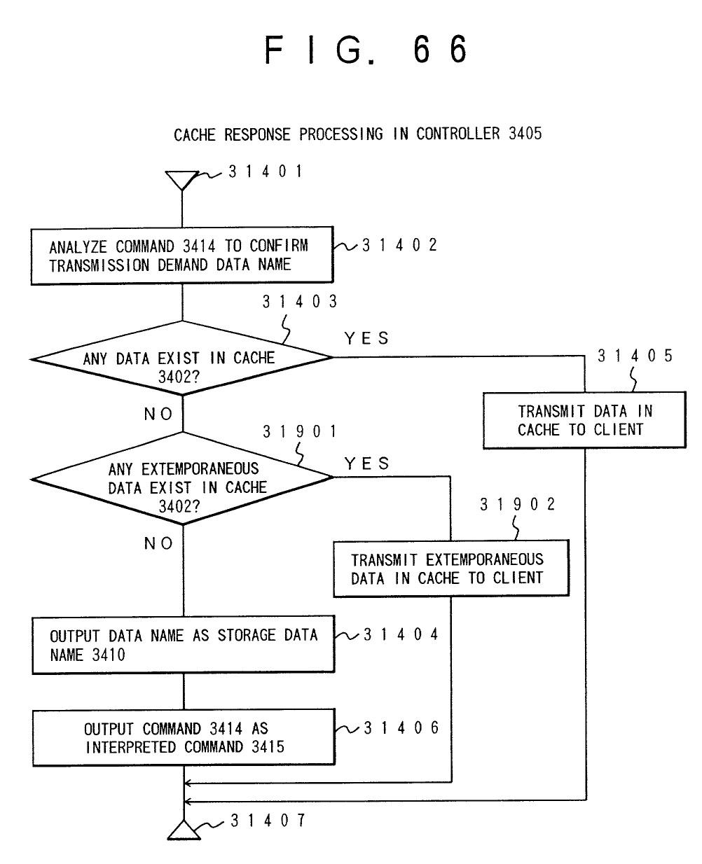

When the client 3105 receives the multimedia data C 31701, the client 3105 interprets the received data content, and displays such image information as shown in FIG. 65 on the display.

In FIG. 65, reference numeral 31801 represents a screen display of the multimedia data C 31701, and reference numeral 31802 represents a screen display of the text data 31705.

The communication controller 3203 transmits the interpretation command 3415 to the server 3101. The server 3101 receives the command through the network 3102, and transmits the multimedia data A 3601 to the client 3105.

The communication controller 3203 receives the multimedia data A 3601, and transmits the data as the multimedia data 3407 to the controller 3401. When receiving the multimedia data 3407, the controller 3401 performs “data conversion and transmission processing” of converting the data according to the predetermined regulation like the seventh embodiment, transmitting the converted data to the client, and storing the data into the cache 3402.

The data conversion and transmission processing of the controller 3401 of this embodiment is similar to that of the seventh embodiment, and thus the detailed description thereof is omitted.

In this embodiment, the controller 3401 converts the multimedia data A 3601 to the multimedia data 31101 through the data conversion and transmission processing by using the data converter 3403, outputs the converted data as the transmission multimedia data 3412 and stores the data into the cache 3402.

Subsequently, the communication controller 3206 transmits the transmission multimedia data 3416, that is, the multimedia data 31101 to the client 3105.

The client 3105 receives the multimedia data 31101 through the network 3104 to interpret the received data content and display such image information as shown in FIG. 59 on the display, and is kept on standby for an user's instruction through the pointing device.

Further, when the user of the client 3105 selects the button 3804 through the pointing device, the client 3105 transmits the transmission demand command of the multimedia data B 3701 to the server 3101.

The operation at this time is substantially similar to that at the activation time of the client 3105. That is, the communication controller 3206 receives the transmission demand command, and transmits the command as the command 3414 to the controller 3405. Here, the data stored in the cache 3402 are only the data named as “multimedia data A”, and thus the storage unit 3405 outputs the multimedia data C as the transmission multimedia data 3416 and also outputs the command 3414 as the interpretation command 3415.

The communication controller 3206 transmits the multimedia data C 31701 to the client 3105. In the same manner at the activation time of the client 3105, when the client 3105 receives the multimedia data C 31701, the client 3105 interprets the received data content and displays such image information as shown in FIG. 65 on the display.

Here, the display frame of FIG. 65 can be changed to the frame shown in FIG. 59 by operating the pointing device at the client 3105.

The communication controller 3203 transmits the interpretation command 3415 to the server 3101.

The server 3101 receives this command through the network 3102, and transmits the multimedia data B 3701 to the client 3105.

The communication controller 3203 receives the multimedia data B 3701, and transmits the data as the multimedia data 3407 to the controller 3401.

In the same manner as carried out at the activation time of the client 3105, the controller 3401 converts the multimedia data B 3701 to the multimedia data 31301 through the data conversion and transmission processing by using the data converter 3403, outputs the multimedia data 31301 as the transmission multimedia data 3412 and stores the data in the cache 3402.

The communication controller 3206 transmits the transmission multimedia data 3412 to the client 3105. At this time, the transmission multimedia data 3412 are the multimedia data 31301.

The client 3105 receives the multimedia data 31301 through the network 3104 to interpret the received data content, and displays such image information as shown in FIG. 56 on the display. At this time, two multimedia data which are named as “multimedia data A” and “multimedia data B” are stored in the cache 3402. The operation when the client 3105 is activated again in the above state is identical to that of the seventh embodiment, and thus the description thereof is omitted.

According to this embodiment, in the case where the data demanded by the client 3105 do not exist in the cache 3402, for a period from the time when the multimedia data are transmitted to the cache-attached data converting device 3103 until the time when the transmitted multimedia data are converted in the cache-attached data converting device 3103, the user of the client 3105 is allowed to have an message indicating the transmission and conversion processing as described above.

In the conventional system, when no converted multimedia data exist in the cache 3402, the user's operation in the client 3105 must be interrupted and kept on standby during the period from the time when the multimedia data are transmitted from the server 3101 to the data converting device 3301 until the time when the conversion processing is completed in the data converting device 3301 and then the converted data are transmitted to the client 3105.

On the other hand, according to this embodiment, when the user selects the button 3804 to transmit the transmission demand command of the multimedia data B 3701 to the server 3101, if no converted data exist in the cache 3402, the client 3105 receives the multimedia data C 31701 to have a display as shown in FIG. 65 on the display while the cache-attached data converting device 3103 receives the data from the server 3101 and converts the data. The client 3105 does not receive the data demanded by the user, but receives the multimedia data C 31701, so that the user can perform another operation during the conversion data of the transmission of the multimedia data B 3701 to the client 3105.

In this case, it is necessary to execute plural software having functions other than the cache 3402 of FIG. 51 in parallel, and enable these software to own the cache 3402 jointly.

If a data conversion time can be estimated in the data converter 3403 or a data transmission rate can be estimated in the communication controllers 3203 and 3206, the above information may be inserted into the multimedia data C 31701 to display, for example, a message “data transmission and conversion is being performed, and it will take three minutes at minimum” on the screen of the client 3105 in order to support the user's efficient operation. Even when the assumption 3 is not set, this message has the same effect as “a clue to know a time until the user's demand is satisfied”.

(Ninth Embodiment)

Next, a ninth embodiment of the present invention will be described. In this embodiment, the cache response processing of the controller 3405 and the conversion processing of the controller 3401 in the seventh embodiment are altered.

Further, according to this embodiment, the assumption 1 of the seventh embodiment is altered as follows:

(Assumption 1′)

The data which can be converted by the data converter 3403 are limited to still-picture data and moving-picture data. The conversion of the still-picture data is performed by reducing the display size of pictures to “½” (half) size in the vertical and lateral directions. With respect to the conversion of the moving-picture data, the data converter 3403 can two kinds of data conversion processing. One conversion processing is to prepare a digest-version moving-picture data having a reproduction time which is one-fifth of that of the original moving-picture data. The other conversion processing is to cut most of the moving-picture data except for a head portion of 6 seconds to prepare introductory moving-picture data. Here, the processing time for the latter introductory moving-picture processing is assumed to be extremely shorter than that for the former digest-version moving-picture processing.

This embodiment will be described in consideration of the assumption 1′ and the assumption 2 of the seventh embodiment as described above.

This embodiment is characterized by the operation at the transmission time of the moving-picture data, and thus the operation at the activation (start) time of the client 3105 is omitted. Therefore, the operation when the frame shown in FIG. 59 is displayed on the display of the client 3105 and the user of the client 3105 selects the button 3804 through the pointing device will be described.

First, in the cache 3402 are stored only the data having the data name “multimedia data A”.

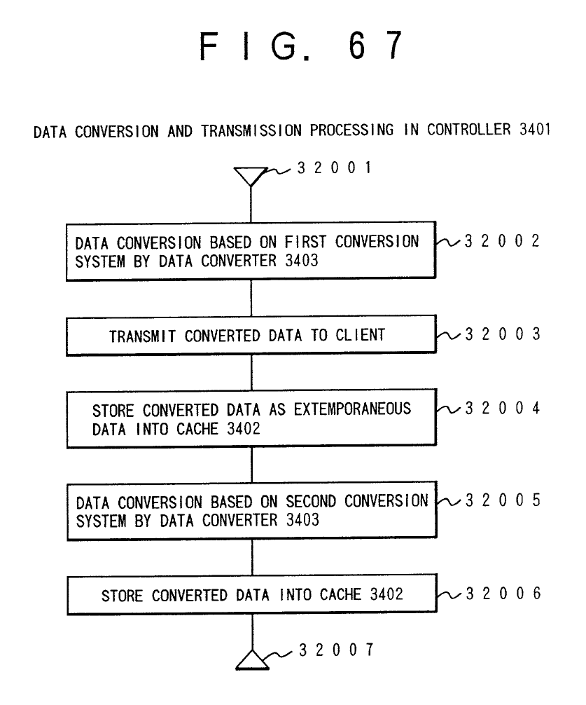

When the user of the client 3105 selects the button 3804 through the pointing device, the client 3105 transmits the transmission demand command of the multimedia data B 3701 to the server 3101. The communication controller 3206 receives the transmission demand command which is transmitted through the network 3104 to the server 3101, and transmits the command as the command 3414 to the controller 3405. When receiving the command 3414, the controller 3405 performs the cache response processing according to the flowchart of FIG. 66.

The cache response processing of this embodiment will be described hereunder with reference to FIG. 66.

In step 31401, the cache response processing of the controller 3405 is started. In step 31402, the controller 3405 leads out the data name of the data which are demanded by the command 3414. At present, the command 3414 is the transmission demand command of the multimedia data B 3701, and thus the demand data name is “multimedia data B”.

In step 31403, the controller 3405 checks whether the data having the data name obtained in step 31402 are stored in the cache. Since no data are stored in the cache 3402, the judgment result is “NO”, and the process goes to step 31901.

In step 31901, the controller 3405 checks whether the cache is stored with the data having the data name in which a character array “.extempore” is added to the end of the data name obtained in step 31402. In this case, since the data having the data name “multimedia data B.extempore” are not stored in the cache 3402, the judgment result is “NO” and the process goes to step 31404.

In step 31404, the controller 3405 stores the data name “multimedia data B” into the data name storage unit 3406. Subsequently, in step 31406, the controller 3405 outputs the command 3414 as the interpretation command 3415. In step 31407, the controller 3405 finishes the cache response processing.

As described above, the controller 3405 of this embodiment is different from the seventh embodiment in that it checks whether the multimedia data having a data name demanded by the command or the multimedia data having a data name obtained by adding “.extempore” to the end of the above data name are stored in the cache 3402.

The communication controller 3203 transmits the interpretation command 3415 to the server 3101. The server 3101 receives this command through the network 3102, and in response to the command it transmits the multimedia data B 3701 to the client 3105.

The communication controller 3203 receives the multimedia data B 3701, and transmits the data as the multimedia data 3407 to the controller 3401. The controller 3401 performs the data conversion and transmission processing according to the flowchart of FIG. 67.

The data conversion and transmission processing as described above will be hereunder described with reference to FIG. 67.

In step 32001, the data conversion and transmission processing of the controller 3401 is started. In step 32002, the controller 3401 converts the multimedia data 3407 according to a first conversion system. In this case, the first conversion system is assumed to be a conversion system for preparing intro moving pictures as described in “assumption 1′”. First, the controller 3401 outputs conversion system specifying information 3418 “specify the conversion system of preparing the intro moving pictures as a moving-picture conversion system” to specify the conversion system of the data converter 3403. After this operation, the data converter 3403 subjects moving-picture data to such conversion processing that the moving-picture data are cut while only a head portion thereof corresponding to 6 seconds is left, thereby preparing intro moving-picture data. Subsequently, the controller 3410 outputs the multimedia data 3407 as the conversion target multimedia data 3404, and controls the data converter 3403 to perform the data conversion. The data converter 3403 outputs the converted data as the converted multimedia data 3411. In this case, the conversion target multimedia data 3404 correspond to the multimedia data B 3701, and the data are converted to the multimedia data 31001 shown in FIG. 57. In FIG. 57, reference numeral 31001 represents the multimedia data which are converted by the data converter 3403, reference numeral 31002 represents first data of the multimedia data 31001, and reference numeral 31003 represents intro moving-picture data which are obtained by cutting most of the moving-picture data except for the head portion of 6 seconds.

Returning to FIG. 67, in step 32003, the controller 3401 outputs the data converted by the data converter 3403 as the transmission multimedia data 3412 to the client 3105. In this case, the controller 3401 outputs the multimedia data 31001 as the transmission multimedia data 3412.

The communication controller 3206 transmits the transmission multimedia data 3412 to the client 3105. In this case, the communication controller 3206 transmits the multimedia data 31001 to the client 3105.

The client 3105 receives the multimedia data 31001 through the network 3104 to interpret the received data content, and displays such image information as shown in FIG. 56 on the display. At this time, on the frame display 3902 are reproduced moving pictures at the head portion corresponding to 6 seconds, which are cut out from 30-second moving pictures of the moving-picture data B.

In step 32004, the controller 3401 stores the converted multimedia data 3411 into the cache 3402. At this time, the converted multimedia data 3411 are stored in the cache 3402 under the data name having “.extempore” added to the end of the data name 3413 which is obtained from the data name storage unit 3406. In this case, the controller 3401 stores the multimedia data 31001 in the cache 3402 under the data name of “multimedia data B.extempore”.

At this time, two multimedia data are stored in the cache 3402 under the names of “multimedia data A” and “multimedia data B.extempore”.

In step 32005, the controller 3401 converts the multimedia data 3407 according to a second conversion system. In this case, the second conversion system is assumed to be a conversion system of preparing digest moving-picture data as described in the “assumption 1′”. First, the controller 3401 outputs conversion system specifying information 3418 “specify the conversion system of preparing digest moving pictures as a moving-picture conversion system” to specify the conversion system of the data converter 3403. After this operation, for moving-picture data, the data converter 3403 is set to perform the conversion processing of preparing digest moving-picture data having a reproduction time which is one-fifth of the reproduction time of original moving-picture data.

Subsequently, the controller 3401 outputs the multimedia data 3407 as the conversion target multimedia data 3404 and controls the data converter 3403 to perform the data conversion. The data converter 3403 outputs the converted data as the converted multimedia data 3411. In this case, the conversion target multimedia data 3404 correspond to the multimedia data B 3701. The data are converted to the multimedia data 31301 by the data converter 3403, and output as the converted multimedia data 3411.

In step 32006, the controller 3401 stores the converted multimedia data 3411 into the cache 3402 under the data name 3413 obtained from the data name storage unit 3406. In this case, the multimedia data 31301 are stored under the data name of “multimedia data B”.

In step 32007, the controller 3401 finishes the data conversion and transmission processing. At this time, in the cache 3402 are stored three multimedia data which are named as “multimedia data A”, “multimedia data B” and “multimedia data B.extempore”.

In this case, it is assumed that plural software having functions other than the cache 3402 as shown in the block diagram of FIG. 51 can be executed in parallel in the cache-attached data converting device 3103, and these software own the cache jointly.

Further, it is assumed that another client like the client 3105 is connected to the network 3104 to access the server 3101 like the client 3105. Further, it is assumed that the other client concerned has been activated and thus it is kept in the frame display state shown in FIG. 59 to wait for an user's input through the pointing device. The data content to be received by the client is varied in accordance with the timing at which the user of the other client concerned selects the button 3804 to transmit the transmission demand command of the multimedia data B 3701. Here, two timings may be considered.

Timing A . . . “just after the client 3105 transmits the transmission demand command of the multimedia data B 3701 to the server 3101”: In this case, the processing of the controller 3401 has not been completely finished, and two multimedia data which are named as “multimedia data A” and “multimedia data B.extempore” are stored in the cache 3402.

Timing B . . . “after some time have elapsed from the transmission of the transmission demand command of the multimedia data B 3701 from the client 3105 to the server 3101”: In this case, the processing of the controller 3401 has been completely finished, and three multimedia data which are named as “multimedia data A”, “multimedia data B” and “multimedia data B.extempore” are stored in the cache 3402.

Further, the timing “before the client 3105 transmits the transmission demand command of the multimedia data B 3701 to the server 3101” may be considered. The operation in this case is identical to the first operation of this embodiment, and thus it is omitted.

In the case of the timing A, no data having the data name “multimedia data B” exist in the cache 3402, however, the data having the data name “multimedia data B.extempore” exist in the cache 3402. Therefore, through the processing of the controller 3405, the client receives the multimedia data 31001.

In the case of the timing B, since the data having the data name “multimedia data B” exist in the cache 3402 and also the data having the data name “multimedia data B.extempore” exist in the cache 3402, the client receives the multimedia data 31301 through the processing of the controller 3405.

As described above, according to this embodiment, when no demanded conversion data exist in the cache 3402, the data received from the server 3101 are first converted in the conversion system which can perform the processing at a high speed, and then the converted data are transmitted to the client 3105. Thereafter, high-quality conversion data are prepared and stored in the cache 3402. Therefore, the conversion data which has as high quality as possible can be supplied to the client 3105 with enhancing the response characteristic of the operation performance for the user of the client 3105.

In the foregoing description, the conversion target data are assumed to be the moving-picture data. In following description, there are some cases where the conversion processing rate and the quality for the same data are inversely proportional to each other.

In one case, the conversion target data are a lot of document data. In this case, a head portion (intro) of the document data can be picked up at a high speed. However, in order to automatically prepare a digest of the document data, it takes a relatively long time.

In another case, the conversion target data are still-picture data. For example, when the display size is reduced, use of error diffusion processing or the like results in enhancement of data quality, however, it needs a high time cost.

(Tenth Embodiment)

Next, a tenth embodiment according to the present invention will be described. Prior to the description of this embodiment, the cache-attached data converting device 3103 of this invention which is equipped with a command expansion function will be first described in comparison with the conventional data converting device 3301 which is equipped with a command expansion function. The command expansion function is defined as a function of enabling the user of the client 3105 to expand a transmittable command so that he can freely select a data conversion method, etc. of the data converter 3403 for multimedia data which will be received by the user, and the concept of this function is proposed in Japanese Patent Application No. Hei-7-118673 as described above.

First, the conventional multimedia network system shown in FIG. 50, which is equipped with the command expansion function, will be described.

In this case, the data conversion device 3301 contains therein a flag for determining whether the data conversion processing is carried out. In an actual software, this flag can be realized by a variable or file.

When activated, the client 3105 transmits the transmission demand command of the multimedia data A 3601. The data converting device 3301 checks the end of the name of data which are demanded by the command, and compares the end of the name with a predetermined character array (hereinafter referred to as “expansion character array”). If the end of the name and the expansion character array are coincident with each other, the data converting device 3301 sets “perform data conversion processing”, and transmits to the server 3101 a command demanding transmission of data having the data name from which the expansion character array is removed. On the other hand, if both are not coincident with each other, the data converting device 3301 sets “perform no data conversion processing”, and transmits to the server 3101 the command which has been received from the client 3105. In this case, the expansion character array is assumed to be “.small”. The name of the data which is demanded to be transmitted by the command is “multimedia data A”, so that the end of the name and the expansion character array are not coincident. Accordingly, the data converting device 3301 sets “perform no data conversion”.

The server 3101 receives this command through the network 3102, and in response to this command it transmits the multimedia data A 3601 to the client 3105. The data converting device 3301 receives the multimedia data A 3601 through the network 3102.

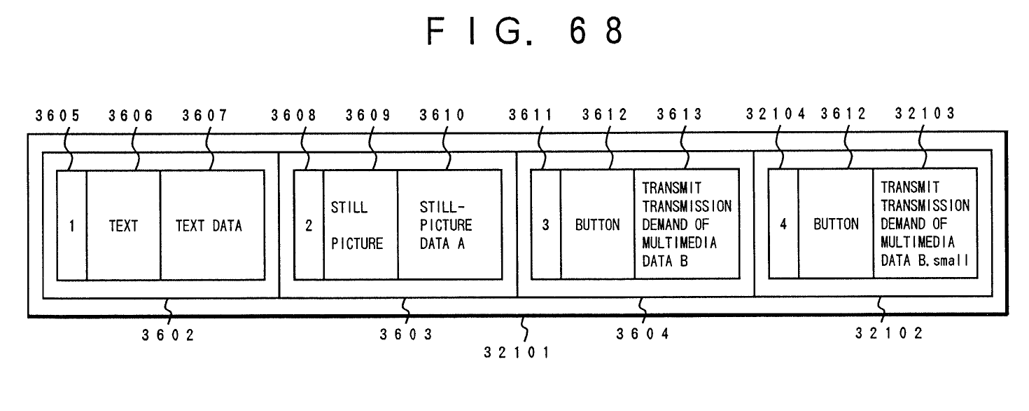

The data converting device 3301 expands the multimedia data A 3601 to multimedia data 32101 shown in FIG. 68, and transmits the multimedia data 32101 to the client 3105. Here, the multimedia data 32101 are data obtained by adding the multimedia data A 3601 with data 32101. Reference numeral 32104 represents the data number of the data 32102, and reference numeral 32103 represents the data content of the data 32102, which corresponds to button data to transmit a command demanding transmission of data having the data name “multimedia data B.small”.

That is, “expansion” means that when the data constituting the multimedia data contain button data, the multimedia data is added with button data which demands to transmit data having the data name obtained by adding the end of the expansion array to the name of data which is demanded to be transmitted by the button data.

Further, at this time, “perform no data conversion” is set in the data converting device 3301, and thus no conversion is performed on the still-picture data 3603.

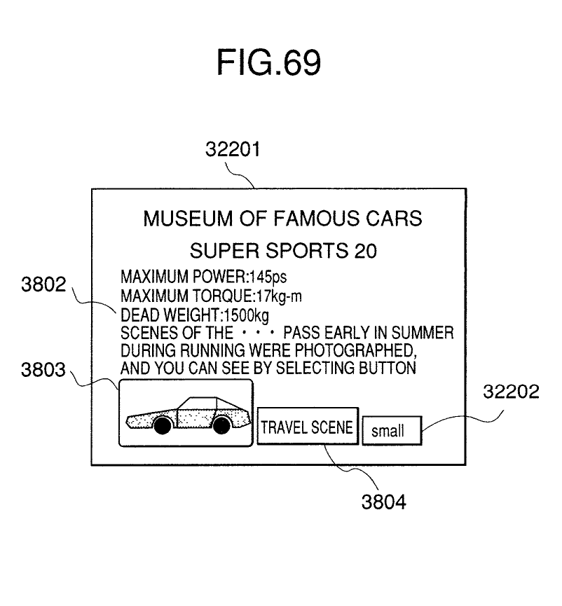

The client 3105 receives the multimedia data 32101 through the network 3104 to interpret the received data content and display such image information as shown in FIG. 69 on the display, and waits for an user's instruction through the pointing device.

In FIG. 69, reference numeral 32201 represents the screen display of the received multimedia data 32101 at the client side. Reference numeral 32202 represents the screen display of the button data 32103. When the user of the client 3105 selects the button 3804 through the pointing device, the client 3105 transmits the transmission demand command of the data having the data name “multimedia data B” to the server 3101. This transmission demand command is received through the network 3104 by the data converting device 3301. Since the name of the data demanded by the command is “multimedia data B”, the data converting device 3301 sets “perform no data conversion” as described above, and transmits the command to the server 3101. The server 3101 receives this command through the network 3102, and transmits the multimedia data B 3701 to the client 3105. The data converting device 3301 receives the multimedia data B 3701 through the network 3102. Here, no button data are contained in the multimedia data B 3701, and “perform no data conversion” is set, so that the data converting device 3301 directly transmits the multimedia data B 3701 to the client 3105.

The client 3105 receives the multimedia data B 3701 through the network 3104 to interpret the received data content and display such image information as shown in FIG. 56 on the display. At this time, moving pictures are reproduced on the screen display 3902 for 30 seconds.

On the other hand, when the user of the client 3105 selects the button 32202 on the screen display of FIG. 69 through the pointing device, the client 3105 transmits the transmission demand command of the data having the data name “multimedia data B.small” to the server 3101. This transmission demand command is received through the network 3104 by the data converting device 3301. The expansion character array “.small” is compared with the end of the name of the data which is demanded to be transmitted by the command received by the data converting device 3301. In this case, the expansion character array “.small” and the end of the name are coincident with each other, so that the data converting device 3301 sets “perform data conversion”. Further, the data converting device 3301 transmits to the server 3101 a command which demands transmission of data having the data name obtained by removing the expansion character array “.small” from the end of the data name of the data as described above. In this case, the transmission demand command of “multimedia data B” is transmitted to the server 3101.

The server 3101 receives this command through the network 3102, and in response to this command it transmits the multimedia data B 3701 to the client 3105. The data converting device 3301 receives the multimedia data B 3701 through the network 3102. At this time, “perform data conversion” is set, so that the data converting device 3301 converts the multimedia data B 3701 to the multimedia data 31301 shown in FIG. 60, and transmits the multimedia data 31301 to the client 3105.

In FIG. 60, reference numeral 31301 represents multimedia data, reference numeral 31302 represents first data constituting the multimedia data 31301, and reference numeral 31303 represents digest-version moving-picture data which are moving-picture data of 6 seconds obtained by partially cutting the moving-picture data 3705. The client 3105 receives the multimedia data 31301 through the network 3104 to interpret the received data content and display such image information as shown in FIG. 56 on the display. Therefore, on the screen display 3902 are reproduced moving pictures of 6 seconds which are extracted from the moving pictures of 30 seconds of the moving-picture data B.

The above is the operation of the data converting device having the command expansion function. The user of the client can receive the converted data by selecting the button which is added through the expansion processing of the data converting device.

Next, the case of the present invention, that is, the case that the data converter 3403 is provided with the data expansion function will be described.

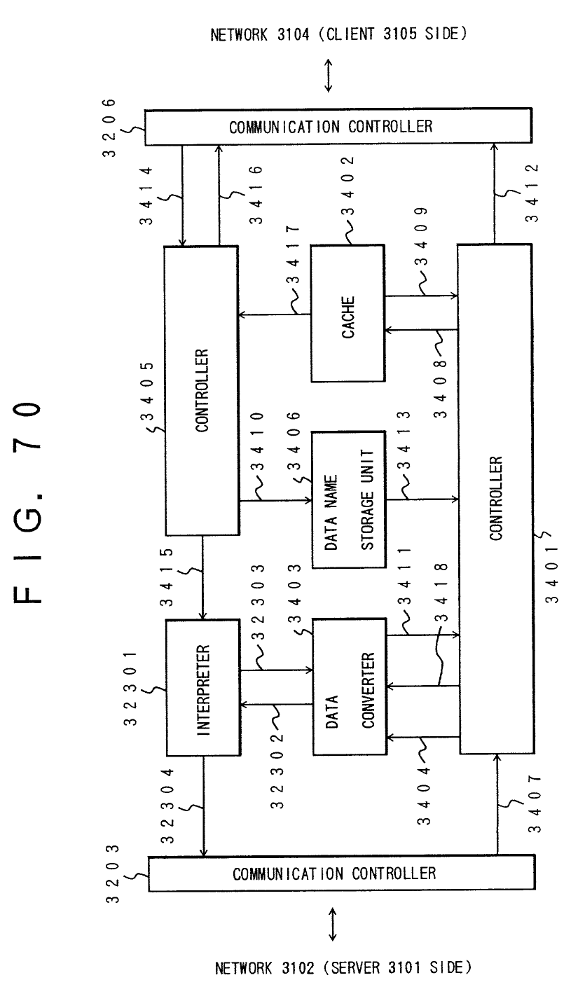

In this embodiment, the functional block diagram of the software which is performed in the cache-attached data converting device 3103 is shown in FIG. 70.

In FIG. 70, the interpreter 32301 receives the interpretation command 3415 and the expansion character array 32302. If the interpretation command 3415 is an expansion command, the interpreter 32301 outputs as a data conversion flag 32303 the data representing “perform data conversion” in the data converter, and also outputs as an interpreted command 32304 the command demanding transmission of the data having the data name obtained by removing the expansion character array 32302 from the name of the data which is demanded to be transmitted by the interpretation command 3415.

On the other hand, if the interpretation command is not an expansion command, the interpreter 32301 outputs the data representing “perform no data conversion” as a data conversion flag 32303, and also outputs the interpretation command 3415 as an interpreted command 32304.

Here, the assumption 1 and the assumption 2 of the seventh embodiment are set as assumptions of this embodiment.

In order to simplify the description, the operation of this embodiment will be described from such a stage that the client 3105 receives the multimedia data 32101 and a display as shown in FIG. 69 is output on the screen. The multimedia data 32101 are stored in the cache 3402 under the name of “multimedia data A”.

When the user of the client 3105 selects the button 3804 through the pointing device, the client 3105 transmits the transmission demand command of the multimedia data B 3701 to the server 3101. The communication controller 3206 receives the transmission demand command which is transmitted through the network 3104 to the server 3101, and transmits the command as the command 3414 to the controller 3405.

When receiving the command 3414, the controller 3405 performs the “cache response processing” shown in FIG. 61 like the seventh embodiment. Here, since only the data having the data name “multimedia data A” are stored in the cache 3402, a response based on the storage data in the cache 3402 is not made, and the controller 3405 outputs the command 3414 as the interpretation command 3415 as described above. At this time, the name “multimedia data B” is stored in the data name storage unit 3406.

The interpreter 32301 compares the expansion character array 32302 with the end of the name of the data which is demanded to be transmitted by the interpretation command 3415. Here, the expansion character array is assumed to be “.small”. Further, the name of the data which are demanded to be transmitted by the interpretation command 3415 is “multimedia data B”, so that the expansion character array and the end of the name of the data are not coincident with each other. When they are not coincident with each other, the interpreter 32301 outputs “OFF” representing “perform no data conversion” as a data conversion flag 32303, and also outputs the interpretation command 3415 as the interpreted command 32304.

The communication controller 3203 transmits the interpreted command 32304, that is, the transmission demand command of the multimedia data B to the server 3101.

The server 3101 receives this command through the network 3102, and in response to this command it transmits the multimedia data B 3701 to the client 3105.

The communication controller 3203 receives the multimedia data B 3701, and transmits the data as the multimedia data 3407 to the controller 3401. The controller 3401 performs the data conversion and transmission processing shown in FIG. 62.

In step 31502, the controller 3401 supplies the multimedia data 3407, that is, the multimedia data B 3701 as the conversion target multimedia data 3404 for the data conversion and transmission processing. However, the data converter 3403 performs no data conversion because the data conversion flag 32303 is set to “OFF” in the data converter 3403, and transmits the multimedia data B 3701 as the converted data 3411.

In step 31503, the controller 3401 outputs the multimedia data B 3701 as the transmission multimedia data 3412.

In step 31504, the controller 3401 stores the multimedia data B 3701 into the cache 3402 with a data name “multimedia data B”.

As described above, finally the client 3105 receives the multimedia data B 3701, and the multimedia data B 3701 are stored in the cache 3402 with the name “multimedia data B”.

On the other hand, when the user of the client 3105 selects the button 32202 through the pointing device, the client 3105 transmits the transmission demand command of the data having the data name “multimedia data B.small” to the server 3101. The communication controller 3206 receives the transmission demand command which is transmitted through the network 3104 to the server 3101, and transmits the command as the command 3414 to the controller 3405.

When receiving the command 3414, the controller 3405 performs the “cache response processing” shown in FIG. 61 like the seventh embodiment. Here, only two data having the data names “multimedia data A” and “multimedia data B” are stored in the cache 3402, so that no response based on the stored data of the cache 3402 is made, and the controller 3405 outputs the command 3414 as the interpretation command 3415 as described above. At this time, the name “multimedia data B.small” is stored in the data name storage unit 3406.

The interpreter 32301 compares the expansion character array 32302 with the end of the name of the data which are demanded to be transmitted by the interpretation command 3415. Here, the expansion character array is assumed to be “.small”. Further, the name of the data which are demanded to be transmitted by the interpretation command 3415 is “multimedia data B.small”, so that the end of the name and the expansion character array are coincident with each other. When they are coincident, the interpreter 32301 outputs “ON” representing “perform data conversion” as the data conversion flag 32303. Further, it outputs as the interpreted command 32304 the command demanding transmission of the data of the data name obtained by removing the expansion character array from the name of the data which are demanded to be transmitted by the interpretation command 3415, that is, the data name “multimedia data B”.

The communication controller 32303 transmits the interpreted command 32304, that is, the transmission demand command of the multimedia data B to the server 3101.

The server 3101 receives this command through the network 3102, and in response to this command it transmits the multimedia data B 3701 to the client 3105.

The communication controller 3203 receives the multimedia data B 3701, and transmits the multimedia data 3407 to the controller 3401. The controller 3401 performs the data conversion and transmission processing shown in FIG. 62.

In step 31502, the controller 3401 supplies the multimedia data 3407, that is, the multimedia data B 3701 as the conversion target multimedia data 3404 for the data conversion and transmission processing. The data converter 3403 converts the multimedia data B 3701 to the multimedia data 31301, and outputs the data as the converted data 3411 because the data conversion flag 32303 is set to “ON” in the data converter 3403.

In step 31503, the controller 3401 outputs the converted multimedia data, that is, the multimedia data 31301 as the transmission multimedia data 3412.

In step 31504, the controller 3401 stores the converted multimedia data, that is, the multimedia data 31301 into the cache 3402 with a data name “multimedia data B.small”.

As described above, finally the client 3105 receives the multimedia data B 3701.small and the multimedia data 31301 are stored in the cache memory with the name “multimedia data B.small”.

At this time, in the cache 3402 are stored the multimedia data A 360 named as “multimedia data A”, the multimedia data B 3701 named as “multimedia data B” and the multimedia data 31301 named as “multimedia data B.small”.

At this time, when the user of the client 3105 selects the button 3804 through the pointing device again, the transmission demand command of the data named as “multimedia data B” is input to the controller 3405, and the multimedia data B 3701 stored in the cache 3402 are transmitted to the client 3105. In this case, the multimedia data B 3701 can be supplied to the client 3105 without access to server 3101 and data conversion processing.

Likewise, when the user of the client 3105 selects the button 32202 through the pointing device, the transmission demand command of the data named as “multimedia data B.small” is input to the controller 3405, and the multimedia data 31301 stored in the cache 3402 are transmitted to the client 3105. In this case, the multimedia data 31301 can be supplied to the client 3105 without performing access to the server 3101 and the data conversion processing.

According to this embodiment, even in the data converter 3403 having the command expansion function, both non-converted data and converted data can be supplied to the client 3105 at a high speed in response to a second or subsequent transmission demand command.

Further, the following function can be also achieved by performing the processing of the controllers 3401 and 3405 of this embodiment in the same manner as the ninth embodiment. That is, at a first time, the multimedia data 31001 are prepared and then transmitted to the client 3105 to supply intro moving pictures to the user. After some time elapses, the multimedia data 31301 are transmitted to the client to supply higher-quality digest moving pictures to the user.

(Eleventh Embodiment)

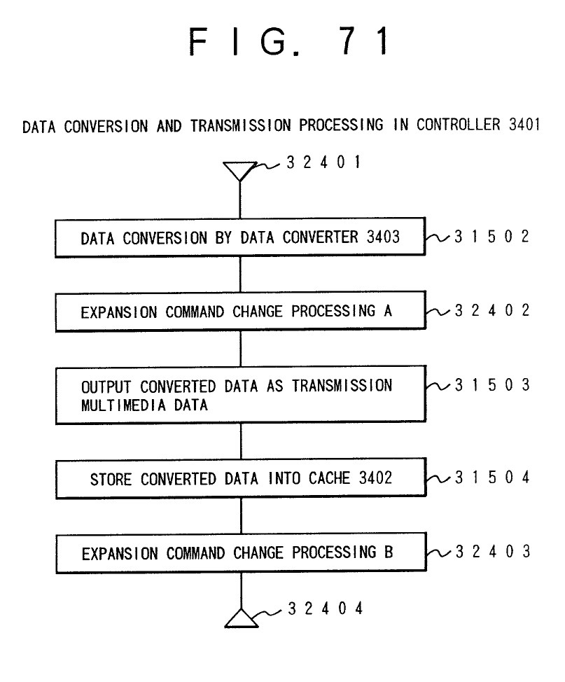

An eleventh embodiment according to the present invention will be described. In addition to the function of the tenth embodiment, this embodiment has another function of changing a command expansion method in accordance with a data storage status of the cache 3402. In this embodiment, the data conversion and transmission processing of the controller 3401 in the tenth embodiment is performed according to the flowchart of FIG. 71.

In FIG. 71, in step 32401 the data conversion and transmission processing is started. The steps 31502, 31503 and 31504 are identical to those of the seventh embodiment.

Step 32402 corresponds to expansion command changing processing A. In this step, for button data which are in the converted multimedia data 3411 and added by the data converter 3403, the controller 3401 adds a character array “(slow)” to the end of the button name when data which are demanded to be transmitted by the button exist in the cache 3402, thereby changing the button name.

Step 32403 corresponds to expansion command changing processing B. In this step, when the data name 3413 contains character array, for all the data stored in the cache 3402, the character array “(slow)” are removed from the end of the button name of the button data which demands transmission of the converted multimedia data 3411.

The data conversion processing of the controller 3401 in this embodiment will be described in detail. Here, the same assumptions 1 and 2 as the seventh embodiment are set, and both cases where the server 3101 transmits the multimedia data A 3601 to the client 3105 and where the server 3101 transmits the multimedia data B 3701 to the client 3105 will be described.

(Case A)

The client 3105 transmits the transmission demand command of the multimedia data A to the server 3101, and in response to the command the server 3101 transmits the multimedia data A 3601 to the client 3105.

(Case A-1)

The data named as “multimedia data B.small” are not stored in the cache 3402.

The controller 3401 receives the multimedia data A 3601 as the conversion target multimedia data 3407.

In this case, like the tenth embodiment, in step 31502 the data converter 3403 converts the multimedia data A 3601 to the multimedia data 32101, and outputs the data as the converted multimedia data 3411.

Here, the button data contains data having a “button name”. For example, the button data 36313 has a button name “travel scene”, and the button data 32103 has a button name “small”.

In step 32402, the controller 3401 performs the command change processing A. Here, since the converted multimedia data 3411 are the multimedia data 32101, for the data 32102 added by the data converter 3403, a command which the button data thereof transmits is checked, and also it is checked whether data having the same data name as the data which are demanded to be transmitted by the command are stored in the cache 3402.

In this case, the data named as “multimedia data B.small” are not stored in the cache 3402, and thus a character array “(small)” is added to the end of the data name of the button data 32103.

In step 31503, the controller 3401 outputs as the transmission multimedia data 3412 the multimedia data having the data name obtained by adding the character array “(slow)” to the end of the data name of the button data 32103 for the multimedia data 32101. The multimedia data are transmitted to the client 3105 by the communication controller 3206.

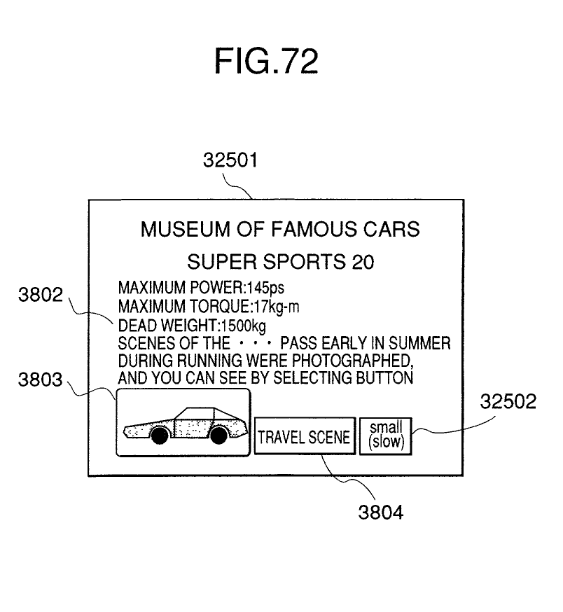

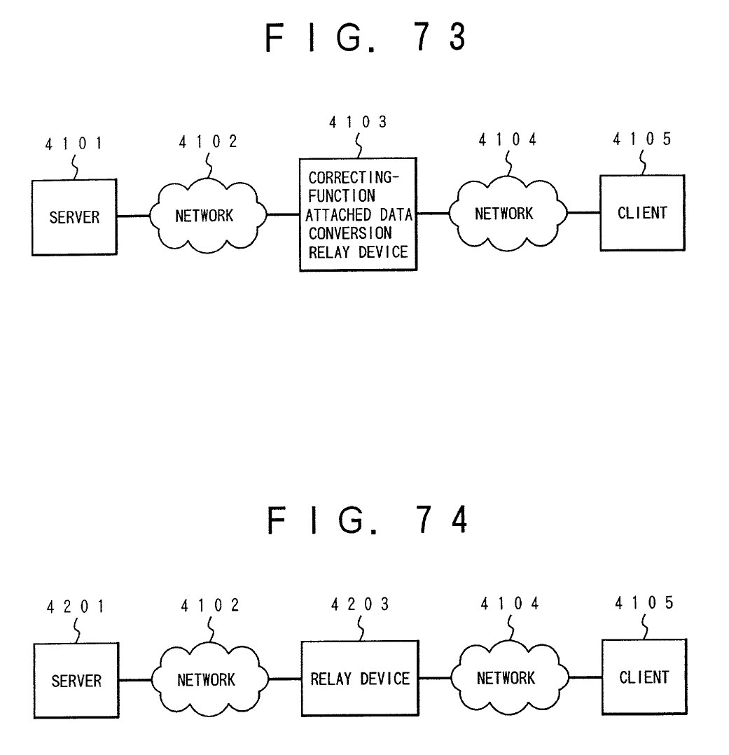

The client 3105 receives the multimedia data through the network 3104 to interpret the received data content and display such image information as shown in FIG. 72 on the display, and waits for an user's instruction through the pointing device.

In FIG. 72, reference numeral 32501 represents a screen display of the client which receives the multimedia data having the data name obtained by adding the character array “(slow)” to the end of the data name of the button data 32103 for the multimedia data 32101, and reference numeral 32502 represents a screen display of the button data 32103 in which the end of the data name is added with the character array “(slow)”.

In step 31504, the controller 3401 stores the multimedia data into the cache 3402 with the name “multimedia data A” like the tenth embodiment.

In step 32403, by the expansion command change processing B, for all the button data of all the data stored in the cache 3402, “(slow)” is removed from the ends of the button names of those button data which transmit the transmission demand command of “multimedia data A”. In this case, no multimedia data which contain the button data to transmit the transmission demand command of the data “multimedia data A” exist in the cache 3402, and thus the process goes to the next step.

In step 32404, the controller 3401 finishes the data conversion and transmission processing.

(Case A-2)

Data named as “multimedia data B.small” are stored in the cache 3402.

This case is different from the case A-1 only in the expansion change processing A in the step 32402. In this case, the data named as “multimedia data B.small” are stored in the cache 3402, and thus the data name of the button data 32103 is not changed. The other steps are identical to those of the case A-1, and finally the multimedia data 32101 are transmitted to the client 3105 and the multimedia data 32101 are stored in the cache 3402 with the name “multimedia data A”.

The client 3105 receives the multimedia data 32101 through the network 3104 to interpret the received data content and display such image information as shown in FIG. 69 on the display, and waits for an user's instruction through the pointing device.

(Case B)

The client 3105 transmits the transmission demand command of the multimedia data B.small to the server 3101, the data named as “multimedia data B.small” do not exist in the cache 3402, the cache-attached data converting device 3103 transmits the transmission demand command of the multimedia data B 3701 to the server 3101, and the server 3101 transmits the multimedia data B 3701 to the cache-attached data converting device 3103.

(Case B-1)

Only the multimedia data 32101 in which the button name of the button data is changed are stored in the cache 3402.

The controller 3401 receives the multimedia data B 3701 as the conversion target multimedia data 3407.

In this case, like the tenth embodiment, since the data conversion flag 32303 is set to “NO” in the data converter 3403, in step 31502 the data converter 3403 converts the multimedia data B 3701 to the multimedia data 31301, and outputs the data as the converted multimedia data 3411.

In step 32402, the controller 3401 performs the command change processing A. In this case, the converted multimedia data 3411, that is, the multimedia data 31301 contain no button data, so that the button name of the button data is not changed.

In step 31503, the controller 3401 outputs the multimedia data 31301 as the transmission multimedia data 3412. The multimedia data 3412 are transmitted to the client 3105 by the communication controller 3206.

The client 3105 receives the multimedia data 31301 through the network 3104 to interpret the received data content and display such image information as shown in FIG. 56 on the display. At this time, the moving pictures of 6 seconds which are extracted from the moving pictures of 30 seconds of the moving-picture data B are reproduced on the screen display 3902.

In step 31504, the controller 3401 stores the multimedia data into the cache 3402 with the name “multimedia data B.small” like the tenth embodiment.

In step 32403, by the expansion command change processing B, for all the button data of all the data stored in the cache 3402, “(slow)” is removed from the ends of the button names of those button data which transmit the transmission demand command of “multimedia data B.small”. In this case, the multimedia data 32101 in which the button name of the button data 32103 is changed are stored in the cache 3402, and thus the character array “(slow)” is removed from the end of the button name of the button data 32103 in the multimedia data 32101.

In step 32404, the controller 3401 finishes the data conversion and transmission processing.

(Case B-2)

No data are stored in the cache 3402.

The different point from the case B-1 is the step 32403. In this case, since no data are stored in the cache 3402, in step 32403 the controller 3401 advances its process to step 32404 without performing the change of the button name of the button data contained in the multimedia data stored in the cache 3402.

As described above, according to this embodiment, when the converted data which are finally transmitted to the client 3105 upon user's selection of the button displayed on the screen of the client 3105 does not exist in the cache 3402, the character array “(slow)” is added on a character array on the button. On the other hand, when the converted data exist in the cache 3402, the character array as described above can be removed. Accordingly, the user can grasp a data arrival rate to some degree through the display of the button, and thus the operation performance for the user can be enhanced.

In the above embodiment, the button name which is an attribute of the button data is changed. When the button data has a display attribute such as color, size, shape or turn on-and-off, non-display or the like, the operation performance for the user may be enhanced by changing such an attribute in place of adding the character array “(slow)” to the button name.

(Twelfth and Thirteenth Embodiments)

Next, twelfth and thirteenth embodiment according to the present invention will be described. The following description is made on the assumption that the server is a WWW server.

FIG. 73 shows a basic system constructions showing the twelfth and thirteenth embodiments according to the present invention.

As shown in FIG. 73, the system of these embodiment includes a WWW server 4101, networks 4102 and 4104, a correcting-function attached data conversion relay device 4103 and a client 4105. That is, the WWW server 4101 is connected to the correcting-function attached data conversion relay device 4103 through the network 4102, and further the client 4105 is connected to the correcting-function attached data conversion relay device 4103 through the network 4104. Multimedia data communication is carried out between the WWW server 4101 and the client 4105. At this time, the correcting-function attached data conversion relay device 4103 performs the data amount control operation through the data conversion and further corrects other demands and data through the data conversion.

The WWW server 4101 can supply services clients other than the client 4105, however, only one client 4105 is illustrated in FIG. 73 in order to simplify the description.

The networks 4102 and 4104 may comprise a single network or plural networks. The system is designed so that the networks 4102 and 4104 have different transmission capabilities, the correcting-function attached data relay device 4103 provides a greater effect. For example, the greater effect can be obtained in such a case that an internet is used as the network 4102 and a telephone line is used as the network 4104. Further, the correcting-function attached data conversion relay device 4103 may be connected to the different networks 4102 and 4104 so that it is used as a gateway.

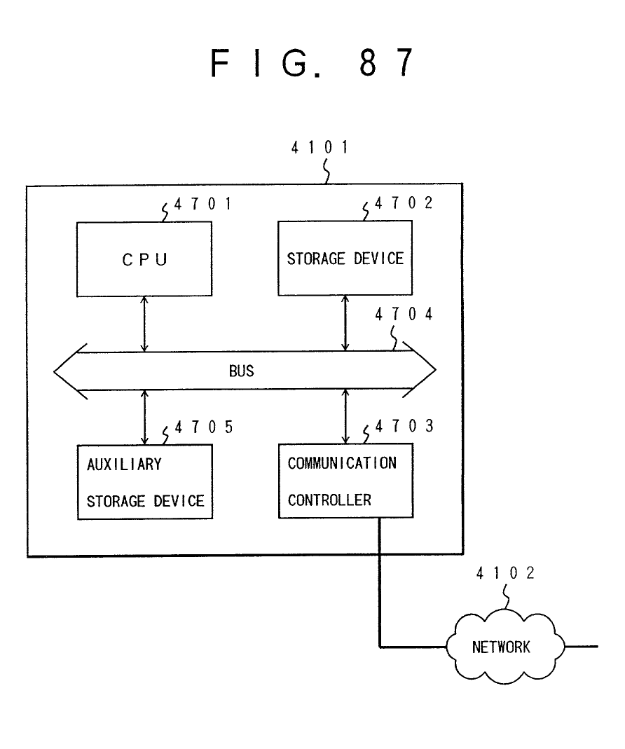

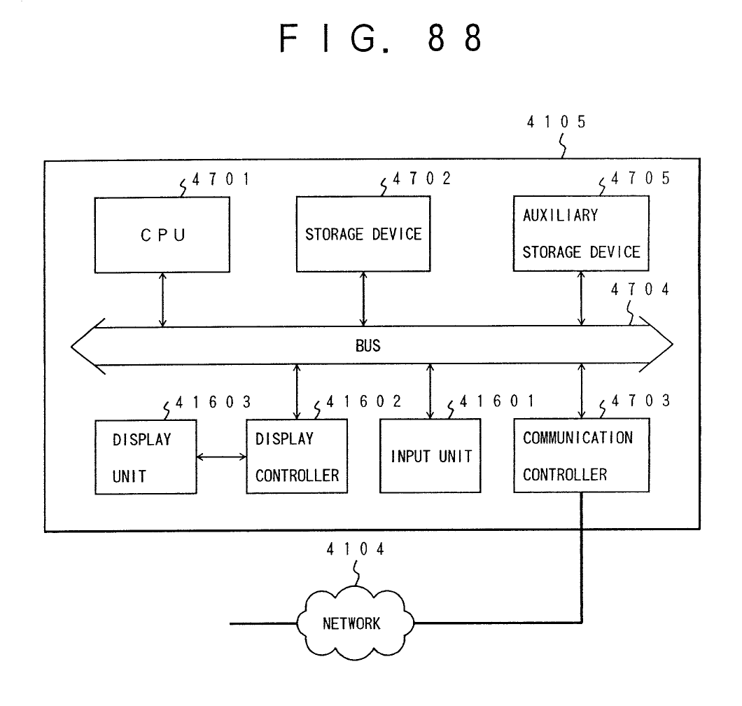

Next, the constructions of the WWW server 4101, the correcting-function attached data conversion relay device 4103 and the client 4105 will be described. FIG. 87 shows the construction of the WWW server 4101, FIG. 79 shows the construction of the correcting-function attached data conversion relay device 4103 and FIG. 88 shows the construction of the client 4105. Each of the devices shown in FIGS. 79, 87 and 88 includes a CPU 4701 for performing prescribed processing, a storage device 4702 for storing required information containing a program to operate the CPU 4701, a communication controller 4703 for controlling the data communication, and an auxiliary storage device 4705. The client 4105 shown in FIG. 88 further includes an input device 41601 such as a pointing device (for example, mouse), a keyboard or the like through which data demands or commands are input by the user of the client 4105, a display controller 41602 for controlling the screen display, an display unit 41603 such as a display or the like which is connected to the display controller 41602 and controlled to perform the screen display. The respective elements are connected to one another through a bus 4704 so that information communication can be performed thereamong.

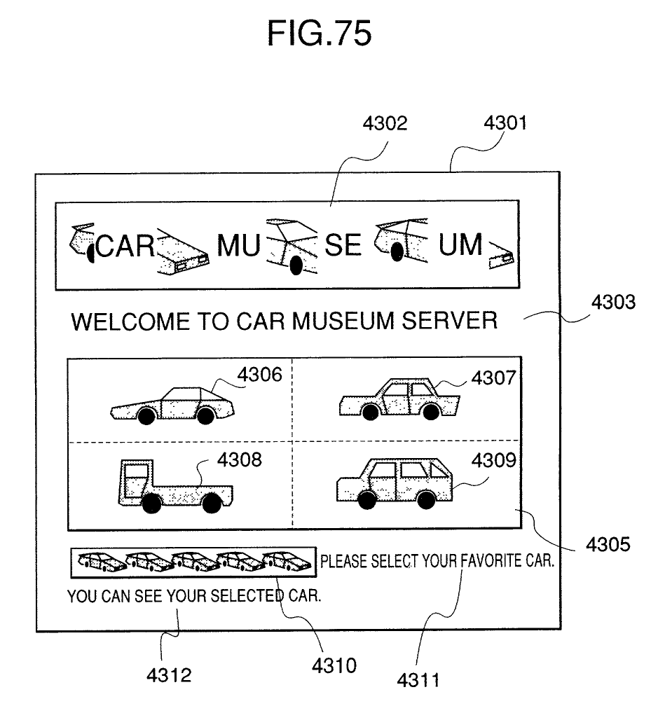

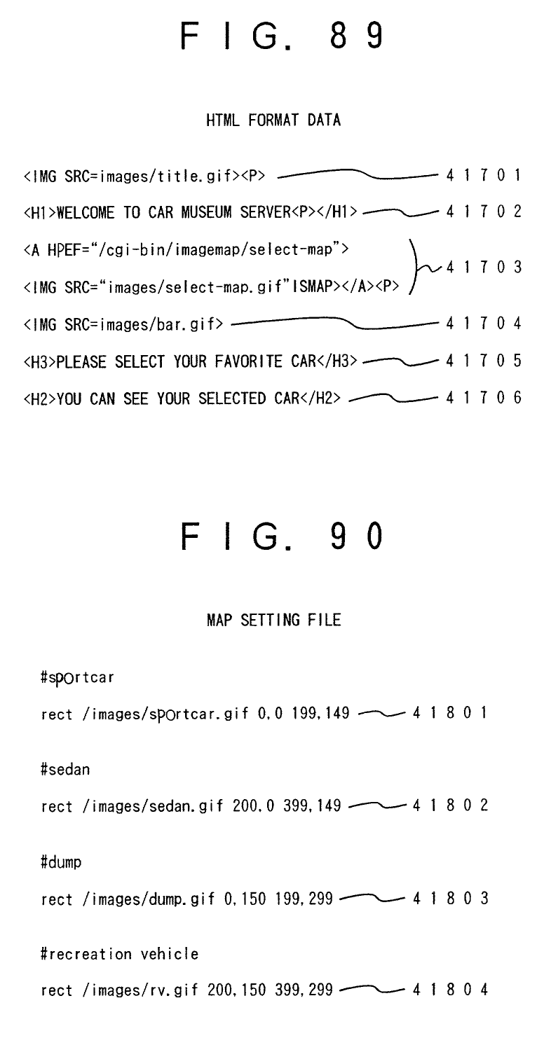

The storage device 4702, the communication controller 4703 and the auxiliary storage device 4705 are controlled with commands or data which are transmitted from the CPU 4701 through the bus 4704. Further, the main functions of the WWW server 4101, the correcting-function attached data conversion relay device 4103 and the client 4105 are realized by the operation of the CPU 4701 according to predetermined software. FIG. 89 shows an example of data which are serviced by the WWW server 4101. The data shown in FIG. 89 correspond to data representing a link between a text portion of the hypertext shown in FIG. 75 and video data, and are described according to HTML (HyperText Markup Language). In FIG. 89, reference numerals 41701 and 41704 represent descriptors which represents a link of an in-line image, respectively, reference numerals 41702, 41705 and 41706 represent a descriptor of a text, respectively, and reference numeral 41703 represents a descriptor which represents a link of an in-line image having a mapping name.

Next, these descriptors will be described hereunder.

Each of the descriptors 41701 and 41704 represents that a character portion (an image file) located subsequently to “SRC” thereof is linked as an in-line image to the description portion of the hypertext thereof. The links of the descriptors 41701 and 41704 correspond to the in-line images 4302 and 4310 in FIG. 75.

Further, each of the reference numerals 41702, 41705 and 41706 represents the text portion of the hypertext. H1 of the descriptor 41702 represents the size of a font of the text, and a text surrounded by <H1> and </H1>. The numeral subsequent to “H” represents the level of the font, and the font size is reduced as the numeral increases. <P> represents a line feed of the hypertext. The descriptors 41702, 41705 and 41706 correspond to the texts 4303, 4311 and 4312 shown in FIG. 75.

Like the descriptor 41701, etc., a character portion located subsequent to “SRC” of the descriptor 41703 represents an image file to be linked. The image to be linked corresponds to the in-line image 4305 in FIG. 75. HPEF=“/cgi-bin/imagemap/select-map” of the descriptor 41703 is a mapping name, and it represents a mapping name corresponding to a map set file representing what image is linked to what data when the image 4306, 4307, 4308 or 4309 in the in-line image 4305 is selected by the pointing device such as a mouse or the like. The details thereof will be described later.

In the following embodiment, the name of a file having the data shown in FIG. 89 is assumed to be “sampl.html”, and the description will be made by using this file name.

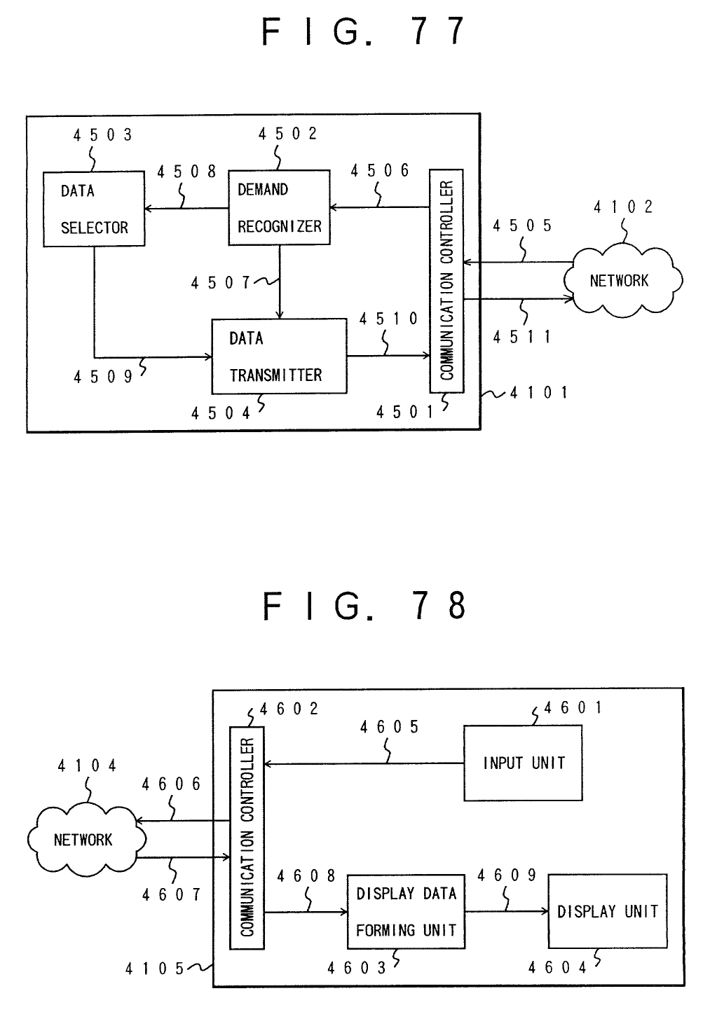

FIG. 77 is a functional block diagram showing the function which is achieved by the WWW server 4101. In the following embodiment, the WWW server 4101 is operated according to the functional block diagram of FIG. 77.

The function of the WWW server 4101 will be described with reference to FIG. 77.

In FIG. 77, reference numeral 4501 represents a communication controller for performing data communication according to a communication protocol, reference numeral 4502 represents a demand recognizer for recognizing a demand, reference numeral 4503 represents a data selector for selecting data to be transmitted, reference numeral 4504 represents a data transmitter for transmitting demanded data, and reference numerals 4505 to 4511 represent the flow of data, the flow of demands, the flow of control, etc.

Here, a processing flow when a data demand of data which are owned by the server 4101 is transmitted from the client 4105 to the server 4101 will be described.

First, the communication controller 4501 receives the data demand 4505 which is transmitted from the client through the network 4102, and transmits the data demand 4506 to the demand recognizer 4502.

In this embodiment, the data demand 4506 from the client is assumed to be classified into two types of data demands. One type is a demand for uniquely specifying the data stored in the server 4101. For example, a file of sampl.html of FIG. 89, a file name “images/title.gif” of an image which is to be liked and as shown subsequently to “SRC” of the descriptor 41701, etc. belong to this type. For example, when the client 4105 receives the file of “sampl.html” of FIG. 89, the client 4105 interprets the content of this file “sampl.html” to demand the image to be linked and shown subsequently to “SRC” to the server 4101. When receiving the file of the demanded image, the client can link the file of this image to prepare a hypertext as shown in FIG. 75. The other type is a demand containing information to allow selection of data to be transmitted from the server 4101 to the client 4105, and for example, it is a data demand which is generated when a portion within the in-line image 4305 is selected by the pointing device such as the mouse or the like. For example, it is assumed that the coordinate of the upper left corner of the in-line image 4305 is set to (0, 0) and the coordinate of the lower right corner is set to (399, 299). In this case, when the coordinate (300, 200) of an intermediate portion in the in-line image is selected by the pointing device such as the mouse or the like, “/cgi-bin/imagemap/select-map” of the mapping name and the coordinate (300, 200) becomes the data demand 4506.

The demand recognizer 4502 recognizes the data demand 4506 as described above. If the data demand is a demand which uniquely specifying the data, a transmission control 4507 for transmitting the specified data is transmitted to the data transmitter 4504. If the data demand contains information with which the data to be transmitted can be selected, its mapping name and selection information 4508 such as the coordinate, etc. are transmitted to the data selector 4503.

In the data selector 4503, the name of the map set file is determined on the basis of the mapping name of the selection information 4508. The map set file corresponding to the mapping name is determined by referring to a configuration file of an image map of the WWW server 4101. For example, the name “select-map. map” of the map set file corresponding to the mapping name “select-map” can be obtained by referring to the configuration file.

FIG. 90 shows an example of “select-map.map”. In FIG. 90, reference numerals 41801, 41802, 41803 and 41804 represent descriptors for performing a corresponding operation between a selected coordinate and data linked thereto. The description of the descriptor 41801 represents that the linked data correspond to an image file sportcar.gif when a coordinate within a rectangle defined by the coordinates (0,0) to (199, 149) is selected. The same is applied to the other symbols. For example, when a coordinate (300,200) is selected, an image file rv.gif is data to be linked. As described above, data to be linked are determined on the basis of the coordinate, and then the transmission control 4509 of the data is transmitted to the data transmitter 4504.

A file represented by the transmission control 4507 or transmission control 4509 is read into the data transmitter 4504. Here, the head of the data which are read in from the file is added with a header containing information which represents the data type of the data. The header is described in a text format, and the data type is contained in the header while described like “Content-Type: (data type)”. For example, when the data type is the HTML format, it is described as “Content-Type: text/html”. Further, when the data type is GIF (Graphics Interchange Format) format video data, it is described as “Content-Type: image/gif”). The data type may be identified on the basis of the expander of the file name of the data to be transmitted. For example, when the expander is “gif”, the data type of this data is identified as a GIF-format image file, and when it is “.jpg” or “jpeg”, the data type is identified as a JPEG (Joint Photographic Experts Group) format image file. Further, when the expander is “.html” or “.htm”, the data type is identified as an HTML-format described text file.

These data are transmitted as the transmission data 4510 from the data transmitter 4504 to the communication controller 4501. The communication controller 4501 transmits the transmission data 4510 to the network 4102.

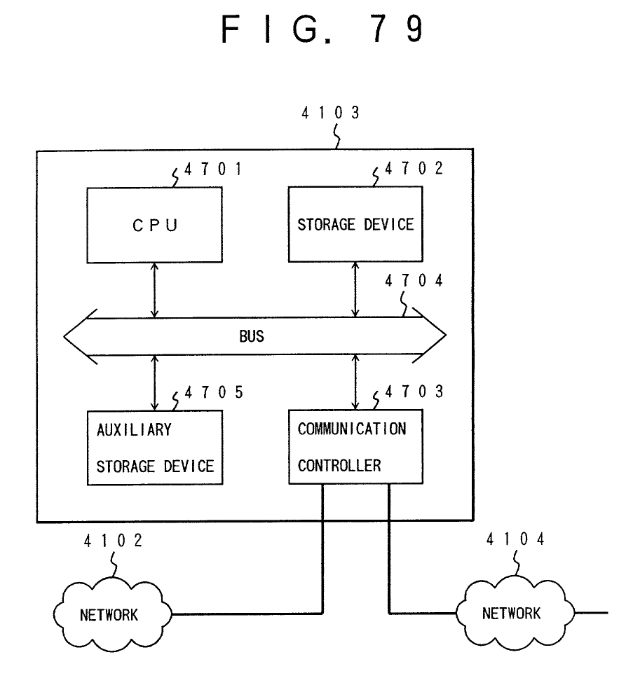

FIG. 78 is a functional block diagram showing the function which is achieved by the client 4105. In the twelfth and thirteenth embodiments, the client 4105 performs its operation according to the functional block diagram of FIG. 78.

In FIG. 78, reference numeral 4601 represents an input unit such as a mouse, a keyboard or the like through which a demand is input, reference numeral 4602 represents a communication controller for performing data communication (reception and transmission) according to a communication protocol, reference numeral 4603 represents a display data forming unit for forming display data from the data transmitted from the server 4101, reference numeral 4604 represents a display unit for performing display or the like on the display, and reference numerals 4605 to 4609 represent data, demands, etc.

First, in order for the client 4105 to perform a data demand to the server 4101, the input unit 4601 inputs a data demand of any data in the server 4101 or data linked to those data which have been transmitted from the server 4101. For example, when a demand of a file “sampl.html” is input through the keyboard, an unique file demand is the data demand. Further, when the file of “sampl.html” has been already in the client 4105, an image file of an in-line image described in the file of “sampl.html” may be the data demand. Still further, when the image as shown in FIG. 75 has been already displayed on the display unit 4604 and such an image as an in-line image 4305 to which other data are linked is selected and demanded by the mouse or the like, the mapping name of the selected in-line image 4305 and the selected coordinate correspond to a data demand. This data demand 4605 is transmitted as the data demand through the communication controller 4602 to the network 4104.

The demand transmitted to the network 4104 is transmitted to the WWW server 4101, and then the data which meet the demand are returned to the network 4104 as described above. Thereafter, the network 4104 transmits as the data 4608 the demanded data 4607 through the communication controller 4602 to the display data forming unit 4603.

The display data forming unit 4603 forms display data in accordance with the HTML format when the transmitted data are HTML format data, or forms display data in which an image is attached to the HTML data when the transmitted data are in-line image data, and then outputs the display data 4609 to the display unit 4604. The display unit 4604 outputs the display data 4609 to the display or the like.

The twelfth embodiment of the present invention will be described in detail.

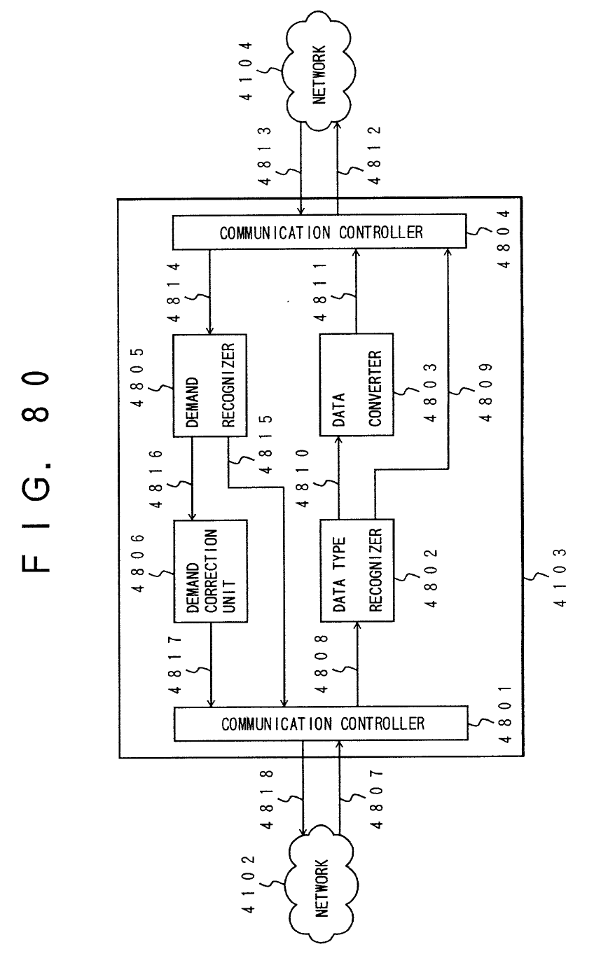

FIG. 80 is a block diagram showing the function which can be achieved by first correcting-function attached data conversion relay device 4103.

In FIG. 80, each of reference numerals 4801 and 4804 represents a communication controller for performing data communication according to the communication protocol, reference numeral 4802 represents a data type recognizer for identifying a data type such as video data, text data or the like, reference numeral 4803 represents a data converter for converting any data to reduce the data amount thereof, reference numeral 4805 represents a demand recognizer for recognizing a demand from the client, reference numeral 4806 represents a demand correction unit for converting the demand from the client 4806, and reference numerals from 4807 to 4818 represent the flow of data, demands, etc.

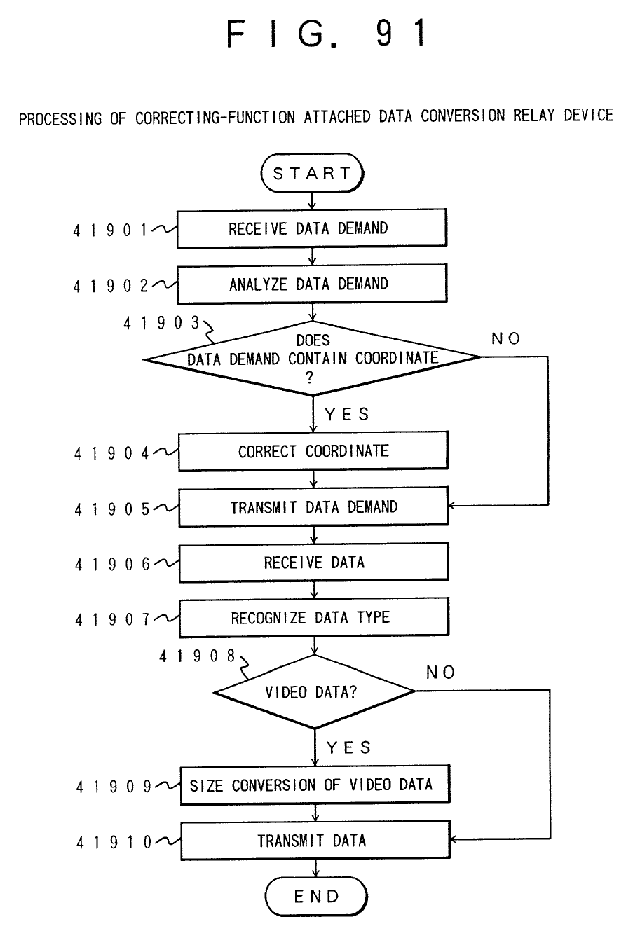

The processing flow of the functional block of FIG. 80 will be described together with the processing flow of the correcting-function attached data conversion relay device 4103 of FIG. 91. In this embodiment, the data converter 4803 is assumed to convert video data at a size conversion rate of ½to thereby reduce the data amount. The processing flow when the client transmits to the WWW server 4101 the data demand of sampl.html which is described in the HTML format as shown in FIG. 89 will be first described.

First, the client 4105 transmits the data demand through the network 4104, and the communication controller 4804 of the correcting-function attached data conversion relay device 4103 as shown in FIG. 80 receives the data demand 4813 (41901). The communication controller 4804 transmits the data demand to the demand recognizer 4805.

The demand recognizer 4805 analyzes the data demand to judge whether the data demand is a data demand which uniquely specifies a file name, or a data demand which contains a mapping name and a coordinate (41902). In this case, since the data demand uniquely specifies the file name (41903), the data demand is transmitted to the communication controller 4801, and the communication controller 4801 transmits the data demand through the network 4102 to the WWW server 4101 (41905).

The WWW server 4101 transmits the file of sample.html as data to the client 4105 according to the processing flow as described above in response to the data demand.

This data is relayed by the correcting-function attached data conversion relay device 4103. First, the communication controller 4801 receives this data (41906), and then transmits the data to the data type recognizer 4802.

The data type recognizer 4802 recognizes the transmitted data (41907). The data type recognizer can recognize a data type by checking information of a header which is added to the head of the data. The file of sample.html is not video data, and thus the data are transmitted to the communication controller 4804 (41908).

The communication controller 4804 transmits the data of sample.html to the client 4105 through the network 4104 (41910).

Next, the processing flow when the client 4105 transmits to the WWW server 4101 a data demand containing an unique file name of video data having such an expander as “.gif” of the descriptors 41701, 41703 and 41704 shown in FIG. 89 will be described.

In this case, the same processing flow as the case of the data demand of the “sample.html” as described above is established from the reception time of the data demand from the client 4105 until the transmission time of the data demand to the WWW server 4101 (from 41901 to 41905), and the subsequent processing will be described hereunder.

The WWW server 4101 receives the data demand which uniquely specifies a file name, and transmits the demanded video data to the client 4105. The data are relayed by the correcting-function attached data conversion relay device 4103. First, the communication controller 4801 receives this data (41906), and then transmits the data to the data type recognizer 4802.

The data type recognizer 4802 recognizes the data type of the transmitted data (41907). The data type of this data is identified as GIF-format video data by the header as described above. Accordingly, the data are transmitted to the data converter 4803 (41908).

The data converter 4803 performs the size conversion on the video data at a size conversion (reducing) rate of ½(41909). Any method may be used for the size conversion of the video data. For example, when the data are compressed like the GIF format data, the data may be temporarily subjected to the size conversion to expand the data to non-compression video data, and then subjected to the size conversion again to compress the data to GIF-format video data. The size-converted video data are transmitted to the communication controller 4804.

The communication controller 4804 transmits the data through the network 4104 to the client 4105 (41910).

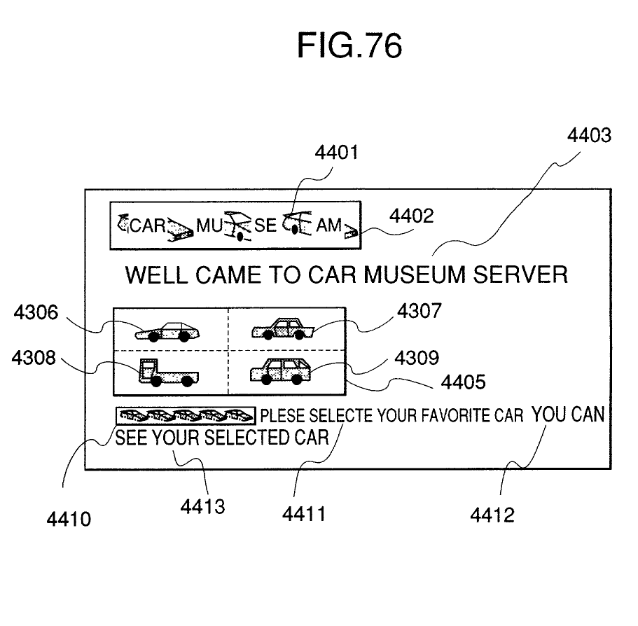

As described above, the size-converted video data can be displayed at the client 4105 as shown in FIG. 76, for example.

Next, the following description is made on the processing flow when the coordinate of the upper left corner of the in-line image 4405 of FIG. 76 assumed to be set to (0,0) while the coordinate of the lower right corner thereof is set to (199,149), and a coordinate (150,100) near to the image 4409 is selected by the mouse or the like to transmit a data demand from the client 4105 to the WWW server 4101. This data demand contains a mapping name and a coordinate.

First, the client 4105 transmits the data demand through the network 4104, and the data demand 4813 is received by the communication controller 4804 of the correcting-function attached data conversion relay device 4103 (41901). This data demand is transmitted to the demand recognizer 4805. The demand recognizer 4805 analyzes the data demand (41902). Since the data demand contains the coordinate, the data demand is transmitted to the demand corrector 4806 (41903).

The data demand correction unit 4806 doubles each of the respective values of the coordinate (150,100) contained in the data demand to convert the coordinate to a coordinate (300, 200) (41904). The multiplication of the double corresponds to the inverse number of the size conversion rate of ½at which the in-line image 4405 is size-converted. If the size conversion rate is equal to ⅓, the coordinate is tripled by the data demand correction unit 4806. The data demand is transmitted to the communication controller 4801 with the corrected coordinate values set as coordinate values for the data demand.

The communication controller 4801 transmits the data demand through the network 4102 to the WWW server 4101 (41905). Thereafter, the WWW server 4101 transmits to the client 4105 the data which are linked to the data demand. When the linked data are video data, the subsequent processing corresponds to the size-conversion processing as described above. When the linked data are not video data, the subsequent processing corresponds to processing of performing only the data relay as described above.

As described above, the first object of the present invention can be achieved by using the correcting-function attached relay device 4103 as described above.

Next, the thirteenth embodiment of the present invention will be described in detail.

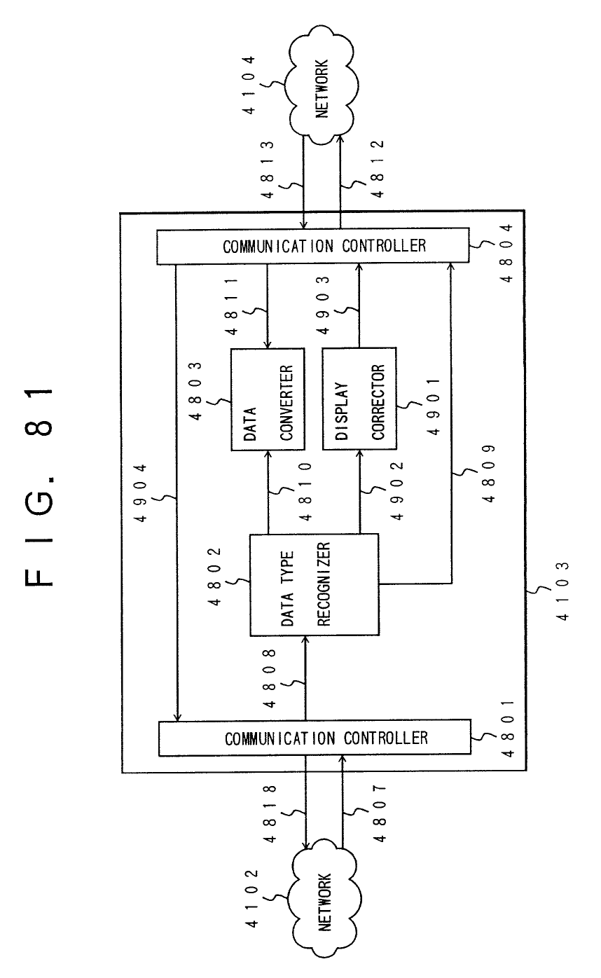

FIG. 81 is a functional block diagram showing the function which is achieved by the correcting-function attached data conversion relay device 4103.

In FIG. 81, reference numeral 4901 represents a display corrector, and reference numerals 4902 to 4904 represent the flow of data, demands, etc. The other reference numerals are the same as shown in FIG. 80.

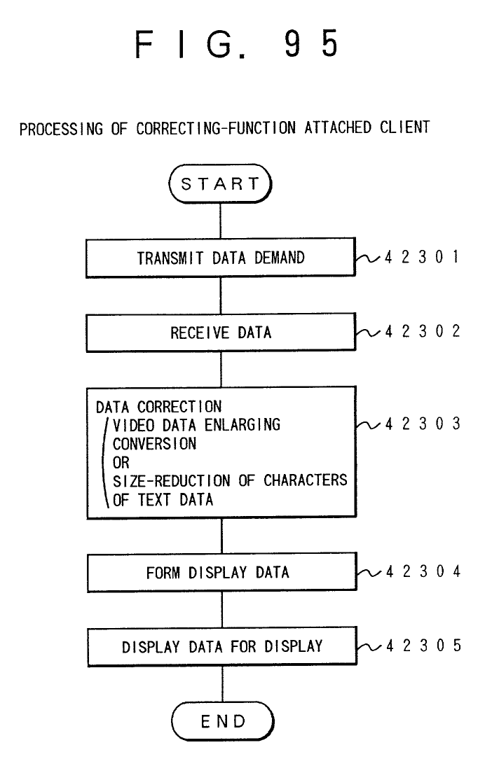

FIG. 94 shows the processing flow of the correcting-function attached data conversion relay device 4103 of the thirteenth embodiment.

The processing flow of the correcting-function attached data conversion relay device 4103 when the data demand of sample.html is transmitted from the client 4105 to the WWW server 4101 will be described with reference to FIGS. 81 and 94.

The correcting-function attached data conversion relay device 4103 performs only the relay operation without changing the data demand from the client 4105. That is, the data demand from the network 4104 is transmitted to the network 4102 through the communication controllers 4804 and 4801 (42201, 42202).

The WWW server 4101 receives the data demand of sample.html, and transmits the data of sample.html to the client 4105. The data transmitted from the WWW server 4101 becomes data 4808 through the network 4102 and the communication controller 4801 (42203), and then is transmitted to the data type recognizer 4802 (42204). When the data transmitted from the server are identified as video data 4810 on the basis of the data type (42205), the data type recognizer 4802 transmits the data to the data converter 4803 (42206). On the other hand, when the data are identified as HTML-format text data (42205), the data type recognizer 4802 transmits the data to the display corrector 4901 (42207). When the data are identified as the other data 4809 (42205), the data type recognizer 4802 transmits the data to the communication controller 4804 with no change of the data.

The data converter 4803 performs the size conversion on the video data 4810 at the size conversion rate of ½(42206), and transmits the size-converted data 4811 to the communication controller 4804.

The display corrector 4901 performs such a correction that as to prevent the display balance of the video data on the display unit 4607 from being lost due to the size-conversion of the video data in the data converter 4803 (42207). The data correction method is related to the size conversion rate. This relation will be described later. The corrected data 4903 is transmitted to the communication controller 4804. The communication controller 4804 transmits the data to the network 4104, and further to the client 4105 (42208).

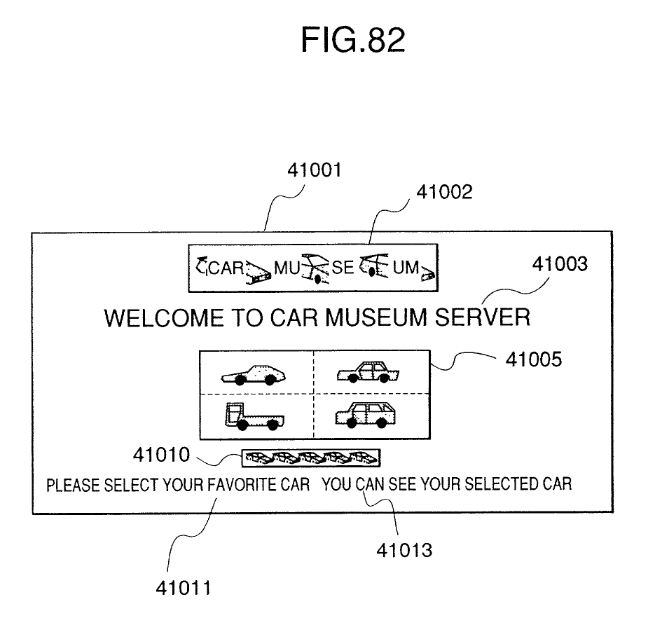

Here, examples of the display correction which is performed by the display corrector 4901 will be described with reference to FIGS. 82, 83, 89, 92 and 93.

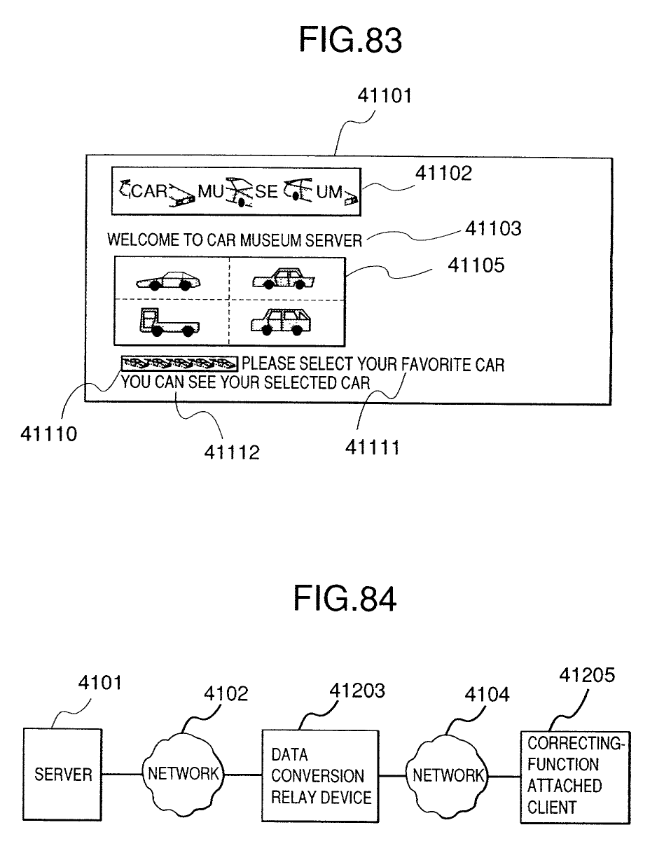

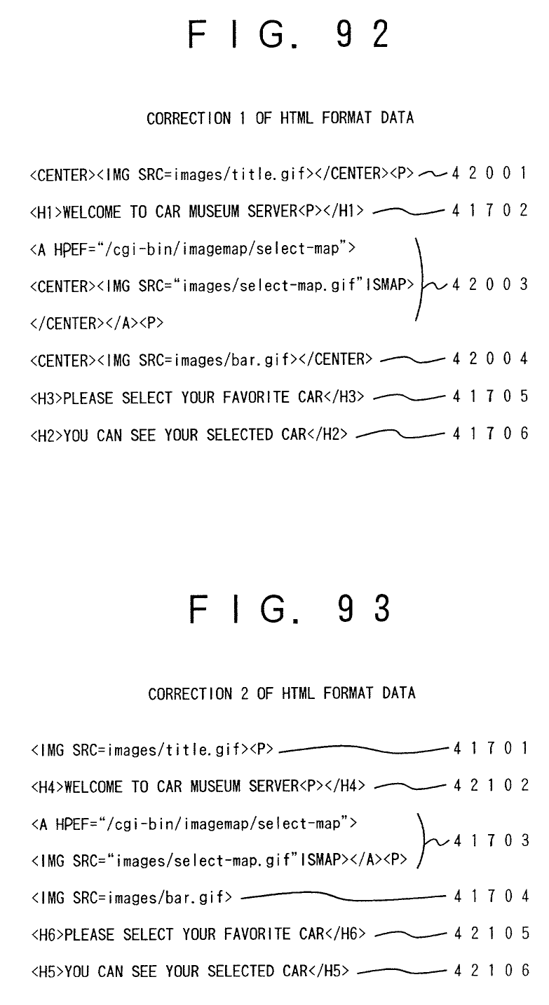

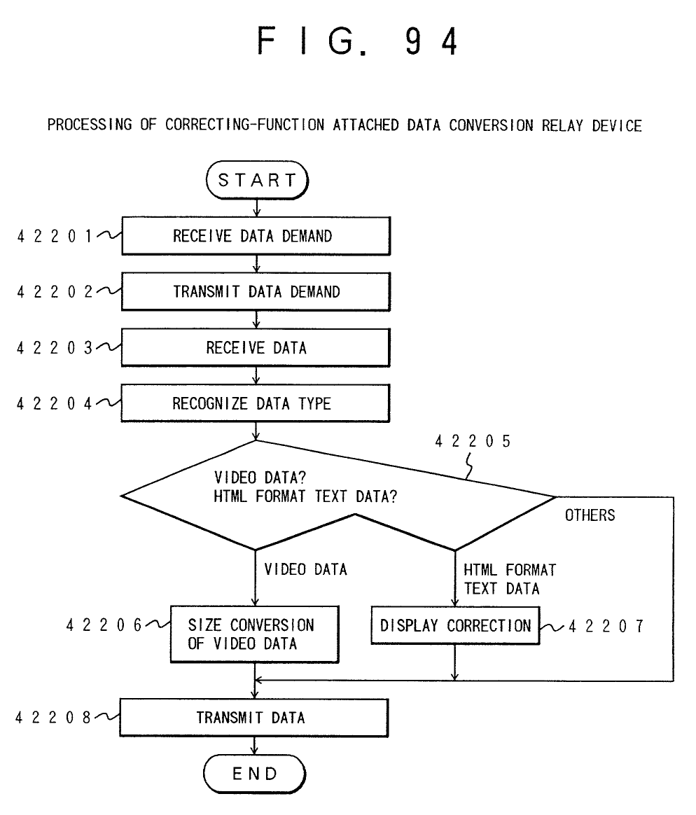

The correcting-function attached data conversion relay device 4103 corrects the data of FIG. 89 as shown in FIG. 92 or 93 to obtain a display image as shown in FIG. 82 or 83.

First, an example of the display correction of correcting the data as shown in FIG. 92 to obtain the display image as shown in FIG. 82 will be described.

In the display corrector 4901, the descriptors 41701, 41703 and 41704 are corrected to descriptors 42001, 42003 and 42004. That is, the correction is performed so that a descriptor of an in-line image is inserted between <CENTER> and </CENTER> of each of the descriptors 42001, 42003 and 42004. This correction results in an image as shown in FIG. 82.

In FIG. 82, reference numeral 41001 represents a display image of a hypertext, reference numerals 41002, 41005 and 41010 represent in-line images, and reference numerals 41003, 41011 and 41013 represent texts.

When an image is fully displayed over the display image 4301 in the lateral direction like the in-line images 4302 and 4305 in FIG. 75, the data can be corrected so that the image is displayed substantially at the center portion of the display image 41001 in the lateral direction like the in-line images 41002 and 41005 of FIG. 82.

Next, another example of the display correction of correcting the data as shown in FIG. 93 to obtain the display image as shown in FIG. 83 will be described.

In the display corrector 4901, the descriptors 41702, 41705 and 41706 shown in FIG. 89 are corrected to descriptors 42102, 42105 and 42106 shown in FIG. 92. That is, the correction is performed so that a descriptor of a text is inserted between <H4> and </H4> of each of the descriptors 42102, 42105 and 42106. That is, the correction is performed so that the character size is reduced in accordance with the size conversion rate of ½. This correction results in the display image as shown in FIG. 83.

In FIG. 83, reference numeral 41101 represents a display image of a hypertext, reference numerals 41102, 41105 and 41110 represent in-line images and reference numerals 41103, 41111 and 41112 represent texts. In FIG. 83, the correction is performed so that the character size of the texts 4303, 4311 and 4312 is reduced. The size-reduced texts are the texts 41103, 41111 and 41112. Since the display size of the in-line images 41102, 41105 and 41110 is reduced through the data conversion, the display image 41101 itself is reduced.

As described above, the second object of the present invention can be achieved by using the correcting-function attached relay device 4103 as described above.

If the demand recognizer 4805 and the demand corrector 4806 as described in the twelfth embodiment are added to the thirteenth embodiment, the size conversion of images can be performed without changing an user interface like the twelfth embodiment. This is because the coordinate in an image indicates a relative position with respect to the upper left corner (0,0) of the image, and thus no coordinate is varied even when the image is moved in parallel.

Next, a fourteenth embodiment according to the present invention will be described.

FIG. 84 shows the system construction of the fourteenth embodiment. As shown in FIG. 84, the system of this embodiment includes the WWW server 4101, the networks 4102 and 4104, a data conversion relay device 41203 and a correcting-function attached client 41205. That is, the WWW server 4101 is connected to the data conversion relay device 41203 through the network 4102, and the correcting-function attached client 41205 is connected to the data conversion relay device 41203 through the network 4104. The multimedia data communication is performed between the WWW server 4101 and the correcting-function attached client 41205. At this time, the data amount of video data is controlled through the size-conversion of the video data. The correcting-function attached client 41205 corrects and displays the data which are subjected to the data conversion in the data conversion relay device 41203.

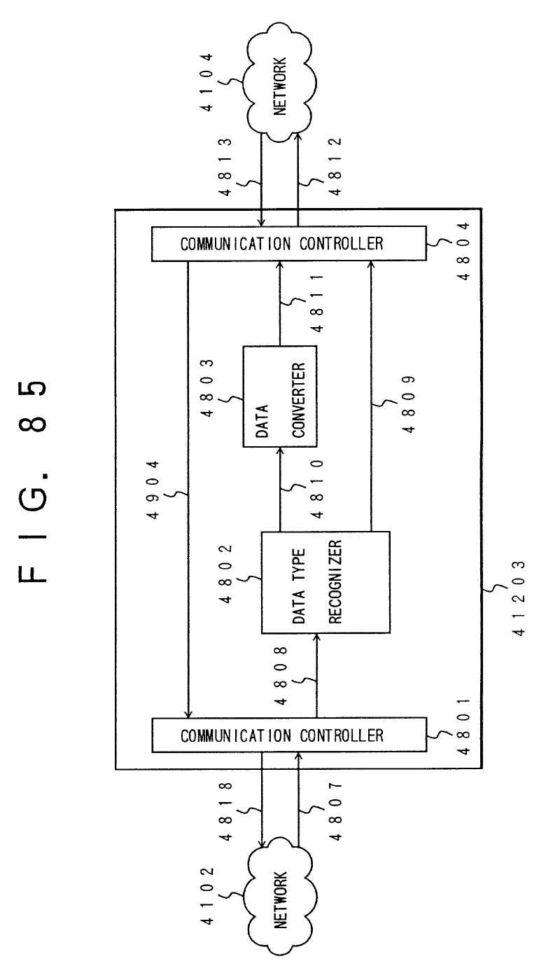

FIG. 85 is a functional block diagram showing the function of the data conversion relay device 41203. In FIG. 85, the same elements as FIGS. 80 and 81 are represented by the same reference numerals. In FIG. 85, the processing flow of the data conversion relay device 41203 when the data demand has been already transmitted from the client to the WWW server 4101 and thus the server 4101 transmits data to the client 4105 is identical to that of FIG. 80. Further, only the relay operation is performed when the data demand from the client to the server 4101 is relayed by the data conversion relay device 41203.

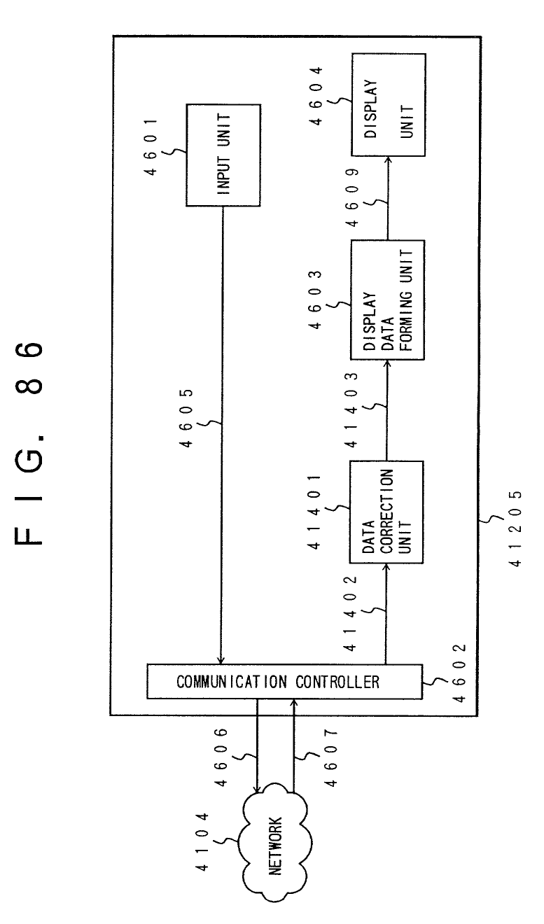

FIG. 86 is a functional block diagram showing the function of the correcting-function attached client 41205.

In FIG. 86, reference numeral 41401 represents a data correction unit, and reference numerals 41402 and 41403 represent data flow. The other reference numerals represent the same elements as shown in FIG. 78.

FIG. 95 is a flowchart of the processing of the correcting-function attached client 41205 of the fourteenth embodiment. The processing of the correcting-function attached client 41205 will be described with reference to FIGS. 86 and 95. The data demand from the correcting-function attached client 41205 to the server 4101 is identical to that of FIG. 78 (42301).

The processing flow when the demanded data are transmitted from the server 4101 to the correcting-function attached client 41205 will be described hereunder.

The data which are transmitted from the WWW server 4101 are relayed by the data conversion relay device 41203, then transmitted as data 4607 through the network 4104 to the communication controller 4602 (42302), and then transmitted as data 41402 to the data corrector 41401.

The data correction unit 41401 corrects video data which are size-converted by the data converter in the data conversion relay device 41203 (42303). The data correction of the data correction unit 41401 of the correcting-function attached client 41205 will be described hereunder.

For example, the data correction unit 41401 corrects video data in the data relayed by the data conversion relay device 41203 so that the display size of the video data is enlarged to a double size (which is equal to the inverse number of the size conversion rate of the data converter 4803). Accordingly, substantially the same display image as the display image 4301 shown in FIG. 75 can be displayed on the display unit 4604. In this case, the coordinates of the images 4306, 4307, 4308 and 4309 in the in-line image 4305 are not varied, and thus it is unnecessary to correct the coordinates.

As another correction method, the data correction unit 41401 may correct text data in the data relayed by the data conversion relay device 41203 so that the character size of the text data is reduced to a half size (which is equal to the size conversion rate of the data converter 4803) or a value near to the half size. Accordingly, substantially the same display image as shown in FIG. 83 can be displayed on the display unit 4604. The corrected data 41403 are transmitted to the display data forming unit 4603.

The display data forming unit 4603 forms display data on the basis of the transmitted data (42304), and then outputs the display data 4609 to the display unit 4604. The display unit 4604 outputs the display data 4609 to the display or the like (42305). As described above, the various objects of the present invention can be achieved by using the correcting-function attached client 41205.

As described above, the present invention is suitably usable for a network system, and on the basis of original sound-attached moving-picture data, the present invention can form sound-attached moving-picture (video) data of a desired reproduction time whose data amount is smaller than that of the original sound-attached moving-picture data and which are suitable to simultaneously output moving pictures and sounds.

Further, the data amount of the multimedia data received by the client can be adjusted without changing the system construction. Accordingly, a client-server system can be constructed with taking no consideration into the change of the function of the client, the transmission capability of the network, etc.

Still further, the suitable data amount control can be performed in accordance with the type of the data demanded by the client, so that the data communication arrangement can be performed in accordance with its use purpose, for example, browsing or the like. Accordingly, a system having excellent operation performance for an user can be achieved.

When the multimedia data amount relay device is disposed at a place where the transmission capabilities of the transmission media are different from each other, the difference of the transmission capabilities can be absorbed by the multimedia data amount relay device. Further, when the system is designed so that an user can freely select one of choices on adjustment of the data amount, the user can adjust the data amount in accordance with his purpose.

According to the present invention, there can be provided the data converting device in which the user can search data at a high speed even when the data conversion processing having a large time cost is used. In addition, by applying data conversion processing having a different large time cost to multimedia data if occasion demands, the client can be supplied with converted data whose quality is as high as possible with keeping the search speed of the user at the client to be high.

Further, the time which is required from the client's service demand time until the completion time of the data transmission from the server can be shortened by the data conversion. In addition, the correction function makes it unnecessary to change the user interface due to the data conversion, and also prevents the display image from losing its image balance. Therefore, the user of the client can be supplied with high-speed display services without a sense of incompatibility.

What is claimed is:

1. A sound-attached moving-picture data forming device comprising:
separation means for separating, into moving-picture data and sound data, sound-attached moving-picture data which are obtained by multiplexing sound data and moving-picture data with each other, the moving-picture data being obtained by encoding moving-picture data of plural frames on a frame basis with an orthogonal transform coding;
reducing means for deleting data representing high-frequency components of each frame from the moving-picture data separated by said separation means to thereby reduce a data amount of the moving-picture data; and
multiplexing means for multiplexing reproduction target moving-picture data which correspond to a part of the moving-picture data reduced by said reducing means and which are obtained by encoding data of frames whose number corresponds to a specified reproduction time, with reproduction target sound data which correspond to a part of the sound data separated by said separation means and which are to be reproduced simultaneously with the reproduction target moving-picture data.

2. The sound-attached moving-picture data forming device as claimed in claim 1, wherein said multiplexing means comprising:
first forming means for forming first auxiliary data containing reproduction start time information of head moving-picture data of each frame in the moving-picture data reduced by said reducing means, for every frame;
second forming means for forming second auxiliary data containing reproduction start time information of head sound data of each frame in the sound data separated by said separation means, for every frame to be simultaneously reproduced;
first extraction means for extracting frames, the number of which corresponds to the specified reproduction time, from the moving data reduced by said reducing means on the basis of the first auxiliary data formed by said first forming means, thereby determining the reproduction target moving-picture data; and
second extraction means for extracting, from the sound data separated by said separation means, those frames which have the reproduction start time corresponding to that of the reproduction target moving-picture data determined by said first extraction means on the basis of the first auxiliary data formed by said first forming means and the second auxiliary data formed by said second forming means, thereby determining the reproduction target sound data, wherein the reproduction target moving-picture data extracted by said first extraction means and the reproduction target sound data extracted by said second extraction means are multiplexed with each other.

3. A sound-attached moving-picture data forming device comprising:
separation means for separating, into moving-picture data and sound data, sound-attached moving-picture data which are obtained by multiplexing sound data and moving-picture data with each other, the moving-picture data containing plural GOPs (Group of Picture) each of which serves as a reproduction processing unit, contains moving-picture data of one or more frames which are encoded for every frame by inter-frame predictive coding, and comprises an I-picture corresponding to a frame which is obtained by encoding moving-picture data of a frame independently of moving-picture data of another frame, at least one P-picture corresponding to a frame obtained by forwardly predictively encoding one I-picture at a forward side, and at least one B-picture corresponding to a frame obtained by bidirectionally predictively encoding one I-picture or P-picture at a forward side and one I-picture or P-picture at a backward side;
reducing means for replacing data of the B-picture with data having a predetermined value to reduce the data amount of the B-picture; and
multiplexing means for extracting GOPs, the number of which corresponds to a specified reproduction time, from the moving-picture data reduced by said reducing means to thereby determine reproduction target moving-picture data which are moving-picture data to be reproduced, and multiplexing the reproduction target moving-picture data with reproduction target sound data which correspond to a part of the sound data separated by said separation means and which are to be reproduced simultaneously with the reproduction target moving-picture data.

4. The sound-attached moving-picture data forming device as claimed in claim 3, wherein said multiplexing means comprises:
first forming means for forming first auxiliary data containing reproduction start time information of head moving-picture data of each GOP in the moving-picture data reduced by said reducing means, for every GOP;
second forming means for forming second auxiliary data containing reproduction start time information of head moving-picture data of each picture in the moving-picture data reduced by said reducing means, for every picture;
third forming means for forming third auxiliary data containing reproduction start time information of head sound data of each frame in the sound data separated by said separation means, for every frame to be simultaneously reproduced;
first extraction means for extracting GOPs, the number of which corresponds to the specified reproduction time, from the moving data reduced by said reducing means on the basis of the first auxiliary data formed by said first forming means, thereby determining the reproduction target moving-picture data; and
second extraction means for extracting, from the sound data separated by said separation means, those frames which have the reproduction start time corresponding to that of the reproduction target moving-picture data determined by said first extraction means on the basis of the second auxiliary data formed by said second forming means and the third auxiliary data formed by said third forming means, thereby determining the reproduction target sound data, wherein the reproduction target moving-picture data extracted by said first extraction means and the reproduction target sound data extracted by said second extraction means are multiplexed with each other.

5. The sound-attached moving-picture data forming device as claimed in claim 3, wherein said multiplexing means multiplexes the data so that pauses of the GOPs are coincident with pauses of transmission processing units when the sound-attached moving-picture data are transmitted.

6. The sound-attached moving-picture data forming device as claimed in claim 4, wherein said first forming means calculates the reproduction start time information of each GOP on the basis of a frame rate of the moving-picture data reduced by said reducing means and the number of pictures contained in all GOPs located at a front side of the GOP concerned, said second forming means calculates the reproduction start time information of each picture on the basis of the frame rate of the moving-picture data reduced by said reducing means, the reproduction start time information for each GOP and a reproduction order of the picture concerned in the GOP containing the picture concerned, and said third forming means calculates the reproduction start time information of each frame on the basis of a sampling frequency of the sound data separated by said separation means and the number of frames located at a front side of the frame concerned.

7. A video server including:
a sound-attached moving-picture data forming device comprising separation means for separating, into moving-picture data and sound data, sound-attached moving-picture data which are obtained by multiplexing sound data and moving-picture data with each other, the moving-picture data being obtained by encoding moving-picture data of plural frames on a frame basis with an orthogonal transform coding, reducing means for deleting data representing high-frequency components of each frame from the moving-picture data separated by said separation means to thereby reduce a data amount of the moving-picture data, multiplexing means for multiplexing reproduction target moving-picture data which correspond to a part of the moving-picture data reduced by said reducing means and which are obtained by encoding data of frames whose number corresponds to a specified reproduction time, with reproduction target sound data which correspond to a part of the sound data separated by said separation means and which are to be reproduced simultaneously with the reproduction target moving-picture data; and
a transmission device for transmitting the sound-attached moving-picture data formed by said sound-attached moving-picture forming device through a network to a client.

8. A video server including:
a sound-attached moving-picture data forming device comprising separation means for separating, into moving-picture data and sound data, sound-attached moving-picture data which are obtained by multiplexing sound data and moving-picture data with each other, the moving-picture data containing plural GOPs (Group of Picture) each of which serves as a reproduction processing unit, contains moving-picture data of one or more frames which are encoded for every frame by inter-frame predictive coding, and comprises an I-picture corresponding to a frame which is obtained by encoding moving-picture data of a frame independently of moving-picture data of another frame, at least one P-picture corresponding to a frame obtained by forwardly predictively encoding one I-picture at a forward side, and at least one B-picture corresponding to a frame obtained by bidirectionally predictively encoding one I-picture or P-picture at a forward side and one I-picture or P-picture at a backward side, reducing means for replacing data of the B-picture with data having a predetermined value to reduce the data amount of the B-picture, and multiplexing means for extracting GOPs, the number of which corresponds to a specified reproduction time, from the moving-picture data reduced by said reducing means to thereby determine reproduction target moving-picture data which are moving-picture data to be reproduced, and multiplexing the reproduction target moving-picture data with reproduction target sound data which correspond to a part of the sound data separated by said separation means and which are to be reproduced simultaneously with the reproduction target moving-picture data; and
a transmission device for transmitting the sound-attached moving-picture data formed by said sound-attached moving-picture forming device through a network to a client.

9. A data converting device comprising:
information input means for receiving input information containing one or more kinds of data;
data analyzing means for checking each kind of data constituting the input information and extracting data from the input information when the data are judged to be data which are predetermined as conversion target data to be subjected to a data amount conversion processing;
control means for performing the conversion processing on the data amount of the extracted data in accordance with a regulation which is predetermined for the kind of data;
information constructing means for replacing the converted data of the input information with the data before the conversion processing, thereby reconstructing the input information; and
information output means for outputting the reconstructed information.

10. The data converting device as claimed in claim 9, wherein the predetermined regulation is to reduce the number of pixels of video data in a predetermined pattern when the data type is video data, and said control means has a function of reducing the number of pixels of the extracted video data in a predetermined pattern.

11. The data converting device as claimed in claim 9, wherein said information input means has means for receiving a command instructing to convert the size of specific data in a specific conversion rate, and processing means for analyzing the content of the received expansion command and supplying the data obtained by converting the size of the specific data in the specific conversion rate as the converted data which are to be treated by said information constructing means.

12. The data converting device as claimed in claim 11, wherein the expansion command is a command for reducing the number of pixels of the video data so that the size of the video data is converted at a conversion rate of “¼or 1/16”, and said processing means has a function of supplying the video data, whose size is converted at the conversion rate of “¼or 1/16”, as the converted data which are to be treated by said information constructing means.

13. A network system having the data conversion device as claimed in claim 9, wherein each of said information input means and said output means of said data converting device is connected to a transmission medium.

14. The network system as claimed in claim 13, wherein the transmission medium connected to said information input means and the transmission medium connected to said transmission medium are different in transmission rate.

15. The network system as claimed in claim 9, wherein said information input means and said information output means of said data converting device are connected to different networks to construct said data converting device as a gateway.

16. A data transmission method for performing data transmission while converting the data amount of given data comprising the steps of:
receiving input information containing one or more kinds of data;
identifying each kind of data constituting the input information, and extracting the data concerned from the input information when the data are identified as conversion target data to be subjected to data amount conversion processing;
performing conversion processing on the data amount of the extracted data according to a regulation which is predetermined for the kind of data;
replacing the converted data of the input information by the data before the conversion processing to reconstruct the input information; and
transmitting the reconstructed information.

17. A data converting device comprising:
information input means for receiving input information containing one or more kinds of data;
data converting means for performing data conversion processing on conversion target data to be subjected to data amount conversion processing according to a predetermined regulation;
storing means for storing the converted input information; and
information output means for outputting the converted information or the information stored in said storing means, wherein said information output means outputs information existing in said storing means without performing the conversion processing when the same information as the converted input information exist in said storing means.

18. The data converting device as claimed in claim 17, wherein said information output means has a function of outputting predetermined data before the converted information is output.

19. The data converting device as claimed in claim 18, wherein the predetermined data correspond to a message indicating that the data are under conversion processing.

20. The data converting device as claimed in claim 17, wherein said data converting means has a regulation group comprising plural kinds of predetermined regulations for data conversion, and said data converting means selects one regulation from the regulation group to output only data which are converted according to the selected regulation, and stores data which are converted according to all the regulations of the regulation group into said storage means.

21. The data converting device as claimed in claim 20, wherein said data converting means has two predetermined regulations having different processing speeds for data conversion, and wherein when data converted according to the regulation having the low processing rate are not stored in said storage means, said data converting means serves to output the data concerned while converting the data according to the regulation having the high processing speed and store the converted data into said storage means, and also to convert the data concerned according to the regulation having the low processing speed and store the converted into said storage device, and when data converted according to the regulation having the low processing speed are stored in said storage means, said information output means outputs the data concerned which are stored in said storage means without performing the data conversion processing.

22. The data converting device as claimed in claim 21, wherein when a demand of data is input from an external, if only data which are converted according to the regulation having the high processing speed are stored in said storage means for the data concerned, said information output means outputs the data concerned which are stored in said storage means without performing the data conversion processing.

23. The data converting device as claimed in claim 21, wherein the data are moving-picture data, and the high-speed regulation is a regulation for eliminating most of the moving-picture data except for a head portion of the moving-picture data, and the low-speed regulation is a regulation for extracting plural portions of the moving-picture data.

24. The data converting device as claimed in claim 17, wherein in accordance with a data demand command which is received from an external, said data converting means determines whether the data amount conversion processing is performed.

25. The data converting device as claimed in claim 24, wherein said information output means generates first data to transmit a first command for performing the conversion processing as the command demanding the data, and second data to transmit a second command for performing no conversion processing as the command data, a user being allowed to select one of the first and second commands on the basis of the first and second data.

26. The data converting device as claimed in claim 25, wherein when said information output means generates the first command, said information output means adds the first data with information indicating that a processing time for the conversion processing is needed at the transmission time of the first command if the converted data which are demanded by the first command does not exist in said storage means, and does not add the first data with the information if the converted data exist in said storage means.

27. The data converting device as claimed in claim 17, wherein said information input means is connected through a first network to a server to which the input information is supplied, and said information output means is connected through a second network to a client which receives the information.

28. A network system having a data converting device which is connected through a first network to a server and also connected through a second network to a client, and serves to convert an amount of data from said server and then transmit the converted data to said client, wherein said data converting device has a cache memory for temporarily storing converted data obtained by converting the amount of the which are demanded from said client to said server, and when a client demands the same data again, said data converting device reads out the converted data concerned from said cache memory and transmits the data concerned to the demanding client without accessing to said server and without performing the data amount conversion.

29. A data transmission method for a network system having a data converting device which is connected through a first network to a server and also connected through a second network to a client, and serves to convert an amount of data from said server and then transmit the converted data to said client, comprising the steps of:
temporarily storing in a cache memory converted data obtained by converting the amount of data which are demanded from said client to said server; and
when a client demands the same data again, reading out the converted data concerned from said cache memory and transmitting the data concerned to the demanding client without accessing to said server and without performing the data amount conversion.

30. An information processing system which comprises a first information processing device for supplying data, a data conversion relay device which is connected to said first information processing device through a network, and a second information processing device which is connected to said data conversion relay device through a network, wherein a data demand from said second information processing device is transmitted through said data conversion relay device to said first information processing device, said first information processing device supplies the data corresponding to the data demand through said data conversion relay device to said second information processing device, and said second information processing device displays at least one of images and characters which are represented by the supplied data, characterized in that
when the data supplied from said first information processing device are video data, said data conversion relay device serves to convert the video data so that an image represented by the video data is reduced and supply the converted video data to said second information processing device, and when the data demand from said second information processing device is a data demand containing coordinate values of the video data, said data conversion relay device serves to correct the coordinate values by multiplying the coordinate values by the inverse number of a reduction ratio of the image and transmit the data demand having the corrected coordinate values to said first information processing device.

31. An information processing system which comprises a first information processing device for supplying data, a data conversion relay device which is connected to said first information processing device through a network, and a second information processing device which is connected to said data conversion relay device through a network, wherein a data demand from said second information processing device is transmitted through said data conversion relay device to said first information processing device, said first information processing device supplies the data corresponding to the data demand through said data conversion relay device to said second information processing device, and said second information processing device displays at least one of images and characters which are represented by the supplied data, characterized in that
when the data supplied from said first information processing device are video data, said data conversion relay device serves to convert the video data so that an image represented by the video data is reduced and supply the converted video data to said second information processing device, and when the data supplied from said first information processing device are text data, said data conversion relay device serves to convert the text data so that the size of characters contained in the text data are reduced in the same reduction ratio as the image and then supply the converted data to said second information processing device.

32. An information processing system which comprises a first information processing device for supplying data, a data conversion relay device which is connected to said first information processing device through a network, and a second information processing device which is connected to said data conversion relay device through a network, wherein a data demand from said second information processing device is transmitted through said data conversion relay device to said first information processing device, said first information processing device supplies the data corresponding to the data demand through said data conversion relay device to said second information processing device, and said second information processing device displays at least one of images and characters which are represented by the supplied data, characterized in that
when the data supplied from said first information processing device are video data, said data conversion relay device serves to convert the video data so that an image represented by the video data is reduced and then supply the converted data to said second information processing device, and said second information processing device serves to enlarge the image represented by the supplied video data on the basis of the inverse number of the reduction ratio of the video data and then display the converted data.

33. An information processing system which comprises a first information processing device for supplying data, a data conversion relay device which is connected to said first information processing device through a network, and a second information processing device which is connected to said data conversion relay device through a network, wherein a data demand from said second information processing device is transmitted through said data conversion relay device to said first information processing device, said first information processing device supplies the data corresponding to the data demand through said data conversion relay device to said second information processing device, and said second information processing device displays at least one of images and characters which are represented by the supplied data, characterized in that
when the data supplied from said first information processing device are video data, said data conversion relay device serves to convert the video data so that an image represented by the video data is reduced and then supply the converted data to said second information processing device, and when the data supplied from the first information processing device through the data conversion relay device are text data, said second information processing serves to convert the text data in the same reduction ratio as the image so that the size of characters contained in the text data is reduced and then display the converted data.
